(19) United States
(12) Patent Application Publication
(10) Pub. No.: US 2008/0089978 A1
(43) Pub. Date: Apr. 17, 2008

(54) LACTEAL COATED PIZZAS

(75) Inventors: Louise J. Grigg, Scarsdale, NY (US); John Jonsan, Sutherland, VA (US)

Correspondence Address: LOUISE GRIGG PC;GRIGG & DAVIS ENGINEERS, P.C., 21 CROSSWAY, SCARSDALE, NY, 10583, US

(73) Assignee: Body Structures, Inc., Scarsdale, NY (US)

(21) Appl. No.: 11/309,851

(22) Filed: Oct. 13, 2006

(51) Int. Cl. A23L 1/00; A21D 10/00; A23C 9/00; A23L 1/212; A23L 1/31; A23L 1/302; A23C 9/12; A23G 3/00

(52) U.S. Cl. 426/61; 426/100; 426/102; 426/103; 426/580; 426/71; 426/72; 426/92; 426/94

(57) ABSTRACT

From dietary health to product diversity, Lacteal Coated Pizzas outperform the venerable four-hundred year old ethnic (Italian) pizzas. Lacteal Coated Pizzas are comprised of soft leaven dough/sourdough that is topped with a delicious, nutritious Lacteal Batter, and a conventional topping. The present invention's Lacteal Batters are innovative, heat-stable, hydrocolloidal-proteineous mixtures that possess unique performance-enhancing, rheological properties.

### FIELD OF INVENTION

The present invention relates to new, nonconventional proteineous-polysaccharide composite foods that are herein known as a “Lacteal Coated Pizzas.”

### BACKGROUND OF INVENTION

Pizza cuisine is deep-rooted in the oldest civilizations on earth that wheat farmed and animal herded for food. These early agricultural societies used grazed animals to cultivate land, and produce milk. The earliest fermented lacteal products were created from milk stored in goat pouches. The pouches retained natural bacterium that fermented milk, retarded spoilage, and produced delightful, tangy flavors. These farming civilizations milled flour by pulverizing wheat kernels with abrasive stones. They evolved the earliest unleavened dough prepared from wheat flour, salt, and water. The dough was cooked to charred, crisp, thin wafers that resembled matzos.

The Egyptians discovered leavened breads from dough mixed with fermented beer. This innovation enabled the Egyptians to transform unleavened dough (i.e. composed of flour, water, yeast, and salt) into raised bread. The breads were tough, chewy, and dense due to inferior wheats (e.g. spelt), inadequate baking methods, and high sodium content.

It was not until the Romans developed brick ovens, that baking of leaven dough products improved. Using their innovative masonry technologies, the Romans' constructed firebrick ovens with cook surfaces of volcanic stone covered by bell shaped, masonry domes. The Roman ovens were a major breakthrough in leaven dough technology by efficiently retaining high heat, and thoroughly cooking starch dough products. These features enhanced dough taste & texture, resulting in enhanced dough rise, structure, and extensibility. These advances also improved dough palatability and digestibility.

The Romans constructed communal brick ovens in their town squares where Italian peasants typically prepared thrifty, family meals called “piceas” that consisted of lard cheeses, olive oil, salt, herbs, and dough. Piceas were bottom-baked in the Roman ovens until the crusts were blackened. In the middle ages, “pizzas” were known as salty or sweet “piceas.”

The modern version of the Italian pizza dates to the 16^{th} century, when Neapolitan bakers created a spiced tomato paste topping, and began using the sauce to flavor pizzas. Mozzarella was first introduced around 1880, although other Italian cheeses were used prior. The piceas consisted of cheese, oil, herbs, tomato paste, & dough, which were oven-baked at temperatures of 400-430° C. (750-800° F.). Around the 1900's, Italian pizzas were introduced to the United States, and grew popular over the next century.

### Pizza's Global Popularity

Ethic (Italian) pizza has risen to extraordinary popularity in all reaches of the globe from Bangalore to Hong Kong, from Rio de Janeiro to the heart of Moscow. Pizzas have become a worldwide phenomenon largely due to institutional foodservices showcased Italian pies as a multi-cultural food. Changes in food consumption patterns, coupled with mass-media marketing by foodstores and pizza franchises, have led to an explosive pizza market worldwide.

In 2004, ACNielsen, “What's Hot Around the Globe in Growth of Food & Beverages,” surveyed food consumption patterns and trends in the Asia Pacific, emerging countries, Europe, Latin America & North America. This survey showed frozen & chilled packaged pizzas had a global growth-rate of 6%, and that consumers favored tastier, healthier, thriftier product versions.

Prior-art pizza varieties from around the globe include Australian pizzas topped with shrimp, pineapple & barbequed chicken/beef; Costa Rican pizzas topped with shredded coconut; Saudi Arabian pizzas topped with beef & cheese; Indian & Pakistani pizzas topped with curry, pickled ginger, minced mutton, paneer & tandoori chicken, and Japanese-mayo jaga pizzas topped with mayonnaise, potato, eel, squid & bacon. Pizzas popular in Europe include the Neapolitan or Margharita pizzas; the French flambé pizzas made with bacon, onion & fresh whole cream, and the double Dutch pizzas made with twice the usual cheese, onions & beef toppings. However, around the globe, ethnic (Italian) pizzas are the most popular and frequently consumed type.

Across the globe, pizzas are a hot commodity in the ready-made meal solutions market. Pizza products pose health and nutritional risks by routinely containing high levels of saturated fats, sodium, calories, cholesterol, trans-fatty acids, total lipids (fats), carcinogenic black pepper, and acidity. Rising pizza consumption is now regarded as contributing to the global rise in dietary disease occurrences. Furthermore, amid the increasing scarcity of natural energy resources, prior-art pizzas are not well suited for future global sustainability.

Tables 1-6 identify the key nutrient facts for the leading pizza brands in the food services and food retailing sectors. These tables demonstrate the routinely high levels of fats, sodium, and calories contained in most commercially sold pizza products.

### Pizza Derisive Global Health Impact

The United Nation's (UN) 2000 report “Current Food Consumption Patterns & Global Sustainability” cited packaged pizzas are the single most frequently consumed processed food, worldwide. This report also cites frequent pizza consumption (prior art) has amplified global obesity/overweight prevalence, and escalated consumer's cardiovascular (CVD) disease risks. The high sodium, fats and calories, in prior art pizzas, as shown in Tables 1-6, escalate blood lipid and serum cholesterol levels, as well as reduce consumers daily allowances to meet their other nutritional goals.

Worldwide, pizza products provide consumers with quick, low-cost, meal-replacement solutions, important to those with little time to prepare traditional meals. In 2000, the World Health Organization (WHO) estimated 1.7 billion (25% of the world population) were overweight (BMI≧25 kg/m²), and from the years 1995-2000, obesity (BMI≧30 kg/m²) exponentially rose from 0.2 to 0.3 billon (4.6% of the world population). These patterns parallel the worldwide rise in pizza popularity.

Pizza's popularity among children has risen dramatically in western industrialized nations, and its frequent consumption is now regarded as contributing to the rise in youth obesity/overweight prevalence. According to WHO—“EURO/13/05”; September, 2005—reported that from the United Kingdom (UK) to the Russian Federation, obesity/overweight occurrences among 7-11 year olds was rising at alarming rates (Italy 36%, Spain 34%, Greece 31%, UK 20%, & France 19%). In Australia, the 1997′ nationwide-health surveys showed 20% of 6-19 year olds are overweight/obese, (60-70% upward escalation since 1985). In Canada, the 1996 nationwide-health surveys showed overweight/obesity occurrence in 6-19 year olds was 33% males, and 27% females (upwardly escalated from 13% males & 11% females in 1981).

TABLE 1
Nutrient Facts
Leading Retailed Frozen Pizzas
(2-Slice Servings 227 g (8 oz) Cooked Wt.)

| | | Cal. (Kcal), | Fat (g), | Sat. Fat (g), | Sodium (mg) |
|---|---|---|---|---|---|
| 1.) | DiGiorno Pizzas (Schwan, NA) | | | | |
| | Rising Crust, Pepperoni | 604 | 26 | 11 | 1639 |
| | Rising Crust, Supreme | 504 | 22 | 9 | 1466 |
| | Deep Dish, Pepperoni | 583 | 33 | 13 | 1490 |
| | Thin Crispy Crust | 496 | 19 | 8 | 1192 |
| | Cheese Stuffed Crust, Supreme | 550 | 26 | 13 | 1521 |
| 2.) | Tombstone (Kraft Foods, Inc) | | | | |
| | BBQ Chicken | 582 | 22 | 11 | 1145 |
| | Double Top, Pepperoni | 608 | 34 | 26 | 1449 |
| | Bacon Cheeseburger | 662 | 33 | 15 | 1931 |
| | For One, Extra Cheese | 587 | 32 | 24 | 1079 |
| 3.) | Freschetta Pizzas (Schwan, NA) | | | | |
| | Brick Oven 8″, BBQ Chicken | 515 | 22 | 10 | 1270 |
| | Bake & Rise, 4 Meat, Large | 589 | 25 | 10 | 1741 |
| | Brick Oven, Italian Style Pepperoni | 620 | 33 | 15 | 1726 |
| | Sauce Stuffed Crust, Four Cheese | 561 | 20 | 10 | 1537 |
| | Sauce Stuffed Crust, Sausage & Pepperoni | 585 | 24 | 10 | 1688 |
| 4.) | Red Baron Pizzas (Schwan, NA) | | | | |
| | Bake to Rise, 4 Cheese | 551 | 22 | 9 | 1741 |
| | Bake to Rise, Pepperoni | 589 | 25 | 9 | 1973 |
| | Deep Dish Pan Style, Supreme | 584 | 31 | 10 | 1129 |
| | Deep Dish Mini, Supreme | 615 | 33 | 10 | 1174 |
| 5.) | Jack's Original Pizzas (Kraft Foods, Inc.) | | | | |
| | Pizza Bursts, Pepperoni & Sausage | 668 | 5 | 18 | 1256 |
| | Pizza Bursts, Suprema | 695 | 38 | 22 | 1310 |
| | Pizza Bursts, Pepperoni | 695 | 40 | 25 | 1470 |
| | Pizza Bursts, Sausage & Pepper | 668 | 35 | 18 | 1176 |
| 6.) | Totino's Party (General Mills | | | | |
| | Crisp Crust Party Pizza, Cheese | 526 | 23 | 9 | 1013 |
| | Crisp Crust Party Pizza, Pepperoni | 595 | 35 | 10 | 1363 |
| | Crisp Crust Party Pizza, Sausage and Pepperoni | 886 | 50 | 12 | 1931 |
| 7.) | Tony's Pizzas (Schwan, NA) | | | | |
| | Deep Dish, D'Primo Sausage | 629 | 32 | 10 | 1334 |
| | Original Crust, Cheese | 628 | 36 | 13 | 1031 |
| | Original Crust, Sausage & Pepperoni | 619 | 34 | 9 | 1311 |
| | Original Crust, Supreme | 668 | 37 | 13 | 1372 |
| 8.) | Celeste (Aurora Foods) | | | | |
| | Pizza For One, Cheese | 561 | 28 | 9 | 1567 |
| | Pizza For One, Deluxe | 521 | 28 | 10 | 1378 |
| | Pizza For One, Sausage & Pepper | 621 | 35 | 11 | 1642 |
| | Pizza For One, Suprema | 584 | 31 | 10 | 1518 |
| 9.) | Other pizza processors | | | | |
| | Mexican Pizza, (Health is Wealth) | 445 | 21 | 11 | 1013 |
| | Cheese Pizza, (Heaven's Bistro) | 574 | 29 | 10 | 1387 |
| | Five Cheese & Tomato, (California Pizza Kitchen) | 616 | 29 | 17 | 1375 |

### Pizza's Popularity—USA

In the USA, pizzas are school lunch-meal favorites. In 1995, the Nutritional Advisory Council (NAC) coupled with the American School Food Service Association (ASFSA), conducted a two-year nationwide school lunch survey to identify and rank cafeteria foods. NAC-ASFSA cited that in 1995-96, ethnic (Italian) pizzas (i.e. pizzas coated with a tomato paste) ranked overwhelmingly first (1^{st}) place as the most favorite school lunch meal item, two-years in a row.

In 2000-01, NPD Foodworld conducted two-year nationwide food consumption surveys ranking dinner entrées in the food retailing and foodservices sectors. Their surveys showed that consumers in both sectors (i.e. food services & food retailing) categorized ethnic (Italian) pizzas (i.e. Pizzas that are coated with a tomato paste) as their 2^{nd} most favorite dinner entrée (after chicken); moving up from 8^{th} place in 1990-91, and surpassing the popularity of hamburger (8^{th} place). Compared to their 1990-91 survey, NPD Foodworld's 2000-01 market data showed ethnic (Italian) pizzas were consumed much more frequently, and their popularity increased significantly two-years in a row.

Americans continue to consume pizzas, frequently. In 2003, the United States consumed about 22-billion two-slice servings of pizza, which equates to roughly an annual pizza consumption of 50-servings per capita “away-from-home,” and 25-servings per capita “at-home.” In the US, the annual pizza consumption averages about 75 servings per capita. Assuming that each pizza serving equals two-slices, than Americans are annually consuming about 13 pounds of pizza, per capita (i.e. 75 servings/capita×600 kcal÷3500 kcal/lb=12.9 lb). With these high levels of fatty, salty, caloric pizza consumption, is it any wonder that Americans have grown more overweight/obese?

Over the past decade, Americans have significantly increased pizza consumption, paralleling the epidemic rise in obesity/overweight prevalence. In 2005, the Center for Disease Control (CDC), National Center for Health Statistic's National Health, and Nutrition Examination Survey (2005) reported that 15% of the 6-19 year olds, among all races & ethnicities were obese/overweight, and that 21% of the 6-19 year olds of low-income Blacks & Latinos were obese/overweight. Youth obesity/overweight occurrences in the USA has escalated upward from 11% in 1994, and doubled between the years of 1980-94. Black and Latino populations escalate their dietary disease risks by consuming significantly more pizzas than others groups, for reasons of economy & convenience.

### USA Prior-Art

Ethnic (Italian) pizzas, of the type with a tomato paste coating over rolled out, flattened raised bread, dominate sales. Common pizza dough products include regular, deep-dish/stuffed-pan, wraps/rolls, and thin crusts. Popular pizza toppings are pepperoni, sausage, bacon, extra cheese, chicken, beef, peppers, anchovies, and such forth. Rising in popularity are gourmet-type pizzas that are topped with more obscure items like fish (i.e. shrimp, crayfish) and/or exotic vegetables (i.e. eggplant, artichoke hearts), on specialty dough-type crusts.

American regional favorites are Chicago-style pizzas that consist of deep-dish pies stuffed with tomato-paste, cheese, sausage, & peppers; Mexican style pies that are spiced with hot salsa, cheese, & BBQ beef/chicken; California-style pizzas that have crispy, thin crusts topped with garden vegetables & cheese, and New York-style pies that are cheese pizzas with thin or regular crusts. Californian/New York-style pizzas generally contain about 40-45% fat, and Chicago/Mexican-style pizzas generally contain about 45-52% fat.

TABLE 2
Nutrient Facts
Leading Fresh-Baked Pizzas
(2-Slice Servings or Equivalent).

| | | Cal. (Kcal) | Fat (g) | Sat. Fat (g) | Sodium (mg) |
|---|---|---|---|---|---|
| 1.) | Cheese pizzas. | | | | |
| | Domino's Thin Crust Extra Cheese (5 squares) | 750 | 37 | 16 | 2,330 |
| | Domino's Deep Dish Extra Cheese (2 slices) | 740 | 35 | 14 | 1,800 |
| | Little Caesars Thin Crust Cheese (2 slices, 10 oz) | 650 | 30 | 13 | 1,600 |
| | Pizza Hut Stuff. Crust Cheese (2 slices, 11 oz) | 720 | 32 | 14 | 2,180 |
| | Pizza Hut Big New Yorker Cheese (2 slices, 12 oz) | 760 | 34 | 18 | 2,280 |
| 2.) | Veggie pizzas. | | | | |
| | Domino's Deep Dish Veggie (2 slices) | 770 | 36 | 14 | 1,860 |
| | Domino's Thin Crust Veggie (5 squares) | 780 | 38 | 16 | 2,430 |
| | Pizza Hut Big NY Veggie Lover's (2 slices, 24 oz) | 900 | 44 | 12 | 2,680 |
| | Pizza Hut Stuff. Crust Veggie Lover's (2 slices, 14 oz) | 840 | 34 | 16 | 2,080 |
| 3.) | Ham pizzas. | | | | |
| | Domino's Deep Dish Hawaiian (2 slices) | 780 | 36 | 14 | 2,040 |
| | Domino's Thin Crust Hawaiian (5 squares) | 810 | 38 | 17 | 2,720 |
| | Pizza Hut Stuff. Crust Ham (2 slices, 11 oz) | 660 | 26 | 12 | 2,260 |
| | Pizza Hut Big New Yorker Ham (2 slices, 12 oz) | 680 | 26 | 12 | 2,320 |
| 4.) | Pepperoni pizzas. | | | | |
| | Domino's Thin Crust Pepperoni (5 squares) | 800 | 42 | 17 | 2,560 |
| | Little Caesars Thin Crust Pepperoni (5 sq., 11 oz) | 800 | 45 | 18 | 2,100 |
| | Pizza Hut Stuff. Crust Pepperoni (2 slices, 12 oz) | 880 | 38 | 18 | 2,230 |
| | Pizza Hut Stuff. Cr. Pepperoni Lover (2 slices, 12 oz) | 840 | 42 | 18 | 2,700 |
| | Pizza Hut Stuff. Cr. Pepperoni Lover (2 slices, 14 oz) | 1,050 | 52 | 25 | 2,830 |
| 5.) | Sausage pizzas. | | | | |
| | Domino's Thin Crust Italian Sausage (5 squares) | 820 | 42 | 17 | 2,520 |
| | Pizza Hut Stuff. Crust Italian Sausage (2 slices, 11 oz) | 960 | 46 | 21 | 2,330 |
| | Pizza Hut Big New Yorker Sausage (2 slices, 16 oz) | 1,140 | 66 | 28 | 3,240 |
| 6.) | Beef/Chicken pizzas. | | | | |
| | California Pizza Kitchen, BBQ Chicken (1pie, 14 oz) | 1,000 | 32 | 14 | 2,060 |
| | Pizza Hut Stuff. Crust Chicken Supr. (2 slices, 13 oz) | 860 | 34 | 16 | 2,220 |
| | Domino's Thin Crust Beef (5 squares) | 820 | 44 | 18 | 2,470 |
| | Pizza Hut Personal Pan Beef (1 pizza, 10 oz) | 710 | 35 | 14 | 1,580 |
| | Pizza Hut Big New Yorker Beef (2 slices, 15 oz) | 960 | 52 | 22 | 2,760 |
| 7.) | Bacon or pork pizzas | | | | |
| | Domino's Deep Dish Bacon (2 slices) | 830 | 43 | 16 | 2,000 |
| | Domino's Thin Crust Bacon (5 squares) | 890 | 49 | 19 | 2,660 |
| | Pizza Hut Stuff. Crust Pork (2 slices, 12 oz) | 920 | 42 | 19 | 2,350 |
| | Pizza Hut Big New Yorker Pork (2 slices, 15 oz) | 940 | 50 | 20 | 2,940 |
| 8.) | Meat-and-veggie combo pizzas | | | | |
| | Domino's Deep Dish America's Favorite (2 slices) | 850 | 44 | 17 | 2,160 |
| | Domino's Deep Dish Extravaganza (2 slices) | 870 | 45 | 17 | 2,270 |
| | Domino's Thin Crust America's Favorite (5 sq.) | 930 | 51 | 22 | 2,920 |
| | Domino's Thin Crust Deluxe (5 squares) | 820 | 42 | 17 | 2,540 |
| | Domino's Thin Crust Extravaganza (5 squares) | 950 | 52 | 21 | 3,120 |
| | Pizza Hut Stuff. Crust Super Supreme (2slices, 14 oz) | 1,010 | 50 | 22 | 2,740 |
| 9.) | Meat combo pizzas. | | | | |
| | Domino's Thin Crust Meatzza (5 squares.) | 1,030 | 59 | 25 | 3,400 |
| | Domino's Deep Dish Meatzza (2 slices) | 910 | 49 | 19 | 2,440 |
| | Papa John's Orig. Crust All Meats (2 slices, 11 oz) | 780 | 38 | 14 | 2,200 |
| | Pizza Hut Stuff. Crust Meat Lover's (2 slices, 10 oz) | 830 | 42 | 19 | 2,670 |

According to ACNielsen's 1996 survey, America's best-selling packaged pizzas were 34% deluxe, 24% pepperoni, 21% plain-pizzas, and the balances were sausage, hamburger, & bacon. According to NPD Foodworld's 2000-01, two-year nationwide food-consumption survey, pepperoni is American's most popular pie topping (34% of the pizza orders), and 99% of pizzas sold were tomato-paste cheese type pizzas with 75% regular-crust; 15% stuffed-pan/deep-dish; 9% thin-crust, and 1% specialty-pizzas (e.g. salad pizza or ricotta pizza).

According to Mintel's—March 2005 report entitled: “Pizza—USA, Food Retailing & Foodservices Sectors,” the following were the new 2005 pizza product releases: Aldi, Mama Cozzi's “Self-Rising Crust, 3-Meat Pizza”; Target, Market Pantry's “Deep Dish Mini Pizzas”; Uno Food's “Chicago-Style Pizza”; Schwan, Carb-Comfort's “Meat-Trio Pizza”; Trader Joe's “Pizza Margherita”; Nestle USA, Stouffer's “Lean-Cuisine's Zesty-Pepperoni French-Bread Pizza”; Kraft Foods, DiGiorno's “Microwave-Rising Crust Pizza”; Amys Kitchen's “Cheese Pizza Snacks”; Safeway—Milena's “Hawaiian-Style Pizza”, and Con Agra, MaMa Rosa's “Bite My-Slice, Spicy-Nacho Beef Pizza.”

### Pizza Marketing System

Ethnic (Italian) pizzas are an important dietary staple in the United States. In 2003, United States, Department of Agriculture, Economic Research Service (USDA-ERS) reported that the pizza market supplied $36.7 billion worth of pizzas to the US-Food Marketing System, constituting 3.6% of the total $995 billion worth of food. The dietary and economic importance of the pizza industry is demonstrated by its considerable revenues it generates. The pizza marketing system is divided into two major segments, namely the “foodservices” and “food retailing” sectors.

### Foodservices—Fresh Baked Pizzas Produced as “Food Away-From-Home”

As the majority of Americans now lives in urban centers and work outside the home, the “food away-from-home” sector has increasingly dominated the marketplace. In 2003, USDA-ERS reported foodservices produced $33 billion fresh-pizzas for immediate consumption “on-premises or take-out,” constituting 7.4% of the total $445 billion worth of US foodservice revenues. In 2003, the US foodservice sector comprised 14% Institutional (e.g. schools, nursing) & 86% restaurants (i.e. 69,000 full services, fast restaurant service, and fast food establishments). These restaurants are comprised of 64% independently owned & operated pizzerias, 11% Pizza Hut, 7% Dominos, 4% Papa Johns, and 10% small chains.

Fresh-baked pizzas have better taste than packaged products, and are preferred when convenient, practical, and affordable. In the US, fresh-baked pizzas outsell packaged pizzas by a factor of 2:1, as consumers are willing to pay more for tastier pizzas over the value and convenience of retailed products. In the US, fresh-baked pizzas are an affordable commodity that is bolstered by readily available raw foodstuffs, energy resources, and proper hygiene/sanitation.

Table 1 shows the leading fresh-baked pizza brands for consumption “away-from-home that are marketed by the top ten US pizza sellers. The table identifies the following product information for a 2-slice serving or its equivalent: calories (kcals); lipids (grams); saturated fats (grams), and sodium Na (milligrams). The elevated fat, sodium, and calories levels contained in these leading brands place millions of consumers at risk for acquiring dietary diseases.

TABLE 3
Nutrition Facts
Pepperoni & Sausage Pizza
(Averaged Among All Brands.)

| | | | % Daily Value | |
|---|---|---|---|---|
| Dinner Entrée | Prior art | | 2000 kcals | |
| Serving size: | 227 g (8 oz.) | | (% DV) | |
| Calories | 602 | kcal | | |
| Total Fat | 31 | g | 65 | g (48%) |
| Saturated Fat | 10 | g | 20 | g (50%) |
| Cholesterol | 48 | mg | 300 | mg (16%) |
| Sodium | 1328 | mg | 2400 | mg (55%) |
| Total Carbohydrates | 56 | g | 300 | mg (19%) |
| Dietary Fiber | 4 | g | 25 | mg (16%) |
| Protein | 24 | g | 50 | mg (48%) |
| Calcium | 298 | mg | 1000 | mg (30%) |
| Potassium | 398 | mg | 3500 | mg (11%) |

Calorie Breakdown

| | |
|---|---|
| Calories from Fat | 279 (46%) |
| Calories from Carbohydrate | 224 (38%) |
| Calories from Protein | 99 (16%) |

Calorie Breakdown: 46% F: 38% C: 16% P

In 2003, foodservices supplied 22.1 billion, two-slice pizza servings in the “food away from home sector.” As shown in Tables 1-6, the leading brands negatively influence the dietary health & nutrition of millions of consumers by containing high calorie, fat, and sodium levels. The escalating overweight/obesity occurrences underscore consumer need for tastier, healthier, thriftier pizza products.

In August 2003, the USDA, Food Safety, & Inspection Service (FSIS) rescinded stature 9 CFR 319.600 from the Federal Regulation—68 FR 44859 (Meat Inspection). Under this enactment, the minimum required meat constituents were reduced from 12% cooked (15% raw) to 2% cooked (3% raw). Although this regulatory revision was enacted to improve pizza processors compliance with USDA dietary guidelines, it has encouraged quite the opposite trend (i.e. increased fat, reduced-protein food products).

### Retailed Packaged Pizzas Produced by Food Processors in the “Food At-Home” Sector.

In 2003, pizza processors supplied $3.7 billion worth of pizzas to the US-Food Marketing System; constituting 0.7% of the total $504 billion worth of food retailed, as per USDA-ERS. In 2004, frozen pizzas in the US, garnered 92% of the packaged pizza revenues. Packaged pizzas for “at-home” consumption are produced by pizza processors and retailed in warehouse clubs & foodstores (e.g. supermarkets, hypermarkets). The major packaged pizza categories are a.) Frozen pizzas, frozen crusts or dough; b.) Refrigerated pizza kits, crust, dough, or sauce, and c.) Shelf-stable pizza crusts, kits, sauce, or dough mix.

In 2004, ACNielsen's global survey showed packaged pizzas had a 6% annual growth rate. In many parts of the world, frozen pizzas provide convenient, ready-made meal replacement solutions that are important to the daily rhythm of modern life, and are good value for the money. The convenience of portion-packaged, ready-made, frozen pizzas further benefits graying, elderly, singles, night/odd shift workers, and dietetic individuals.

TABLE 4
Nutrition Facts
Schwan's Franschesta
12″ Self Rising Pepperoni Pizza
(No 1. - top frozen packaged pizza maker in US)

| | | | % DV- | |
|---|---|---|---|---|
| Dinner Entrée | | | 2000 kcals | |
| Serving size: | 227 g (8 oz.) | | % Daily Value | |
| Calories | 648 | kcal | | |
| Total Fat | 33 | g | 65 | g (48%) |
| Saturated Fat | 12 | g | 20 | g (53%) |
| Cholesterol | 56 | mg | 300 | mg (16%) |
| Sodium | 1488 | mg | 2400 | mg (62%) |
| Total Carbohydrates | 57 | g | 300 | mg (24%) |
| Dietary Fiber (2%) | 2 | g | 25 | mg (19%) |
| Protein | 24 | g | 50 | mg (48%) |

Calorie Breakdown

| | |
|---|---|
| Calories from Fat | 296 (45%) |
| Calories from Carbohydrate | 256 (40%) |
| Calories from Protein | 96 (15%) |

Calorie Breakdown: 45% F: 40% C: 15% P

In 2004, Kraft & Schwan garnered 66% or $1.8 billion of the US frozen pizza market revenues. Kraft & Schwan are price competitive, profit conscious competitors that exert considerable control over the frozen-case selections. According to Mintel's 2005—US pizza report, vendor profit margins closely follow consumer taste preferences over health & nutrition. Concurrently, Schwan's remarks for Baking & Milling News, Fending Off Challenges; May 2004, “we're not joining the low-carb craze until/unless new product matches the taste of Red Barons, Tony's & Freschettas” focuses on product taste, fueled by concerns over earnings.

Tables 1-6 demonstrate that commercially sold pizzas from both sectors are far from complying with the USDA dietary recommendations. Table 2 covers the leading pizza brands retailed for “food at-home” consumption that are manufactured by the top-ten US pizza processors. Table 2 identifies the calories (kcal), total-lipids (grams), saturated fats (grams), and sodium, Na (milligrams) for a 227 g (8 oz ) two-slice, cooked serving of pizza.

### Tastes & Profits Over Health & Nutrition.

In 2001, the USDA-ERS issued a report on their “Comprehensive 25-year Nationwide Food Consumption Surveys,” (2001). The report cited that frequent consumption of pizza, savory-snacks, candy, and soda was linked with promoting an epidemic rise in overweight/obesity occurrences. Pizza makers are largely motivated by tastes & profits over health & nutrition, which unfortunately has taken its toll on millions of consumers.

Not much has changed despite a decade of extensive public health campaigns coupled with FSIS Federal Regulatory change in 2003 (i.e. the rescinding of pizza's standard of identity), and the myriad of food labeling laws. Tables 1-6 show that the leading pizza products routinely contain escalated levels of calories, fatty acids, saturated fats, and sodium levels, which far exceed the DRV (daily reference values) set by the USDA. As shown in Tables 1-6, the majority of these products contain 35-50% fats by calorie content, often half from saturated fats.

As shown in Tables 1-6, rampantly salty, fatty, caloric pizzas negatively affect millions of consumers by depleting their daily allowances, posing a public health threat over promoting dietary disease, and by not meeting consumer's health/nutritional needs.

TABLE 5
Nutrition Facts
Schwan's - Red Baron's -
Classic 4 Cheese Pizza
No 1. - top frozen packaged pizza maker in US

| | | | % Daily Value | |
|---|---|---|---|---|
| Dinner Entrée | | | 2000 kcals | |
| Serving size: | 227 g (8 oz.) | | (% DV) | |
| Calories | 632 | kcal | | |
| Total Fat | 35 | g | 65 | g (54%) |
| Saturated Fat | 14 | g | 20 | g (70%) |
| Cholesterol | 48 | mg | 300 | mg (16%) |
| Sodium | 1184 | mg | 2400 | mg (49%) |
| Total Carbohydrates | 54 | g | 300 | mg (18%) |
| Dietary Fiber (2%) | 2 | g | 25 | mg (8%) |
| Sugars (13%) | 7 | g | — | |
| Protein | 26 | g | 50 | mg (48%) |
| Calcium | 300 | mg | 1000 | mg (30%) |

Calorie Breakdown

| | |
|---|---|
| Calories from Fat | 312 (49%) |
| Calories from Carbohydrate | 216 (34%) |
| Calories from Protein | 104 (15%) |

Calorie Breakdown: 49% F: 34% C: 15% P

### Pizzas Linked—Dietetic Diseases & Overweight/Obesity

Americans consume estimated 32 billion-2 slice servings of ethnic (Italian) pizza, annually. At 98% market-share, ethnic (Italian) pizzas dominate the industry. In the “at home” and “away-from-home” sectors, tomato-paste coated pizzas are Americans 2^{nd} most favorite dinner-entrée. As illustrated in Tables 1-6, in both sectors, the top-ten leading pizza brands are loaded with fats, calories, and sodium. Frequently consuming ethnic (Italian) pizzas elevates overweight/obesity and dietary disease risks.

TABLE 6
Nutrition Facts
Thin Crust Cheese Pizzas
(Average of All Product Brands)

| | |
|---|---|
| Cooked Product Wt: | 1–227 g (8 oz) |
| | 2-slice serving |

| Calories | 691 | | % Daily |
|---|---|---|---|
| | (35%) | | Value |
| | | | 2000 kcal |
| Total Fat | 36 | g | 55% |
| Saturated Fat | 16 | g | 79% |
| Cholesterol | 80 | mg | 27% |
| Sodium | 1320 | mg | 55% |
| Total Carbohydrates | 60 | g | 20% |
| Dietary Fiber | 4 | g | 18% |
| Sugars | 7 | g | |
| Protein | 32 | g | |
| Calcium | 682 | mg | |
| Potassium | 398 | mg | |
| Calories from Fat | | | 320 (46%) |
| Calories from Carbohydrate | | | 241 (35%) |
| Calories from Protein | | | 129 (19%) |

Calorie Breakdown: 46% F: 35% C: 19% P

### Prior-Art Calorie Breakdown—Over Prior-Art

The major pizza brands in the foodservices & food retailing sectors, shown in Tables 1 & 2, respectively, are far from complying with USDA dietary recommendations. Tables 3-6 further demonstrate the pizza industry's lack of compliance with the USDA dietary guidelines. Table 3 shows that “pepperoni & sausage cheese pizzas,” on average contain 46% fat, 38% carbohydrates, and 16% protein. Table 4 shows Schwan's “Self-rising pepperoni pizza” contain 45% fat, 40% carbohydrates, and 15% protein. Table 5 shows Schwan's Red Baron—“Four-cheese pizza” contains 49% fats, 34% carbohydrates, and 15% protein. Table 6 shows “thin crusted cheese pizzas” on average contain 46% fat, 35% carbohydrates, and 19% protein.

Based upon overwhelming, convincing medical evidence, high dietary intake of fats, sodium, and cholesterol escalate CVD risks. The World Health Organization's World Health Report (2002) made the following dietary disease correlations: a) Dietary-induced hyperlipidemia (elevated blood lipids) is primarily manifested by high saturated fat intake; b) Dietary-induced hypertension is primarily manifested by high sodium intake; c) Dietary-induced hypercholesterolemia (elevated LDL-C blood serum) is moderately correlated with high cholesterol intake. Hence, the prior art pizzas promote dietary diseases based on frequently containing high saturated fats and sodium.

Elevated saturated fats, sodium, and cholesterol levels contained in ethnic (Italian) pizzas promote atherosclerosis by escalating blood serum levels of plague forming constituents. Plague is comprised of cholesterol, fatty substances, fibrous tissues, and calcium deposits. Atherosclerosis poses a health concern when arterious plaque thickens and hardens along the artery walls.

WHO, “World Health Report—2002,” cited a worldwide escalation in the rates of overweight/obesity among 6-19 year olds. Likewise, industrialized nations are reporting 60% of 6-19 year olds, now have at least one of the following preventable dietary-induced risk factors: obesity/overweight, hypercholesterimia, hyperlipidemia, and/or hypertension, which frequently are retained into adulthood.

### Pizzas are Unsuitable for Most Americans

The epidemiologic reports prepared by the CDC, NCHS, NHNES, Nationwide Health Surveys (2005), show sobering dietary disease rates in the USA: adult overweight/obese prevalence—66% (141 million); adult obesity occurrence—25% (54 million); child overweight/obesity prevalence is 15% (10 million) among 6-19 year olds; diabetic occurrences—13% (38 million); hypertensive rates are 45% (65 million) adults; coronary heart disease (CHD), mortality rate—21% (45 million) adults, and CVD morbidity rate, yearly—9 million (40%) deaths; diabetics—13% (38 million), and average sodium intake is nearly double the USDA-DRV's (daily reference values). Furthermore, CDC (2005) surveys showed dietary disease rates are especially prevalent among low-income Blacks & Latinos, whom are more likely to consume pizzas, for economy and convenience. These health surveys demonstrate ethnic (Italian) pizzas are unsuitable for the lion's share of consumers whom already have/at risk of acquiring dietary-diseases.

### AHA (TLC) Magnify Pizzas Poor—Health Outlook

American Heart Association (AHA), Therapeutic Lifestyles Changes (TLC), dietary guidelines recommend reducing the USDA daily reference values for key nutrients linked with escalating dietary diseases shown in Table 7, as follows: lipids≦20% daily caloric intake; saturated fats≦7% daily caloric intake; trans-fats≦3.5 mg; sodium≦1500 mg, and cholesterol≦200 mg. These reduced values now apply to the majority of the population whom have/at risk for the CVD, CHD, diabetes, atherosclerosis, hypertension, heart-attack, digestive-track diseases, hyperlipidemia, hypercholesterolemia & certain cancers, and should limit their daily intake in accordance with AHA (TLC) dietary recommendations.

TABLE 7
Caloric Breakdown - Based on 2,000 Kcal/day Intake⁴

| | Reference | | | |
|---|---|---|---|---|
| | | | ACSM | ASCM |
| | | | Aerobic | Strength & |
| | USDA General | | Training | Conditioning |
| Nutrition | Population^{1,5} | AHA - TLC³ | Athletic² | Training.² |
| Protein | 10% (65 g)¹ | See USDA | 15–20%² | 12–15%² |
| Carbohydrates | 60–65% (300–325 g) | ″ | 55–60% | 60–68% |
| Fats | 20–30% (44–65 g) | 20% (44 g)³ | 20–25% (44 g) | 20–25% |
| Saturated Fats | 10% (20 g) | 7% (16 g)³ | See USDA | See USDA |
| Sodium, Na | 2400 mg⁵ | 1500 mg³ | ″ | ″ |
| Cholesterol | 300 mg | 200 mg³ | ″ | ″ |

FOOTNOTES:
¹USDA, daily protein intake for general populations is 1.0 g/kg/day.
²American Academy of Sports Medicine, (ACSM), daily protein intake for sport populations, ranges from minimum of 0.8–1.0 g/kg/day to maximum of 2.0 g/kg/day.
³American Heart Association (AHA) - Therapeutic Lifestyle Changes (TLC) Dietary Guidelines. For those individuals with/at risk of dietary diseases, the AHA strongly recommends lowering the USDA - DV for nutrients associated with escalating disease risks, (with USDA concurance).
⁴Daily calorie allowances - should be based upon energy intakes required to achieve & maintain a healthy body mass, which for sedentary aging women frequently fall around 1500 kcal/day.
⁵Sodium Na - 2400 mg supplying 6,162 mg/tsp salt, Sodium Chloride, NaCl per teaspoon, equivalent to: Sodiuim Na 2,424 mg (39.337%) & Chloride, Cl 3,738 mg (60.7%) per teaspoon.

Realistically, many women have daily calorie intakes of only 1500-1800 kcals that dip even lower with inactivity and age. The AHA (TLC) daily total lipids & saturated fats intakes vary widely with calorie allowances to achieve, and maintain a healthy weight: a.) The fat intakes for 2,000 kcals are greatly reduced to lipids≦44 g & saturated fats≦16 g; moderately inactive females with a daily caloric intake of 1,800 kcals the allowable lipids≦40 g & saturated fats≦14 g; sedentary females with a daily intake of 1,500 kcals has a daily allowable intake of lipids≦33 g & saturated fats≦11 g, and weight-reducing females with a daily intake of 1,350 kcals have only an allowable lipids≦30 g & saturated fats≦10 g.

Tables 1-6 demonstrate that consuming a 2-slice serving of ethnic (Italian) pizzas frequently approaches/exceeds the USDA/AHA (TLC) recommended daily values for fats, saturated fat & sodium, as well as reduces consumer allowances to meet their other nutritional needs.

### Western Industrialized Nations—Dietary Fats Consumption

Americans still “buy-into” mass-marketed, profit-driven pizzas that are cheese-laden, gargantuan pies, topped with pepperoni (Americans' favorite pizza topping), bacon, or sausage. To entice American consumers, manufacturers frequently give pizza products, names like “Sweet-n-Crusty” or “Big Mama Rosa.” From thin to stuffed-pan/deep-dish crusts, pizza makers are increasingly adding more fats and dextrins to simply impart sweetened, buttery flavors.

Amid the ever-growing dietetic pizza market, American consumers are unwilling to swap taste over lower fat. Nationwide food consumption surveys show American consumers consider the pizza taste of major importance, and its nutrition of minor (Sources Decision Analysis, Inc., “Frozen Pizza Leaves Consumers Wanting More” December 2003, and Mintel, 2005, reported similar findings).

Pizza makers are increasingly adding more sugars to command a larger share of the market, simply because sweetened-savory foods are more satisfying to consumers. Adding sucrose or dextrins to pizzas increases calorie levels, promotes dental caries, and escalates dietary-disease prevalence. Furthermore, adding sucrose or dextrins can be injurious to diabetic consumers whom now make up 10% (21 million) of the American adult population (Source: US Natl Inst. of Diabetes & Digestive & Kidney Diseases, Natl. Inst. of Health, 2005).

According to the Food & Agriculture Organization of United Nations—Statistical Databases (FAOSTAT), the “Food-consumption Report” (2003) showed escalating dietary-fat & livestock consumption were concomitantly linked to rising dietary-disease particularly in western-industrialized nations, and developing countries over the past 30 years. Specifically, in North American the average dietary-fat intake per capita in 1997-99 was 143 g/day (38% daily caloric intake≈1,287 kcal/d), and had escalated upward [symbol] 23% since 1967. Even higher than North America were the European continents with an average dietary-fat intake per capita in 1997-99, as 148 g/day (1,332 kcal/d≈39% daily caloric intake), and had escalated upward [symbol] 31% since 1967. Anecdotally, these statistical findings closely correlate with the high lipid levels shown in Tables 1-6.

### Fixing What's Wrong with Pizzas?

Worldwide, ethnic (Italian) pizzas are a popular international cuisine, comprised of cheese-tomato paste-dough. In the United States, pizzas are the 2^{nd} most popular dinner entrée inside/outside the home (NPD Foodworld, 2000-07), and now dominate about 98% of pizza sales (NPD Foodworld, 2003). The success of ethnic (Italian) pizza is bolstered by the lack of competition from any other diversely mass-marketed pizza prototypes.

What's wrong with pizzas? Well, just about everything from the high saturated fats to the caustic sauce, the easily-burnt cheese, not to mention the high calories and sodium! Judging from Tables 1-6, pizza makers continue to retain soaring levels of key-nutrients that are linked to the escalation in obesity/overweight occurrences. These soaring levels are proof of the irreconcilable differences that cleave the pizza industry, pinned on one side by health/nutritional concerns, and on the other side by the prospects of falling sales over loss of product appeal.

For all the commotions stirred by dietetic pizza makers, their products are not any healthier! Take for example, California Pizza Market's “White Pizza & Spinach”—with its gummy, salty, meltless-cheese toppings, flaked over its wafery-like crust. At a caloric breakdown of 38% fat, 22% protein, and 40% carbohydrates, these pizza products do not comply with the USDA guidelines, either.

Ethnic (Italian) pizzas are gluttonous foods that plague modern life (USDA-ERS, 2001). Sedentary lifestyles require increased intake of nutrient-dense, low-energy foods to avoid sloth and gluttony. On the contrary, prior-art pizzas are nutrient-poor, high-energy foods that deplete consumer's daily allowances without meeting their dietary needs. Consumers are unwilling to swap taste over health/nutrition, despite awareness that high fat and sodium intakes promote dietary-disease.

### BACKGROUND OF INVENTION—SUMMARY

Prior art pizzas are synonymous for ethnic (Italian) pizzas (i.e. dough-tomato paste-cheese combinations)which command over 90% of the pizza industry's market share. Prior art's fatty, salty, caloric pizzas Tables 1-6 supply little nutritional benefit, and approach/exceed consumers' daily allowances. Prior art pizzas are glutinous foods that increase consumer's dietary disease risk by not complying with the USDA/AHA (TLC) dietary recommendations. Despite public pressure from health advocacy groups, pizza makers won't risk product taste/sales profits over lowering lipid and sodium levels. The real issue is that pizza makers are exiguously unable to appreciably lower lipids, sodium or calorie levels without jeopardizing prior art pizza's product quality, as later enumerated.

### USPTO Subclassifications

The USPTO subclassification of Lacteal Coated Pizzas is problematic for a number of reasons. Firstly, Lacteal Coated Pizzas are proteineous-polysaccharide composite foods comprised of roughly half-n-half diary & grain ingredients, and thus neither principally a grain nor mostly a diary product. Secondly, during the product preparation of Lacteal Coated Pizzas, the constituent properties are physically, chemically, and functionally converted into a composite food product. Thirdly, Lacteal Coated Pizzas are perceived, consumed, and assimilated as a composite food product. Therefore, classifying the present invention's Lacteal Coated Pizzas as a composite food that is comprised of “dough-Lacteal Batter (present invention)-toppings,” is a more accurate depiction.

Concomitantly, the present invention's Lacteal Batters are classifiable as a diary-containing food under subclass 426/531/580. These mixtures may be applied to dough/sourdough, encrusted in pasta or other meal dishes, topping/dipping sauce, or adapted to snack-foods. The present invention's Lacteal Batters are innovative, heat-stable, hydrocolloidal-proteineous mixtures that possess unique performance-enhancing, rheological properties that are characterized as creamy viscous-flowing coagulums. These mixtures contain, at the very least: milk, a thickening/stabilizing agent, and lipids.

### SUMMARY OF THE INVENTION

This section starts with an invention overview, and follows with a brief product description. The focus turns to identify what was not understood/unobvious about prior art defects, flaws, and limitations. Followed by a discourse on how the present invention resolves the following prior art's compositional deficiencies: tomato paste's lack of moisture retainage, loss of free/unbound moisture; additives; taste-enhancers (sweeteners, sodium, & fats); lowfat cheese (taste & textural defects worsened by dehydration); health/nutrition concerns, and WHO/FAO-UN global impacts, and concluded by a summary of remarks.

### Overview of the Present Invention

The present invention's Lacteal Coated Pizzas are healthy, tasty, thrifty composite foods that are comprised of dough/sourdough, Lacteal Batter, and preferably a topping product. The present invention's Lacteal Coated Pizzas are new, sizzling, tangy-tasting pizzas that are nutritious, wholesome, calorie-conscious foods. Lacteal Coated Pizzas are thrifty, healthy, tasty, all-in-one meals that are rich in proteins, carbohydrates, vitamins, and minerals (particularly calcium, iron, zinc, and vitamins A & D). Lacteal Coated Pizzas are comprised of soft leaven dough/sourdough that is coated with a delicious heat-stable lacteal batter, and preferably covered with a topping product.

What distinguishes Lacteal Coated Pizzas from prior art is its “Lacteal Batters.” This middle layer component is an innovative, heat-stable, hydrocolloidal-proteineous mixture that possesses unique performance-enhancing, rheological properties. This mixture is characterized as a creamy, viscous-flowing coagulum that is formed from agglomerated (denatured) casein micelles, whey & gluten fractions, and lipid-in-starch emulsion which acts as a hydrocolloidal thickener/stabilizer. Lacteal Batters are preferably prepared using yogurt and/or other fermented milk products, which improves the product shelf life by increasing its pathogenic resilience, aids digestion, and boosts nutritive value.

The present invention's Lacteal Batters transform Lacteal Coated Pizzas into highly nutritious, delicious proteineous-polysaccharide foods. At all stages, Lacteal Batter's slow-moisture precipitation enhances performance and preserves product freshness.

The present prototype invention addresses a complex assortment of product performance criteria, in addition to resolving prior-art defects such as its flawed composition, poor-nutritive value, and derisive dietary-health concerns.

Based upon extensive product searches, no commercially marketed pizzas or patented archives resemble the present invention's Lacteal Coated Pizzas. For a number of important reasons later enumerated, the pizza industry continues to almost exclusively market ethnic (Italian) pizzas (i.e. cheese-tomato paste-dough pies).

### Product Development

The present invention was invented and developed in privately owned & operated commercial bakeries, located in New York and Connecticut, over the past fifteen years. These bakery facilities were equipped with large mixers, blenders, slicers/dicers, dough-racks, cold storage, and deep-freezers. Food products were cooked using large, commercial bakery ovens. Thousands of trial batches were conducted under varying conditions, using a variety of bulk packaged, commercially sold, GRAS foods, and raw-foodstuffs. The present invention's Lacteal Batters & Lacteal Coated Pizzas were tested under chilled, frozen, fresh, and freeze/thaw cycle conditions.

The present invention's Lacteal Coated Pizzas evolved only after many years of trial batches that led to the development of a suitable prototype. The development of the preferred embodiment and its product applications are fully disclosed in the ensuing detailed description. The product development was greatly facilitated by a wealth of bakery-arts experience, combined with the necessary time, materials, and equipment. Prior to this patent filing, neither the present prototype invention (i.e. preferred embodiment), nor its product applications were ever advertised, marketed, and/or commercially sold.

### Profits & Tastes Over Health and Nutrition.

The escalated lipids, sodium, and calories levels shown in Tables 1-6 are indicative of the unresolved dietary-health/nutritional concerns that plague the pizza industry. The pizza industry has not been able to improve on salty, caloric, fatty pizzas without jeopardizing its product quality! Consequently, not much has changed in the pizza industry despite the explosive cheese/dough products that have been developed to ameliorate the high fats, sodium, and calories levels contained in ethnic (Italian) pizzas (i.e. cheese-tomato paste-dough combinations which continue to dominate over 90% of the pizza industry). Furthermore, the FISI's 2003′ rescinding of the pizza standard of identity, which relieved pizza makers of compulsory 15% meat quotas, had quite the opposite intended effect (i.e. After this ruling went into effect, pizza products were permitted to have higher fat and lower protein contents).

The pizza brands shown in Tables 1-6 are disingenuous, hardscrabble products that cater to profits & tastes over health and nutrition. Ethnic (Italian) pizzas now dominate the industry along with a minute fraction of insipid dietetic pizzas that are comprised of wafer-like crusts, topped with gummy, meatless, rubbery-cheeses. Over the past thirty years, pizza consumption has risen dramatically (USDA-ERS, 2001), and concomitantly obesity/overweight & dietary-disease occurrences have rapidly escalated (CDC, 2005), particularly in western industrialized nations (WHO/FOA-UN, 2003).

The main public-health issue is that millions of Americans increase their dietary-disease risks by regularly consuming salty, fatty, caloric pizzas (USDA-ERS 2001).

### Tomato Paste's Popularity Stifled Development of Topping Alternatives?

Essential components of ethnic (Italian) pizzas are its tomato-paste's flavorful-taste and colorful appearance. Unlike its cheese or dough, tomato-pastes are popularly regarded as antioxidant-containing healthy-foods (i.e. vitamin A & lycopene). Public perception of tomato-pastes has long been bolstered by media-campaigns tooting its health benefits while unpublicizing its insufficiencies (i.e. elevated sodium, black pepper, sugar, & acidity). Conversely, cheese and pizza dough had ignited an explosive product development aimed at ameliorating the negative dietary health/nutritional defects that surround the frequent consumption of ethnic (Italian) pizzas.

The role of tomato pastes in escalating lipids and sodium levels in ethnic (Italian) pizzas has remained unexamined and unresolved due to a number of factors. Neither the public nor the pizza industry has signaled an interest in modifying/replacing tomato paste pizza topping sauce. Replacing tomato paste as a pizza topping sauce was simply inconceivable in light of its international popularity, publicly perceived healthy-food image, and its unapparent role in escalating the dietary-health/nutritional concerns plaguing the pizza industry.

Most importantly, the pizza industry hasn't commercially promoted a diverse enough, nutritious, and flavorful topping sauce replacement for tomato paste. Concomitantly, tomato paste's high sodium and poor moisture regulating performance have gone unchallenged. The present invention's thrifty, healthy, tasty pizza's significantly reduces sodium, black pepper, sugar, and acidity levels by eliminating tomato paste, and resolves numerous other prior art defects as later enumerated.

### Tomato Pastes Role was Poorly Understood.

The present invention's Lacteal Batters resolve tomato-paste's unapparent moisture regulating properties, which are crucial to product performance. Tomato paste coated pizzas continue to dominate the pizza industry. Consequently, the popularity of these products has obscured the pizza industry's interest in examining tomato paste's compositional defects associated with its lack of moisture retainage, and its loss of free-unbound moisture.

Firstly, tomato paste's function/role as a “middle layer” component has been poorly understood. Formerly, tomato pastes have been viewed largely as a flavoring that have little other functional attributes. The composition of each layer captured the industry's attention over examining the energy and moisture regulating properties of a three-layer composite food product. Furthermore, the lack of developing suitable alternative sauce applications hindered taking a “fresh look” at tomato paste's product performance/function, as well as its effect on dietary-health concerns pertaining to its high sodium and acidity levels.

Secondly, poorly understood was that product performance is greatly effected by regulating moisture. Moreover, tomato-paste's poor moisture regulation lowers product performance. What went unnoticed was that tomato pastes lacked the necessary physical and chemical composition required to regulate moisture effectively.

Thirdly, unnoticed were that at all stages, poor moisture regulation promulgated (worsened) product performance. The primary defects associated with worsened moisture regulation are poor dough-rise, inextensibility, poor-crumb, harder/coarser crusts, poor reheatability, limited shelf life (due to accelerated rates of spoilage), and crystallization (associated with freeze/thaw cycling).

Fourthly, what went unnoticed was that tomato pastes escalate the need for colligative altering constituents, such as lipids, sodium, or additives, in order to ameliorate its moisture regulating defects. More specifically, tomato-paste's poor moisture regulation lowers product quality by causing a majority of prior-art's performance defects. Escalating lipids, sodium, and additives contained in prior art's tomato pastes improves product performance by altering its colligative properties. For example, escalating solute levels in tomato pastes improves product performance by elevating the boiling point, and lowering its rate of evaporation.

Prior art pizza's product quality is lowered by tomato paste's poor moisture regulation. These deficiencies are herein described as the “lack of moisture retainage” and the “loss of free-unbound moisture,” by means of evaporation/topping-product moisture absorption. The rapid loss of moisture during the baking cycle leads to lesser dough-rise, poorer extensibility, larger crumb, and smaller-harder crusts. The present invention resolves these poor moisture regulation defects, as further described in the ensuing information that is presented.

### Lacteal Coated Pizza—Composition.

Formerly, there have been no similar products markets like the present inventions Lacteal Coated Pizzas. The present invention's Lacteal Coated Pizzas are typically composed of a crust coated with the present invention's lacteal batter, and covered with a conventional topping product. The present invention's Lacteal Batters are comprised of creamy, viscous-flowing, nutrient-dense coagulums of agglomerated (denatured) casein micelles that are mixed with a hydrocolloidal stabilizer/thickener agents that are combined with lipids (e.g. lipid-in-starch emulsions), and preferably suspended in an acidic ferment substrate.

Lacteal Coated Pizza's moisture-regulating properties are conferred by its Lacteal Batters. The present invention's Lacteal Batters are protein film coatings that lessen the free-moisture that is available for premature spoilage/ crystallization by slowly releasing entrapped moisture through agglomerated casein micelles. The present invention's Lacteal Batters function as “moisture-regulating layers” that precipitate hydration from temperature-sensitive, hydrophilic casein micelles. This slow-moisture releasal preserves product freshness, and to minimizes moisture-loss by evaporation or crystallization. Formerly, there has been no such similar pizza topping sauce compositions marketed, whatsoever.

### Lacteal Coated Pizzas have Radically Improved Calorie Breakdowns

As shown Tables 1-6, ethnic (Italian) pizzas (prior-art) are fatty, salty, caloric foods that promote over consumption of dietary-disease related nutrients. For example, Table 3 shows the calorie-breakdown for “pepperoni & sausage cheese pizza” (averaged for all brands), as a whopping 46% fat, only 38% carbohydrates, and 16% protein. Similarly, Table 5 shows the calorie-breakdown for Schwan, Red Baron's “Four-Cheese Pizza” as containing heaping 49% fat, mere 34% carbohydrates, and 15% protein. These fatty, salty, caloric foods easily exceed consumer's daily-recommended values of disease related nutrients that deplete their allowance to meet their nutritional-goals.

By comparison, Cheese Lacteal Coated Pizzas, as later shown in Tables 13 & 16, have perfectly balanced calorie breakdowns of 14% fat, 63% carbohydrate, and 24% protein. The present invention's preferred embodiments enable consumers to meet their dietary health/nutritional requirements, while minimizing their overconsumption of dietary-disease related nutrients (i.e. saturated fats, lipids, sodium & cholesterol).

Lacteal Coated Pizzas enabling consumers to better meet their nutritional-goals by complying with the USDA, AHA, and ACSM dietary guidelines shown in Table 7. Conversely, the major product brands shown in Tables 1-6 are noncompliant with these important public-health agency's dietary guidelines. Ethnic (Italian) pizzas are fatty, salty, caloric products, which can no longer be considered as “all-in-one meals.” Concomitantly, as shown in Tables 13 & 16, Lacteal Coated Pizzas are innovative all-in-one meals that are nutrient-dense foods rich in protein, calcium, vitamins A & D, iron, folate & potassium, while low in saturated fats and sodium.

### Lacteal Coated Pizzas Resolve Sodium Defects Over Prior-Art

As shown in Tables 1-6, soaring levels of sodium contained in prior-art pizzas, exceed/approach the dietary guidelines shown in Table 7. Hypertension now afflicts an estimated 45% (65 million) of American adults, whom on average consume nearly double the daily recommended intake (DV) of sodium (Source: CDC, NCHS, NHNES, 2005). As shown in Tables 1-6, prior art pizzas frequently approach/exceed the USDA 2,400 mg sodium DV.

Due to the elimination of tomato paste, Lacteal Coated Pizzas have significantly less sodium. As shown in Tables 13 & 16, the preferred embodiment for a 2-slice, 192 g (6.75 oz) serving of Lacteal Coated Pizza contains 551 mg (23% DV) of sodium compared with 1,320 mg of sodium (58% DV) shown in Table 6, as averaged among all brands of thin crusted ethnic (Italian) cheese pizzas.

The escalating tomato paste's sodium levels alter its colligative properties by increasing its solute concentrations and molecular weights. These altered chemical properties improve prior art's product performance by raising tomato paste's boiling point elevation, lowering its freezing point depression, and increasing its osmotic gradient concentration.

Due to tomato paste's poor moisture regulating properties, the increased solute concentrations are an unobvious method of reducing moisture loss in prior art pizzas. Elimination of tomato paste and replacement with the present invention's Lacteal Batters greatly improves product performance, at all stages while also significantly reducing the sodium and acidity levels also.

### Lacteal Coated Pizzas Resolves High Fat Levels Over Prior-Art.

As shown in Tables 1-6, soaring levels of lipids contained in prior-art pizzas, exceed/approach the dietary guidelines shown in Table 7. Pizza makers' escalated fat levels improve tomato paste's poor moisture-regulating properties, and the lack of lubricity in lowfat cheese toppings. Ethnic (Italian) pizzas typically derive 35˜52% of the calories from fats, wherein half are from saturated fatty acids.

As shown in Table 6, a 227 g (8 oz), 2-slice serving of thin-crusted ethnic (Italian) cheese pizza, averaged for all product brands, contains 1320 mg (55% DV) of sodium, a monstrous 46% fats, a meager 35% carbohydrates, 19% protein, 16 g (79% DV) saturated fats, 36 g (55% DV) total fats, 80 mg (27% DV) cholesterol, and a hefty 691 kcals (35% DV).

These high calorie, saturated fats and sodium levels promote overweight/obese prevalence while depleting consumers' daily allowances. Anecdotally, ethnic (Italian) pizza's typical fat percentiles closely follow the FAOSTAT—2003 reported dietary-fat consumption 38% N. America's and 39% per capita in European Continent (i.e. UKto the Russia). According to the CDC, NCHS, NHNES, Nationwide Health Surveys (2005), 66% (141 million) American adults are overweight/obese, wherein 34% of low-income American Blacks & Latinos are obese. These health statistics show ethnic (Italian) pizzas are unbefitting for the majority of consumers who are already have/at risk for acquiring dietary-diseases, and underscore public need for tasty, healthy, thrifty alternative products like—Lacteal Coated Pizzas.

Tomato-paste coated pizza's popularity obscured the need to develop an effective moisture-regulating middle layer component, and consequently its role was not well understood. Yet further, the improvement of prior art's moisture-regulating properties by escalating the lipid levels was unobvious. Apart from enhancing product appeal, escalating lipid levels improves tomato-paste coated pizza's colligative properties which influences its product performance at all stages that influences its rate of rapid-evaporation, crystallization, and dehydration. By escalating lipids increases the molecular-concentration and molecular weight, which raises the boiling point elevations, lowers the freezing-point depression, and increases the surface-reactivity from altered osmotic-gradient concentrations. Poorly understood was that in the absence an effective moisture-regulating batter, escalating sodium and lipid levels enhances product performance by altering the colligative properties.

Immiscible oil-in-water emulsions in tomato pastes coated pizzas (prior-art pizzas) poses the following disadvantages. Due to the free energy between the interface of the oil (dispersed phase) and tomato-pastes (continuous phase), these types of emulsions are intrinsically unstable. As a result of the increased interfacial area, more energy is needed to keep the immiscible oil-in-water emulsions from coalescing (i.e. reduced particle-sizes or higher fat dispersed-phase materials). Prior-art pizzas escalate the demand for emulsifiers by acting as surface-active agents that keep immiscible oil-in-water emulsion molecules from coalescing, and reducing the energy required to keep these phases apart.

Tomato-paste coated pizzas are particularly vulnerable to dehydration from the loss of free-unbound moisture and poor moisture retainage. Due to rapid moisture loss and poor-moisture regulating properties, prior-art pizzas are only good when freshly baked. Most importantly, Lacteal Coated Pizzas resolve high-fat levels in prior-art pizzas by enhancing the mouthfeel & texture and adding lubricity, particularly to lowfat cheeses.

### Lacteal Coated Pizzas Resolve Moisture Defects Over Prior-Art

Moisture defects in prior art pizzas lower product quality. These defects most prominently stem from a lack of moisture-retention, and the loss of free, unbound moisture in tomato paste topping products. Tomato pastes have free/unbound moisture that evaporates out of the paste, and/or is absorbed into the dough, and/or the topping products. The result is a watery, food product that contains crumbly dough, soggy toppings. Following cooking, prior art pizzas become dehydrated cooked pizzas, and do not reheat well. Further, the free/unbound moisture is available to crystallize during freeze/thaw cycling. The free/unbound moisture also reduces the product shelf life.

At all stages, free, unbound moisture in tomato pastes promote pathogenic spoilage, off-tastes, reduced shelf life, oil-in-water emulsion separations, and crystallization from freeze/thaw temperature cycling. The rapid loss of moisture during baking, leads to dough dehydration that causes a loss of dough rise, and inextensibility. Ethnic (Italian) pizzas are only good when freshly baked, exhibiting poor reheatabilty, limited shelf life, and rapid staling. Relatively soon after baking, pizzas loose taste, texture, and aroma.

The present invention's Lacteal Coated Pizzas resolves the aforementioned prior art defects related to the loss of free/unbound moisture and the lack of moisture. By absorbing, holding, and precipitating moisture from temperature-sensitive pores, the present invention's Lacteal Batters resolve prior art's moisture-regulating defects. Unobvious was the sauce product poor moisture-regulating features promulgated product performance defects associated with dehydration caused by a lack of moisture retainage; evaporation associated with loss of free-unbound moisture; absorption into dough and/or topping products (particularly lowfat, low-moisture cheeses), and crystallization. Poorly understood was that tomato paste were incapable of absorbing, holding, and releasing moisture in order to resolve many of prior-art's performance deficiencies.

Lacteal Coated Pizza's innovative Lacteal Batters are proteineous-hydrocolloidal mixtures that absorb, hold, and release moisture through temperature-sensitive hydrophobic pores. Lacteal Coated Pizzas have the following beneficial features: a) Enhanced shelf life, reheatability, and resilience to dehydration; b) Its slowly precipitates moisture release of during baking cycle from its “sponge-like” hydrophobic pores, without loss of stability, which c) Hydration (moisture precipitated) improves baking performance, and d) enhances dough risibility, extensibility, and crust softness over prior-art.

Lacteal Coated Pizzas have greatly enhanced composition, structure, and function over prior art pizzas. The present invention is characterized as a wholly new and unique proteineous-hydrocolloidal, nutrient-dense matrix of agglomerated (denatured) casein micelles that are preferably suspended in an acidic ferment substrate. Lacteal Batters are viscous, heat stable amalgamations of fermented milk, denatured milk products, nonfat solid milk fractions (NSF), fat replacement globules, hydrocolloids, greens, vitamins, and minerals. The unique rheological behaviors of agglomerated hydrophobic molecules are surface reactive and precipitate moisture under conditions of elevated temperatures, molecular interactions, and demineralization.

### Lacteal Batters Resolve Tomato-Pastes Dietary Defects

Tomato pastes contribute to roughly half of the sodium contained in prior-art pizzas. As demonstrated in Tables 1-6, the high-sodium levels in these products easily approach/exceed the daily sodium intake recommended by USDA ≦2,400, and are harmful to 45% (65 million) of Americans with hypertension. Elevated sodium also promulgates esophageal-lining damage, tooth erosion, and causes water retainage.

Tomato pastes typically have high sodium, sugar, acidity, and black, and in exchange offer little nutritional benefit. Take for example—Hunt's tomato paste spread over a 227 g (8 oz), 2-slice pizza serving. In this example, about 66 g (2.4 oz) of tomato-paste are used to coat the aforementioned 2-slice serving, supplying 50 kcals, 520 mg sodium, and 12 g carbohydrates. Whereby, Hunt's tomato-paste contains 8 g or 72 kcals (64% of calories) from added sugar promotes dental caries, potentially injures diabetics, and raises consumer's dietary-diseases risks.

High-concentrations of black pepper contained in tomato-pastes, expose consumers to unmonitored carcinogenic health-risks. At present, Nutrition Labeling & Education Act (NLEA) does not require manufacturers to post black-pepper levels. The high levels of black pepper routinely contained in tomato pastes poses health risks to consumers as unregulated carcinogenic substances.

Tomato-paste typically has acidity levels of pH 3.5-4.7, which are hazardous to an estimated 20% (62 million) of Americans with digestive-track disorders, gastric & bowel diseases, bowel/gastritis syndrome, acid-reflux, stomach-ulcerations, or irritable-bowel syndrome (IBS). Low pH is equivalent to a high-concentration gradient of hydrogen ions, wherein there is a tenfold increase in acidity for a drop of one (1) pH.

Lacteal Batters outpace tomato pastes on every conceivable level, from the significantly less sodium, to the improved baking performance, dough softness, longer-shelf life, and product diversity. Lacteal Coated Pizzas have a fraction of the sodium compared to tomato-paste coated pizzas. This is due in large part to the elimination of tomato-pastes and substitution with the present invention's Lacteal Batters. Tomato pastes contain about half of the sodium found in ethnic (Italian) pizzas.

### Lacteal Coated Pizzas Resolve Lactose Intolerance Over Prior-Art.

The preferred embodiment's yogurt-containing Lacteal Coated Pizzas confer beneficial digestive-tracks by containing low-lactose levels. The lactose contained in ethnic (Italian) pizzas can cause malabsorbers (lactase-deficient individuals) to exhibit lactose-maldigestion. Lactose (milk sugar) is a disaccharide that consists of glucose and galactose monosaccharides that are joined by dehydration synthesis. Symptomatic maldigestors are lactose-malabsorbers whom possess a mucosal-lactase enzyme deficiency. Due to an inability to hydrolyze lactose (disaccharide) into glucose and galactose (monosaccharides), maldigesters may elicit gastrointestinal (GI) symptoms. These symptoms may include the passing of undigested lactose through the large intestine, in loose-watery stools that are accompanied by flatulence (colloquially known as farting), abdominal distension (bloating), pain, diarrhea, and/or nausea. Due to elevated levels of lactose, ethnic (Italian) pizzas promulgate these GI responses.

Lactose-intolerance varies widely by population group: Austria 25%; Germany 23%; Sri Lanka 72%; Italy 75%; US (Blacks) 26%; Turkey 71%; S. African (Blacks) 78%; Japan 89%, and China 92% (Source: Intro. to Nutrition & Metabolism; D. Bender, 2002). Worldwide over 70% of adults are estimated to be lactose-intolerant, whereby their consumption of ethnic (Italian) pizzas can elicit derisive digestive-track responses.

Conversely, the preferred embodiment's yogurt-containing Lacteal Coated Pizzas confer beneficial digestive-track responses in lactose-intolerant individuals. This is due to significantly lower levels of lactose, high-dietary fiber, ferment by-products, and reduced caustic-effects over tomato-paste products. Lower containing lactose Lacteal Coated Pizzas can be alternatively prepared by using a lactose-free milk fractions, and non-lactose containing cheese topping that is derived for example from component processing, chemical synthesizing, and/or by utilizing slowly fermenting, low-acid microorganisms.

### Lacteal Coated Pizzas Resolve Lowfat, Low-Moisture Cheese Defects Over Prior-Art

Lowfat, low-moisture cheeses have taste and textural defects arising from a lack of lubricity (lipids). These products exhibit textual defects, such as tacky, chewy, cardboardy, and crumbly mouth feels, which are caused by resilient (tight) protein matrixes. Lowfat, low-moisture cheeses exhibit difficult to remedy taste defects like rubbery-bitter flavors that are perceived in the back of the mouth, arising from hydrophobic peptides (i.e. fat-soluble protein fragments).

Prior-art pizzas topped with lowfat, low-moisture cheeses, promulgate “lubricity type defects. To avoid low fat cheese's undesirable off-tastes and textural defects, many pizza makers have returned to using full-fat cheeses.

In contrast, the present invention's Lacteal Batters greatly diminishes lowfat, low-moisture cheese's lubricity defects. Moreover, low fat cheeses typically have undesirable tacky, chewy, crumbly off-tastes and cardboardy textural defects. Lacteal Coated Pizza's resolve these taste and textural defects by enveloping lowfat, low-moisture cheeses with its creamy, thick, rich Lacteal Batters.

### Lacteal Coated Pizzas Reduce Environmental Impacts Over Prior Art

The most challenging problems on earth today involve the efficient utilization of earth's resources to nourish the present 4.6 billion world population, and conserve for future populations estimated to reach 7.5 billion by year 2020 (Source: FAOSTAT, 2003). Malnourishment in developing countries now afflicts over 70% of the population. Widespread hunger is fostered by a geographical mismatch involving overgrazed, infertile lands, poor irrigation, and water shortage. With increasingly abandonment of traditional diets such as roots & tubers, developing countries are growing ever more dependent on food imports from industrialized nations. These imports include frozen-packaged pizzas, which are the most popularly consumed processed food, worldwide (Source: FAO-UN, “Food Consumption & Global Sustainability Report,” 2000), and livestock products which have seen a double-digit rise in consumption over the past thirty years (Source: FAOSTAT, 2003).

The Joint WHO/FAO-UN's global strategies that are pertinent to this patent are to reduce livestock (fish, fowl, & meat) product consumption, and to promote nutrient-dense/low-energy, environmentally friendly, processed-food products. Lacteal Coated Pizzas meet the Joint Council of WHO/FAO-UN, Diet, Nutrition & Prevention of Chronic Diseases (2003)—global strategies far more effectively and efficiently than prior-art pizzas.

### Lacteal Coated Pizzas Reduce Demand for Livestock Products Over Prior-Art.

The Joint WHO/FAO-UN's global strategy on reducing the demand for livestock products stem from the rise in livestock product consumption over the past 30 years, particularly in western-industrialized nations and developing countries (FAOSTAT, 2003). From herd to feed, livestock imposes a long-chain of environmentally unfriendly confluences. Important ecological impacts from livestock product reduction are the lowered natural resources, such as energy, minerals & clean potable water; the decreased effluent pollution, and the increased feed & farmland resources funneled for livestock production over human consumption (FAO-UN, 2003).

Firstly, the present invention lowers livestock demands by supplying a significant daily portion of protein, and thus lessening consumers' dietary needs to be met by livestock products. Worldwide, packaged-pizzas are an important dietary staple, and have a global-growth rate of 6% (ACNielsen, 2004). The substitution of a mere fraction of prior-art pizzas with the present invention's Lacteal Coated Pizzas, would reduce the rising demand/consumption of livestock products.

According to NPD Foodworld (2000/01), Americans favorite pies are pepperoni at 34% (food-away-from home); deluxe at 38% (food-at-home), followed by plain cheese, sausage, bacon or hamburger-topped ethnic (Italian) pizzas. Fatty-meat toppings improve product performance, taste, texture, and aroma by reducing dehydration (occurring from loss of free, unbound moisture/lack of moisture retainage), and increasing lubricity.

Secondly, the present invention lowers livestock demands, by deriving little benefit from using fatty-meat toppings, unlike prior-art. This is due to the present invention's Lacteal Batters—absorb, retain, and release moisture during the product preparation. Consequently, Lacteal Coated Pizzas do not undergo prior art's poor moisture regulating and/or lack of lubricity defects. Compared with ethnic (Italian) Pizzas, Lacteal Coated Pizzas lower the demand/consumption of livestock products.

### Lacteal Coated Pizzas are Nutrient-Dense, Low-Energy, Earth-Friendly Foods.

The Joint WHO/FAO-UN's global strategy on promoting non-carnivorous, nutrient-dense/low-energy, environmentally friendly, processed foods stem from a large percent of the world's population now live and work in urban centers. Packaged pizzas are important to the daily rhythm of modern life by meeting the needs of those whom have little time/resources to prepare traditional meals, and thus rely upon convenient all-in-one processed foods.

Lacteal Coated Pizzas are nutrient-dense, low energy, environmentally friendly processed-foods that achieve aforementioned the food criterias of the Joint WHO/FAO-UN global strategies. Lacteal Coated Pizzas are high-protein, high-carbohydrates foods that are naturally rich in vitamins & minerals, while low in saturated fats and sodium. Conversely, prior-art pizza products are caloric, fatty, salty foods that routinely are served with carnivorous topping products (e.g. pepperoni & sausage). Furthermore, as shown in Tables 13 & 16, the present invention's calorie breakdowns yield nutritious, balanced all-in-one meals that can easily be derived from entirely from non-carnivorous sources.

By contrast, as shown in Tables 3-6, prior-art pizza products make poor meal choices, that routinely use fatty meats as topping products in order to resolve the lack of lubricity and poor moisture regulating defects. From farm to table, Lacteal Coated Pizzas have a lower total energy demand due to the eliminating tomato-paste. Furthermore, Lacteal Coated Pizzas lower consumer's dietary disease risks by reducing the demand for livestock and cheese-topping products.

### Objects & Advantages

Lacteal Coated Pizzas are high-protein, lowfat, nutrient-dense all-in-one meals. To date no other kind of pizza even comes close to equaling the cuisine taste; superior product nutrition, dietary health, ecological advantages, and complies with the USDA dietary recommendations. The present invention's yogurt-containing Lacteal Coated Pizzas have increased health/nutritional benefits, and extended shelf life.

NAC-ASFSA's food consumption surveys showed coast-to-coast, ethnic (Italian) pizzas are the most favorite school lunch-meal item. Despite pizza's popularity, many school districts restrict serving pizzas as a lunch meal-item, because pizzas are categorized as caloric, salty, fatty foods that promote overweight/obesity. In contrast, school districts would find tasty, healthy, thrifty Lacteal Coated Pizzas meet their dietary health/nutritional criteria for its inclusion as lunch meal-item.

Lacteal Coated Pizzas outpace ethnic (Italian) pizzas on every conceivable level from moisture retainage, baking performance, dough softness, longer-shelf life, and product diversity. Lacteal Coated Pizzas are perfectly balanced foods that are rich in proteins, vitamins, minerals, while containing significantly less sodium and fatty acids.

In the areas of health-nutrition, taste, cost, energy conservation, global sustainability, moisture-regulating properties, reheatability, shelf life, lowfat/low-moisture cheeses applications, and product diversity, Lacteal Coated Pizzas outperforms prior art.

Lacteal Coated Pizzas have wholly new delicious, nutritious composite foods that appeal to a wide range of ages and dietary needs from the very young to very old.

Lacteal Coated Pizzas are wholesome, economical, nutrient dense foods that easily manufactured from abundantly available products. By lowering the calories, sodium, cholesterol content while increasing the diary proteins, in comparison to prior art, Lacteal Coated Pizzas address public health concerns over the growing overweight/obesity epidemic. Lacteal Coated Pizzas meet public need for nutritious, delicious, health-choice pizzas. To date, there has not been one similar commercially marketed pizza product and/or archived patent like the present invention's Lacteal Coated Pizzas.

In addition to the benefits and features presented herein, yet more objects and advantages of the present invention will become apparent upon consideration of the ensuring description.

### Authorized Health Claims

In order to commercially market foods in the United States that bear a “health claim,” those products must comply with the United States, Food & Drug Administration (US-FDA), federal regulatory statures which authorize specific package labeling statements. More specifically authorized health claims used to label commercially packaged foods must comply with the following US-FDA's Title 21, Code of Federal Regulations, 21 CFR §101.9(k) (1), §101.14(c), §101.14(d), and §101.70, among other statures. The present invention's Lacteal Coated Pizzas complies with the following authorized health claims by meeting these and other federal regulatory statures.

### Increasing Dietary Intake of Whole Grains, Lowers CHD & Certain Cancers Risks

In accordance with Docket No. 99P-2209, “Whole Grain Foods and Risk of Heart Disease & Certain Cancers,” the present invention's Lacteal Coated Pizzas meet the following food requirements: lowfat foods that contain over 51% dry weight basis (dwb) whole-grains, and contain dietary-fiber of 3.0 g per 55 g (2 oz); 2.8 g per 50 g (1.8 oz); 2.5 g per 45 g (1.6 oz) or 1.7 g per 35 g (1.2 oz). This FDA regulatory standard authorizes the following health claim: While low in total fats, saturated fats & cholesterol, consuming Lacteal Coated Pizzas as part of a healthy-diet, rich in whole grains & other plant foods—may reduce the risk of heart disease and certain cancers.

### Raising Dietary Potassium, Reduces Hypertension & Stroke Risks

In accordance with Docket No. 00Q-1582, the present invention meets the following food requirements authorizing a health claim on the relationship between: potassium, and the risk of high blood pressure or stroke. Lacteal Coated Pizzas are low in fats, sodium & cholesterol, and contain unfortified potassium levels that exceed 10% DV per portion size. This FDA regulatory standard authorizes the following health claim: Although high blood pressure or stroke are associated with many factors, Lacteal Coated Pizzas consumed as part of a low-sodium, potassium-rich, healthy-diet, may reduce the risk of hypertension and stroke.

### Raising Calcium Uptakes, Lowers Osteoporosis Risks

In accordance with 21 CFR 101.72, the present invention meets the following food requirements authorizing a health claim on the relationship between raising calcium uptakes, and lowering osteoporosis risks. The present invention's Lacteal Coated Pizzas contain unfortified calcium levels that exceed 20% DV per portion size, and have less phosphorous than calcium. Furthermore, Lacteal Coated Pizza's naturally-derived calcium enhances absorption/assimilation over mineral supplements. This FDA regulatory standard authorizes the following health claim: While many factors influence osteoporosis & maintaining good bone-health, by consuming Lacteal Coated Pizzas as part of a calcium-rich, healthy-diet, along with regular exercise—may reduce the risk of developing osteoporosis. Caucasian/Asian teens and/or young-adults females are at high-risk of developing osteoporosis later in life.

### Lowering Sodium Uptakes, Reduces Hypertension Risks

In accordance with 21 CFR 101.74, the present invention meets the following food requirements authorizing a health claim on the relationship between lowering sodium uptakes, and reducing the risk of hypertension. The present invention's Lacteal Coated Pizzas contain less than the disqualifying sodium thresholds per portion size. This FDA regulatory standard authorizes the following health claim: Consuming Lacteal Coated Pizzas as part of a low-sodium, healthy-diet, may reduce the risk of hypertension.

### Reducing Intake of Dietary Fat, Lowers Cancer Risks

In accordance with 21 CFR 101.73, “Dietary Fat and Cancer,” the present invention meets the following food requirements authorizing a health claim on the relationship between reducing dietary intake of fats and lowering cancer risks. Based on portion size, Lacteal Coated Pizzas contain less than the disqualifying threshold limits for lipids and saturated fats. This FDA regulatory standard authorizes the following health claim: Consuming Lacteal Coated Pizzas as part of a lowfat, healthy-diet may lower the risk of certain types of cancers.

### Reducing Saturated Fat & Cholesterol, Lowers CHD Risks

In accordance with 21 CFR 101.75, the present invention meets the following food requirements authorizing a health claim on the relationship between reducing the intake of dietary saturated fats & cholesterol and lowering coronary heart disease (CHD) risk. The present invention's Lacteal Coated Pizzas are low in total fats, saturated fats, and cholesterol. This FDA regulatory standard authorizes the following health claims: While there are many factors influencing heart disease, consuming Lacteal Coated Pizzas as part of a healthy-diet that is low in total fats, saturated fats, and cholesterol—may lower the risk of coronary heart disease.

### Dietary Fiber-Containing Grains, Vegetables & Fruits, Lowers Cancer Risks

In accordance with 21 CFR 101.76, the present invention meets the following food requirements authorizing a health claim on the relationship between increasing intake of dietary-fiber containing grain products, vegetables & fruits food products and lowering cancer risks. Based on portion size, Lacteal Coated Pizzas contain a minimum of 10% DV, unfortified, dietary-fiber-containing grains, vegetables, and/or fruits. This FDA regulatory standard authorizes the following health claim: Consuming Lacteal Coated Pizzas as part of a healthy-diet, rich in fiber-containing grains, vegetables, and fruits, may reduce the risks of certain cancers.

### Dietary & Soluble-fiber containing Grains, Vegetables, Lowers CHD Risks

In accordance with 21 CFR 101.77, the present invention meets the following food requirements authorizing a health claim on the relationship between increased consumption of dietary & soluble-fiber containing grains, vegetables, & fruits and lowered CHD risks. Lacteal Coated Pizzas are low in fats, saturated fats, & cholesterol, and contain 0.6 g soluble-fiber content that is derived from fiber-rich grains, fruits, or vegetables, without fortification. This FDA regulatory standard authorizes the following health claim: Consuming Lacteal Coated Pizzas as part of a lowfat, healthy-diet, rich in soluble fiber-containing grains, vegetables & fruits, while low in saturated fats & cholesterol—may lower heart disease risks.

### Increased Dietary Vegetables & Fruits, Lowers Cancer Risks

In accordance with 21 CFR 101.78, the present invention meets the following food requirements authorizing a health claim on the relationship between increasing dietary intake of vegetables & fruits, and lowering cancer risks. Based on portion size, Lacteal Coated Pizzas are low in fats, saturated fats, & cholesterol, contain 0.6 g dietary fiber, and 10% DV of Vitamins A & C (without fortification). This FDA regulatory standard authorizes the following health claim: Consuming Lacteal Coated Pizzas as part of a lowfat, healthy-diet, rich in dietary fiber-containing vegetables & fruits, may lower cancer risks.

### Increasing Folate Uptakes, Lowers Neural Tube Defects

In accordance with 21 CFR 101.79, “Folate & Neural Tube Defects,” the present invention meets the following food requirements authorizing a health claim on the relationship between increased folate uptake, reduces the incidence of neural tube defects. The present invention's Lacteal Coated Pizzas contains over 0.04 mg of folate per referenced amount, which is derived from non-fortified food sources. This FDA regulatory standard authorizes a health claim. This FDA regulatory standard authorizes the following health claim: Consuming Lacteal Coated Pizzas as part of a healthy-diet that is rich in non-fortified, naturally occurring folate may reduce a woman's risk of having a child with a brain or spinal cord defect.

### Substituting Dietary Sugar Alcohols, Lowers Dental Caries

The present invention's Lacteal Coated Pizzas in accordance with 21 CFR 101.80, meets the following food requirements authorizing a health claim on the relationship between sugar-alcohols used as “sucrose-product substitute” resulting in lowering the incidence of tooth decay. The present invention's sugar-free Lacteal Coated Pizzas can be alternatively be prepared as sugar alcohols derived from xylitol, sorbitol, mannitol, maltitol, isomalt, lactitol, hydrogenated-starch-hydrolysates, hydrogenated-glucose syrups or erythritol, wherein the fermentable carbohydrate-containing foods shall have an pH ≧5.7 acidity level. This FDA regulatory standard authorizes the following health claim: The sugar alcohols contained in sugar-free Lacteal Coated Pizzas do not promote dental caries (tooth decay), as can occur from frequently consuming starchy, sugary foods in between-meals.

### Increasing Dietary Soy Protein, Lowers CHD Risks

The present invention's Lacteal Coated Pizzas can optionally be prepared to comply with federal regulations 21 CFR 101.82, authorizing a health claim on the relationship between the consumption of soy protein and the risk of coronary heart disease. The present invention's soy-containing Lacteal Coated Pizzas (as shown in the embodiments) are low in total fats, saturated fats (excluding inclusion of soy fat in calculating total fats), & cholesterol, which 6.25 g soy protein per referenced amount. This FDA regulatory standard authorizes the following health claim: Consuming soy-protein containing Lacteal Coated Pizzas as part of a healthy-diet that is low in saturated fats and cholesterol may help to reduce the risk of heart disease.

### Increasing Dietary Plant Sterol Esters or Plant Stanol Esters, Lowers CHD Risks

The present invention's Lacteal Coated Pizzas can easily be prepared to comply with federal regulations 21 CFR 101.83, authorizing a health claim on consuming Sterol/Stanol Esters and lowering the risk of coronary heart disease (CHD). The present invention's plant sterol esters/plant stanol esters-containing Lacteal Coated Pizzas (as shown in the embodiments) are low in saturated fats and cholesterol, and be optionally be prepared with 0.65 g of sterol/stanol oils. This FDA regulatory standard authorizes the following health claims: While heart disease is related to many factors, consuming Lacteal Coated Pizzas as part of a healthy-diet that is low in saturated fats & cholesterol, which provides a daily total of 7.3 g of plant sterol ester-containing oils that are eaten over two meals, may reduce the risk of heart disease. While, heart disease is related to many factors, consuming Lacteal Coated Pizzas as part of a healthy-diet that is low in saturated fats and cholesterol which a daily total of 3.4 grams of plant stanol esters eaten over two meals, may help to reduce the risk of heart disease.

### Increasing Soluble-Fiber Containing Foods & Lowers CHD Risks

The present invention complies with federal regulations 21 CFR 101.81—“Soluble-Fiber from certain Foods & Risk of Coronary Heart Disease.” Based on portion size, Lacteal Coated Pizzas meet the following food requirements: low in total fats, saturated fat & cholesterol, and contain easily be prepared with one (1) or more of the following soluble-fibers sources: 0.75 g whole-oats soluble-fiber; 1.7 g psyllium-seed husk soluble-fiber; 4.0% rolled-oats (oatmeal) beta-glucan soluble-fiber; whole oat flour containing 4% beta-glucan soluble fiber or psyllium husk with purity of no less than 95%; 5.5% beta-glucan soluble-fiber from oat-bran; 10% beta-glucan (dwb) soluble-fiber derived from alpha-amylase hydrolyzed from oat-bran or whole-oat flours; 5.5% beta-glucan soluble fiber derived from barley, and oatrim soluble fiber from amylase-hydrolyzed whole oat-flour, or oat-bran. This FDA regulatory standard authorizes the following health claim: Consuming Lacteal Coated Pizzas as part of a healthy-diet that is rich in whole-grain foods and other plant foods, while low in saturated fats & cholesterol, may help to reduce the risk of heart disease.

### DETAILED DESCRIPTION OF THE INVENTION

Lacteal Coated Pizzas are delicious, nutritious, all-in-one-meals that outperform prior art in the areas of taste, nutritive value, enhanced performance, product diversity, dietary-health, and global sustainability. Lacteal Coated Pizzas are typically comprised of conventional flatten dough/sourdough, coated with the present invention's Lacteal Batters, and preferably covered with a topping product (e.g. shredded cheeses). By replacing tomato-paste with the present invention's Lacteal Batters, Lacteal Coated Pizzas have significantly more protein, vitamins, & minerals, while less sodium and acidity.

Lacteal Coated Pizzas can be deliciously prepared using readily available, all natural, GRAS ingredients, and/or alternatively, incorporate a variety of food technologies that further extend its product applications. For example, in order to thicken and stabilize the batter, hydrocolloidal vegetable gums can be used in lieu of starch (as shown in the preferred embodiment).

The present invention's Lacteal Batters are proteineous-hydrocolloidal mixtures that are characterized as semi-solid, viscous-flowing diary products. The Lacteal Batters are nutrient-dense amalgamations of denatured, agglomerated casein micelles; nonfat solid milk fractions; lipid-in-starch emulsions; soluble-fibers, and vegetable matter. These mixtures have unique performance-enhancing, rheological properties that bind, absorb, and release moisture through temperature-sensitive pores.

Tomato-paste coated pies have had a four-hundred year reign over the pizza industry. To date, the pizza industry has not marketed any diverse, alternative topping sauces, which remotely resemble the present invention's Lacteal Batters. Heretofore, what has been overlooked is tomato paste's functional, structural, and compositional role as the middle component of a three-layer food.

More particularly, the pizza industry did not consider tomato-paste's high sodium content, nor its poor moisture regulating properties, as justifications for its replacement. Firstly, what was not understood was that tomato paste's poor moisture regulation, stemming from its lack of moisture-retention and its loss of free-unbound moisture, are fundamental structural defects that warrant major compositional changes. Secondly, the pizza industry overlooked the need for replacing tomato paste with a more nutritious, lower sodium layer. Consequently, there has been no similar marketed pizza topping sauces.

The present invention's novel water-binding characteristics improve product performance at all stages, while lowering its demand for lipids and sodium. The present invention's Lacteal Batters elicit a creamy, smooth rich texture, and mouthfeel/roll that is absent in other prior-art pizzas. Unlike prior art, Lacteal Coated Pizzas do not rely on livestock toppings to improve its product performance. Most importantly, Lacteal Coated Pizzas resolve the high sodium and fat levels that plague prior art pizzas.

### Dietary-Health Perspective

Tables 1-6 show that prior art pizzas routinely contain high fats, sodium, and calories levels that frequently approach/exceed daily-allowances. A major-factor behind the diet-disease epidemic is that the reduced-caloric demand associated with sedentary lifestyles call for consuming nutrient-dense, low-energy foods to avoid gluttony. By comparison, ethnic (Italian) pizzas are high-energy, nutrient-poor foods that are associated with escalating the occurrence of dietary-disease, most notably overweight/obesity, hyperlipidemia, hypertension, CVD, and CHD (USDA-ERS, 2001). These dietary-health deficiencies underscore public need for tasty, healthy, thrifty Lacteal Coated Pizzas.

Contrastingly, Lacteal Batters are easily assimilated by lactose-intolerant consumers (malabsorbers), which makeup 70% of the world population. Lacteal Coated Pizzas are soft foods that are easily chewed, digested, and assimilated. These are important attributes for a wide range of populations, particularly those with chewing, or dysphagia (swallowing) type-disorders.

Lacteal Coated Pizzas use less cheese toppings than regular pizzas, to create a delightfully cheesy-flavors. By containing considerably less fatty acids, saturated fats, sodium, cholesterol, and calories than ethnic (Italian) pizzas, Lacteal Coated Pizzas reduce consumers' dietary-health risks.

### Nutritive Value

Pizzas are an important American dietary-staple that were rated the 2^{nd} most popular dinner-entrée inside/outside the home (NPD Foodworld, 2000-01). Given its consumption frequency, ethnic (Italian) pizzas are part of a vexing dietary-pattern plaguing western-industrialized nations, (USDA-ERS, 2003). As shown in Tables 1-6, fatty, salty, caloric pizzas are rampant throughout the industry, despite the numerous dietetic constituents that have been developed (e.g. lowfat/nonfat cheeses, reduced carbohydrates).

The crux of the issue is that the lowering of sodium and fat levels in prior art pizza significantly compromises product-performance, taste, texture, and aroma. Americans are averse to swapping taste over dietary-health/nutrition, which are major-drivers influencing consumer pizza selections (Decision Analysis, Inc., 2003). Accordingly, pizza-makers are unwilling to jettison product sales over lowering fats and sodium constituents. Consequently, ethnic (Italian) pizzas retain irresolvably high-dietary fats, sodium, & calories levels that are associated with promoting gluttony, and poor dietary-health/nutrition in America (USDA-ERS, 2001). Furthermore, ethnic (Italian) pizzas have a similar derisive public-health impact on other western industrialized nations (WHO, 2001).

Conversely, as shown in Table 16, Lacteal Coated Pizzas reconcile prior-art's dietary health/nutritive deficiencies with its perfectly balanced protein, carbohydrate, and fat ratios. These wholly new, nutrient-dense composite foods have far lower calories, saturated fats, cholesterol, and sodium than ethnic (Italian) pizzas. Lacteal Coated Pizzas contain all of the non-synthesizable, essential, human amino acids for adults and childrens (i.e. isoleucine, leucine, lysine, methionine, phenylalanine, threonine, tryptophan, valine, arginine & histidine). Lacteal Coated Pizzas are rich sources of heart-healthy lipids, dietary fibers, vitamins (particularly thiamin, riboflavin, pantothenic-acid, niacin, vitamins A, B₆, B₁₂, D, E, K), and minerals (notably calcium, iron, potassium, phosphorus, iodine magnesium, zinc, selenium, copper, manganese & folate).

From a nutritive standpoint, replacing tomato-paste with the present invention's Lacteal Batters, significantly boosts Lacteal Coated Pizza's nutritive-value, lowers its sodium levels, and reduces its acidity. It also increases Lacteal Coated Pizza's rate of absorption and assimilation.

Coast-to-coast, ethnic (Italian) pizzas are the most favorite school lunch meal (NAC-ASFSA, 1997). Due to rising overweight/obesity occurrences among youth populations, many school districts either limit/restrict serving pizzas. Conversely, Lacteal Coated Pizzas make perfectly balanced, tasty, heart-healthy, all-in-one meals that would enable school districts to regularly offer them as hot-lunch items.

### Product-Performance

Lacteal Coated Pizzas resolves poor moisture regulation and high sodium content in ethnic (Italian) pizzas (i.e. tomato paste coated pizzas), which were heretofore overlooked and disregarded. The poor moisture regulating defects pertain to tomato-paste's loss of free-unbound moisture to evaporation and/or dough/topping product adsorption and its lack of moisture-retention. These compositional and functional defects were hereto disregarded and overlooked by the pizza industry.

Specifically, prior to baking, free-unbound moisture that is subjected to freeze/thaw cycling, is available to crystallize. During baking, rapid loss of moisture through evaporation, promotes inferior dough-rise, inextensibility, harder/courser crusts, and larger crumb. Following baking dehydrated pizza dough/toppings have insufficient residual moisture to sustain reheating without drying-out. At all stages of product preparation, tomato paste's inadsorbant and nonporous properties promulgate soggy dough/toppings prior to baking, reduces the product shelf-life, and causes poor reheatability. Hitherto, these functional, structural, and compositional issues were irresolvable prior-art defects. The present invention resolves these product performance issues with its Lacteal Batters.

Furthermore, slashing fats and sodium constituents to comply with dietary guidelines shown in Table 7, leads to insipid, cardboardy-tasting pizzas. These are irresolvable issues that continue to plague the pizza industry, despite the innumerable dietetic products that have been developed. Conversely, by replacing tomato-pastes with Lacteal Batters, Lacteal Coated Pizzas resolve the high dietary fats, sodium, and calorie levels routinely contained in prior art pizzas.

Hitherto, the role of the topping sauce was viewed as not much more than a pizza-dough flavoring (Mintel, 2005). Accordingly, other pizza prototypes, such as dietetic pizzas exhibit yet more product defects than ethnic (Italian) pizzas, such as poor-moisture regulating properties, poor nutritive value, bittery-rubbery tastes, and loss of mouthfeel/roll due to a lack of lubricity (fats). These taste/textual defects yield insipid, cardboardy-tasting pizzas of poor nutritive value. Conversely, the present invention's smooth, rich, creamy Lacteal Batters resolve these prior art's tastes/textural defects.

Altering the colligative properties in prior art pizzas is achieved by increasing the fats and sodium levels in tomato paste. The altered properties improve tomato-paste's moisture regulating characteristics by increasing solute-molar concentrations and molecular weight. More specifically, increasing fats and sodium improves product performance by raising the boiling point elevation, lowering the freezing point depression, and increasing the osmotic pressure gradients.

### Environmental/Global Sustainability

Increased livestock consumption over the past 30 years, parallels the epidemic rise in dietary diseases (FAOSTAT, 2003). Since ethnic (Italian) pizzas are frequently topped with fatty-meats, their increased consumption is now routinely cited as a contributing factor to the endemic increase of obese/overweight populations, particularly in western industrialized nations. Furthermore, the escalating fatty meat production has a damaging present/future environmental impact on global sustainability (Joint Council WHO/UN, 2003). Lacteal Coated Pizzas supply a high-percentage of consumers' daily protein, vitamins, and mineral needs. Consequently, by reducing consumer demand for livestock products, the present invention's Lacteal Coated Pizzas pose less environmental impacts, and improve the public health outlook.

### Unobvious Prior-Art Defects

Until now, the flaws and limitations of tomato-containing topping sauces were overlooked or disregarded, for several important reasons. Marketing an alternative middle-layer component, like the present invention's Lacteal Batters, would lower tomato paste suppliers' profits. Tomato paste coated pizzas enjoy worldwide popularity, unchallenged by any other pizza prototypes. Ethnic (Italian) pizzas popularity is further enhanced tomato paste's media-driven, healthy-food image. Thus, prior art defects pertaining to product performance, structure/function, composition, dietary-health/nutritional aspects, public health, present/future environmental impacts, and global sustainability, were overlooked and/or disregarded. Conversely, the pizza industry has focused their attentions on modifying the dough/topping products, while discounting tomato paste's role as not much more than dough-flavoring (Mintel, 2005).

### Lacteal Coated Pizzas & Lacteal Batters Outpace Prior-Art

Heretofore, there have been no-other publicized, and/or marketed products similar to the present invention's Lacteal Coated Pizzas. These present inventions offer many important advantages over prior-art. Lacteal Coated Pizzas have far lower fats and sodium levels than ethnic (Italian) pizzas. Fermented milk-containing Lacteal Coated Pizzas have a longer shelf life, enhanced nutritive value, and improved digestibility. Lacteal Coated Pizzas are perfectly balanced, all-in-one meals of superior dietary-health/nutritional value that are easily chewed, digested, and assimilated. Very importantly, Lacteal Coated Pizzas are environmentally-friendly processed foods that can be economically produced using common manufacturing equipment, and widely available GRAS ingredients.

Replacing tomato-paste topping sauces with the present invention's Lacteal Batters, enhances baking-performance. During baking, the slow moisture precipitation of Lacteal Coated Pizzas, improves its dough/topping hydration, amplifies its dough-rise, increases its extensibility, reduces its crumb, and softens its crust. Following baking, Lacteal Coated Pizzas retain sufficient moisture to preserve product-freshness, and tolerate reheating without drying out.

By contrast, prior-art pizzas are good only when freshly baked, exhibit limited shelf life, and poor-reheatabilty. Prior-art pizzas are high-energy, nutrient-poor foods that derisively affect dietary public health. Fatty, salty, caloric pizzas are ubiquitous throughout the pizza industry due to reducing the fat and sodium constituents, compromises product performance, taste, texture, and aroma.

### Lacteal Batter's Biochemical Composition

The preferred embodiment's Lacteal Batters are heat-stable, blendable mixes that have excellent bioavailability, aid lactose digestibility, and contain slow-digesting amino acids. The preferred embodiment's lipid-in-starch mixture improves taste, texture, and mouthfeel. The hydrophilic micelluar structure entraps moisture in its temperature-sensitive, shallow absorbent pores. The porous batter forms a protein-film that minimizes the moisture loss through evaporation, and/or topping product absorption. The water-binding characteristics preserve product freshness, diminish dehydration, lessen premature spoilage, and reduce the rate of batter crystallization.

At the very minimum, the preferred embodiment's Lacteal Batters shall contain denatured, agglomerated milk products, and a lipid-in-starch mixture. The latter constituents are used for enhanced mouthfeel, thermal-stability, and to thicken/stabilize the batter. To form the lipid-in-starch mixture, the preferred embodiment combines starch (i.e. derived from wheat flour) and fats in a rous-like manner. Besides starch, as shown in the embodiments, other types of thickening/stabilizing agents can be alternatively be used, such as hydrocolloidal vegetable gums. The other constituents that are added to the preferred embodiment's Lacteal Batters improve its taste, texture, and nutritive value. These added constituent include fermented-milk products, vegetable matter, NSF (nonfat solid fractions such as whey protein concentrate, casein protein isolates, and vital wheat gluten), and flavorings.

From the onset, the present invention's Lacteal Batters were developed to resolve prior art's high sodium and acidity levels. What was unapparent from its inception was that the preferred embodiment's Lacteal Batters enhances product performance and resolves prior art's poor moisture regulating properties, by relying on temperature-sensitive hydrophobic pores to provide slow hydration precipitation.

Cow milk typically contains 87.3% water (in the range of 85.5-88.7%), 8.8% solids-not-fat (in the range of 7.9-10.0%), 4.6-5.2% lactose, 3.9% milk fat (in the range of 2.4-5.5%), 3.25% proteins (79.5% caseins, 19.3% whey & 6% non-nitrogen), 0.65% minerals (Ca, P, Mg, K, Na, Zn, Cl, Fe, Cu, sulfate & bicarbonate), 0.18% acids (citrate, formate, acetate, lactate & oxalate), vitamins (A, C, D, thiamine & riboflavin), enzymes (peroxidase, catalase, phosphatase & lipase), oxygen, and nitrogen gases.

The present invention's Lacteal Batters have a casein micelluar microstructure that is developed by prolonged heat of 85° C. (185° F.), in combination with increased acidity, ranging from pH 4-4.6 (isoelectric point). Due to having little secondary-structure, and no tertiary-structure or disulphide bridges, the caseins micelles have a propensity for heat agglomeration. These casein micelles contain a majority of the casein proteins, 90% of insoluble liquid calcium-phosphates (CaP), citrates, minor-ions, lipases, plasmin enzymes, and entrapped whey. Due to calcium-ion binding, casein micelles exhibit hydrophobic interactions along its inner surfaces.

At the biochemical level, caseins are predominantly phosphoproteins (protein groups that are bonded to a phosphoric-acid containing substances), which have many noninteractive proline peptides. It is well known that caseins are conjugated proteins that have esterified phosphate groups with serine residues, where by the casein calcium binding is proportional to its phosphate constituents. The casein proteins typically contain 31% alpha-s1 casein (binds calcium strongly, plasmin protease resistant, natural milk), 8% alpha-s2 casein (binds calcium strongly), 28% beta-casein (partially cold-water soluble in cold plasmin colligation), and 10% kappa-casein (whey bonding at ultra high temperature is colligation resistant).

The casein micelles also contain entrapped milk serum (also known as whey), which constitute about 6-12% by milk volume. Whey proteins are more water soluble than casein proteins, and will denature at lower temperatures of 70° C. (158° F.) at pH 4.6 (isoelectric threshold). At these elevated temperatures along with demineralization, and increased acidity, milk serum precipitates whey proteins, lactose, vitamins, minerals, and traces of fats. Denatured whey proteins have increased water-holding capacity due its well-defined, three-dimensional, globular-microstructure.

The outer surfaces of caseins in micelles have hydrophilic interactions that resemble surfactant-type micelles. The hydrophobic submicelle cores contain the following constituents: calcium phosphates which are coated with very hydrophilic kappa-casein polar moieties, beta-lactoglobulin (casein reactive at temperatures at temperatures over 65° C.), 15% alpha-lactalbumin (a chief component of breast milk), 6% immunoglobulins (casein anti-coagulants that bond with kappa-caseins @UHT), 4% bovine serum albumins (heat-sensitive proteins), 14% heat-stable proteins (which are unrecoverable by heat-acid precipitation), and 21% non-protein nitrogen that consist of amino acids, ammonia, urea, and minute peptides (which in large enough quantity can cause some taste/textural defects).

In the initial stages of the Lacteal Batter's product preparation, the milk constituents are subjected to conditions of elevated temperatures, acidification, and decalcification. Next, denatured casein proteins aggregate to form agglomerated casein micelles, which have hydrophobic molecules that precipitate moisture. Followed by aggregated, denatured caseins and whey proteins form short-branched noncolligative kappa-caseins and immuno-lactoglobulin (whey proteins) complexes on micelluar surfaces. As the Lacteal Batter's acidity levels are increased, native calcium and phosphorus minerals contained in the casein micelles, gradually become more soluble in the aqueous phase. Acidification to a pH 4.6 (isoelectric point) causes the casein micelles to destabilize or aggregate due to entropically driven hydrophobic interactions. Denatured, disintegrated casein micelles precipitate casein proteins, and other by-products.

During the secondary stages of the Lacteal Batter's product preparation, at a pH 4.6 (isoelectric point), the caseins micelles aggregate due to the kappa-casein loss of steric repulsion. Precipitating calcium acts as a micelle bridge to assist coagulation. During this process, the mix holding temperatures are crucial to increasing the hydrophobic reactions, and its moisture binding capacity.

During the tertiary stages of the Lacteal Batter's product preparation, the mixtures form a curd, and if left to progress will exhibit syneresis when the casein micelluar globules form paracasein-type gels. Caseins split up from the whey proteins at acid precipitation of pH 4.6. Shorter casein particle chains are created by adding 12.5%, 20%, and 30% total milk solids from milk powders, whey powders, milk protein concentrates, whey protein concentrates, or sodium caseinates. This results in increased protein density and decreased pore sizes.

Several important comments regarding how the casein micelle stability is influenced by surface interactions, chemical interactions, and temperature.

Firstly, the micelle stability is affected by the kappa-casein outer density and surface reactivity.

Secondly, micelle stability is greatly affected by the increased acidity pH 4.6 (isoelectric point), which promotes caseins precipitation, and leads to a dissolution of colloidal calcium phosphate binding (dissolving phosphate). Casein micelles contain 90% of the calcium content, which bind the micelle together. Reduced acidity causes reversible dissociation of beta-casein without micelluar disintegration accompanied by calcium Ca++ removal. Conversely, adding calcium increases micelluar aggregation. The addition/loss of calcium phosphate and salt, affects the casein micelluar stability and retaining of entrapped serum (whey) quantity of serum.

Thirdly, casein micelluar stability varies with temperature, wherein hydrophobic proteins are very temperature sensitive, and undergo thermal-induced changes. Micelluar disassociation of beta-casein at 4° C. (39° F.) causes micelluar aggregation to occur at temperatures of 0° C. (32° F.). Freezing produces a precipitate called cryo-casein. Alternatively, heat treatment alters micelluar behavior by increasing whey protein absorption. Furthermore, two (2) or more of these factors have an additive effect on micelluar stability.

### Wheat Flour

The preferred embodiment shows that wheat flour is contained in the dough and batter of the present invention's Lacteal Coated Pizzas. The wheat contained in dough/sourdough products is prepared in a conventional manner. However, the preferred embodiment's Lacteal Batter is prepared with a nonconventional lipid-in-starch mixture that functions to thicken/stabilize the present mixture, as later enumerated. The preferred embodiment's Lacteal Batters accomplish emulsion stability by the manner of adding the lipid-in-starch, along with the process of preparing the mixture.

The starch product used in the preferred embodiment's Lacteal Batters, are derived from wheat flour. The primary advantage of using a starch-based thickener/stabilizer is that milled wheat flour is safe, economical, and abundantly available worldwide. During the preferred embodiment product preparation, the present invention's Lacteal Batters contain starch-coated lipids that become entrapped in casein micelluar microstructure. From a combination of prolonged heat 85° C. (185° F.), and pH 4-4.6 acidity, the starch coated lipids solubizes to release the entrapped butter/oil.

Wheat flour belongs to the genus triticum of the family gramineae, and it is comprised of amylose & amylopectin polysaccharides that are joined in a head-to-tail conformation forming alpha-1,4 linkages of glucose monomers. Compared to amylopectin, amylose form linear chains with an alpha-1,6 linkages at every 24-30 glucose monomer units. Starch polymer chains typically contain around 2,500 glucose molecules. The ratio of amylose to amylopectin not only varies by species, but also by different cultivars of the same type of species.

During heating, sulphydryl-disulphide interactions are formed by the cross-linking gluten networks. Mechanically kneading-paddling confers good structural development of the dough by realigning gliadin and glutenin protein fractions.

During leavening, the fermenting yeast releases maltase (derived from barley grains), and disaccharides (derived from wheat grains) into carbon dioxides (gas retention), and ethanol (alcohols), which gives wheat product its characteristic rise, flavor, and aroma. During searing, residual saccharides react with amino acids (e.g. amino-carbonyl) to form browning (Maillard reaction).

### Preferred Embodiments—Cheese Lacteal Coated Pizzas

By using abundantly available, common ingredients, Lacteal Coated Pizzas offer superior nutrition, taste and dietary-health/nutrition. Oven-baked, Cheese Lacteal Coated Pizzas appeal to all of the senses with its delicious, quintessential, molten-fused qualities that impart an orchestra of flavorful tastes, and piquant aromas. The preferred embodiment's Cheese Lacteal Coated Pizzas are mouth-watering blends of molten shredded cheeses, aromatic garlic, robust herbs, & spices, spread over sizzling Lacteal Batters, and soft raised dough.

The preferred embodiment's compositions and processes are presented in the following sections: Stage 1—Dough; Stage 2—Lacteal Batters; Stage 3—Product Assembly; Stage 4—Cooking; Stage 5—Packaging; Stage 6—Nutritional Labeling. The text descriptions is facilitated by Tables 8-16, which show the ingredient quantities, nutrients, composition percent ranges, product assembly, and cooking temperatures among other details. More specifically, the preferred embodiment is shown in Tables 8, 11, 13, 14 & 15, where as Tables 9 & 10 identify additional ingredients that may be optionally added. The constituents and preparations processes comply with the FDA, 21CFR, Subsection B—Food for Human Consumption.

TABLE 8
Preferred Embodiments

| Lacteal Coated Pizza ™ | % of Total |
|---|---|
| Yogurt-containing Lacteal Batter, topped with shredded lowfat cheddar, | Product |
| mozzarella, and lowfat Swiss cheeses, with a 1.3 crust/batter ratio. | Weight |
| Stage 1 - Crust (ingredient composition in baker's percents of 100% of flour): | |
| 100% Enriched flour mix: 51% whole grain flour, NDB #20080; 49% | 25% |
| whole wheat NDB #20641; malted barley; | |
| 55% Water - NDB #14429; | 14% |
| 3% Safflower oil - NDB #04511; | 1% |
| 2% Salt composition; | .4% |
| 2% Leavening agents, active bakers yeast, NDB #18375; | .4% |
| Stage 1 - Subtotal (precooked): | 41% |
| Stage 2 - Lacteal Batter: | |
| 7% Enriched, unbleached whole wheat flours: 15% protein - NDB | 2% |
| #20645; | |
| 48% Nonfat fluid milk, with vitamin A - NDB #01085; | 16% |
| 17% Nonfat yogurt - NDB #01118; | 6% |
| 1.8% Butter, without salt - NDB #01145; | 1% |
| 2% Lipid mixture: blended canola oil, safflower oil & mixed vegetable oil | 1% |
| (NDB #04678, NDB #04670, NDB #04511); | |
| 3% Spices, garlic powder - NDB #02020; | 1% |
| 1% Salt composition; | 0.3% |
| 3% Onions, dehydrated flakes - NDB #11284; | 1% |
| 3% Spices, pepper, black; | 1% |
| 9% Raw cabbage - NDB #11109; | 3% |
| 3% Nonfat dry milk, without added vitamin A - NDB #01091; | 1% |
| 3% Spices, dried parsley - NDB #02029; | 1% |
| Stage 2 Subtotal Weight (precooked): | 34% |
| Stage 3 - Toppings: | |
| 93% Combination of shredded LF cheddar, LF Swiss & mozzarella (part | 24% |
| skim milk): NDB #01028; NDB #43589; NDB #01168; | |
| 7% Spices, parsley, dried NDB #02029; | 1% |
| Stage 3 - Subtotal (precooked): | 25% |
| Total | 100% |

### Stage 1—Lacteal Coated Pizzas Dough Composition & Preparation:

The crust composition, as shown in Tables 8 & 9, shall be preferably prepared in the following conventional manner (or its equivalent). Thoroughly mixes wet and dry ingredients. Inoculate the dough with a symbiotic microbial blend of yeast using active lyophilized (freeze-dried), frozen, liquid, and/or spray-dried yeast cultures (adding lactic-acid producing microbial cultures for sourdoughs). Incubate and proof the dough under quiescent conditions. Knock back down the dough during a second kneading & paddling cycle, adjusting the dough consistency by adding flour, and/or water as needed. Continue to incubate and proof the dough until the volume increases to about 1½ to 2 times its initial size. Followed next by mechanically kneading the dough while forming the crust, along with adding water and flour as added to achieve a smooth, supple finished dough product.

The breadlike crust shall contain at least a quantity of flour, water, lipid mixture, salt composition, and a raising agent, although it may contain many other constituents as shown in Table 9.

The preferred grain products are wheat flours that provide good structure, extensibility, gas retention, and nutrition. The preferred flours are high-gluten wheat flours that have good milling & baking properties, contain malted barley flour, and are fortified with thiamine, mononitrate, riboflavin, niacin, folic acid, & iron.

The preferred gluten content typically varies with the crust thickness. For example, the preferred wheat flours for thin-crusted—Lacteal Coated Pizzas, are hard red spring (HRS) wheats, with subclasses that include dark northern-spring, northern-spring, and red-spring wheat flours that typically contain 13-14% protein. Alternatively, the preferred wheat flours for medium-crusted—Lacteal Coated Pizzas are fall-seeded, hard-red winter wheat flours that typically contain 11-12% protein. Optionally, the preferred wheat flours for deep-dish/stuff-crusted Lacteal Coated Pizzas are 10% protein-type wheat flours, such as soft-white wheat flours of subclasses of soft-white, white-club & western-white wheat flour; soft red winter wheat flour (fall-seeded); or hard-white wheat flour. Furthermore, as shown in the embodiments, the dough protein content can be radically increased by adding nonfat solids such as casein protein concentrate, vital wheat gluten, soy proteins isolates, whey protein isolates, among others.

TABLE 9
Lacteal Coated Pizza Dough - Composition Percent Range

| | Quantity Percentage Range, |
|---|---|
| | Prorated in |
| Dough Ingredients (based on 100% of flour) | Bakers' Percents³ |
| Flour products (multitude of flour types may | 100% |
| alternatively be used). | |
| Water (preferably filtered water). | 40–65% |
| Lipid mixture² (multitude of oil/butter types | .5–9% |
| including fat-replacement & extenders). | |
| Salt composition. | .5–4% |
| Raising Agents: yeast & other leavening | .5–5% |
| constituents. | |
| Milk composition (optionally added, may be | 0–10% |
| derived from non-fat milk solids, fresh fluid | |
| milk, condensed, concentrated, and/or | |
| recombined milk sources). | |
| Nondairy ingredients (optional). | 0–10% |
| Vegetables constituents (optional). | 0–10% |
| Sweeteners (optional). | 0–10% |
| Eggs (optional). | 0–5% |
| Flavorings/spices (optional)¹ | 0–15% |
| Additives (optional)² | 0–15% |

Footnotes:
¹Flavorings/spice, and the colorings may optionally be including, along with cheeses, butter, herbs & seeds, cured meats, oils, starter cultures (sourdough), special flours & meals, and such forth.
²Additives further added include protein supplements (e.g. vital wheat gluten, whey), milk replacers, fermentation enhancers (e.g. yeast foods & water conditioners); fermentation enhancers (e.g. amylase enzymes & malt products; gluten relaxers (e.g. protease enzymes & reducing agents); gluten strengtheners (e.g. oxidizing agents & dough strengtheners); surfactants; hydrocolloidal gums for stabilizing; fat relacements & fat extenders; mold inhibitors (preservatives), among others
³The percentages vary with many factors such as retained moisture, water mineralization, dough fermentation temperatures, ambient air temperature, retarding (holding) duration, processing methods, and such forth, which require quantity adjustments commonly performed by those skilled in the culinary arts.

Table 9 shows the compositional variations for improving the product taste, texture, and nutritive content. These mix variations require trial batching with due considerations for environmental factors, residual moisture, mineral content, flour oxidation, residual moisture, altitude, and processing variables.

### Stage 2a—Lacteal Batter Composition & Preparation:

The preferred embodiment's Lacteal Batters were developed from countless trial batches over fifteen (15) years duration. Compared with other types of thickening/stabilizing emulsifiers, the preferred embodiment's “lipid-in-starch” paste has the distinct advantages of being a delicious, nutritious, environmentally-friendly mixture that is thriftily comprised of abundantly-available flour and lipid constituents. This paste thickens the batter mix, provides emulsion stability, and adds mouthfeel without resorting to more highly processed, costly constituents (e.g. hydrocolloidal gums).

As shown in Table 10, the present invention's Lacteal Batters may optionally include varying percents of other constituents. Moreover, Table 10, shows that the present invention's Lacteal Batters shall contain 51-80% milk composition, 0.2-10% thickener/stabilizer, and 0.5-10% lipid mixture along with other constituents, which are added largely for taste, texture, and nutritive value.

The composition of the preferred embodiment's Lacteal Batter is shown in Table 8, and its nutrients analysis is identified in Table 11. In accordance with the composition shown in Table 8, the preferred embodiment's Lacteal Batters shall be preferably prepared as follows:

Firstly, a “lipid-in-starch” paste is preferably prepared by dispensing a quantity of lipids into a paste mixer. Rotate and heat the lipids to a preferred temperature range of 57-63° C. (135-145° F.). Slowly dispensing a quantity of flour, while continuously rotating, paddling, and blending the flour solute into the lipid solvent, while holding a preferred temperature threshold of 56-60° C. (133-140° F.). The mixture is continuously rotated, paddled, and vibrated until the onset of gelanization (clumping), accompanied by slight browning. The “lipid-in-starch paste” is now ready to be combined with the “denatured lacteal amalgamation” that is prepared in the next step.

TABLE 10
Lacteal Batter - Composition Percent Range

| | Percentage |
|---|---|
| | Range of |
| | Batter |
| Ingredients | Weight |
| Milk composition ranges from at least 51% to about 80% | 51–80% |
| by batter weight preferably comprised of 70–100% fluid | |
| milk by total milk weight, and optionally containing the | |
| following constituents in the range of about 0–30% by milk | |
| weight: | |
| Fermented milk products: optionally added in the range | |
| of 0–30% by milk weight, preferably comprised of | |
| nonfat yogurt; | |
| Concentrated milk powders: optionally added in the | |
| range of 0–30% by milk weight, preferably comprised of | |
| nonfat dry milk; such as whey, caseinattes, hydrolsates. | |
| Thickener/stabilizers | 0.2–10% |
| Lipid mixture | 0.5–10% |
| Vegetable constituents | 2–20% |
| Nondairy ingredients (e.g. vital wheat gluten, soy proteins, | 0–10% |
| protein hydrolsates, or other value-added products). | |
| Flavorings/spices | 2–15% |
| Salt composition | 0.5–5% |
| Additives (optional) | 0–10% |

Secondly, the “denatured lacteal amalgamation” is preferably prepared by dispensing a quantity of fluid milk (which has been previously pasteurized, standardized, homogenized, fortified, & clarified to the desired fat content) to a mixer, and then bringing the fluid milk to a preferred temperature range of 70-85° C. (158-185° F.). Dispensing and blending a quantity of salt composition, minuscule flavorings, minced vegetable matter, and other constituents as shown in Table 8. Dispensing and blending the aforementioned lipid-in-starch paste into the mixture. Paddling and rotating the amalgamation until it's fully blended.

Thirdly, preferably dispensing and blending a fermented-milk product (refer to Stage 2b) at a temperature consistent with the desired post processing & packaging methodologies shown in Stage 5. The mixture is then homogenized at a preferred centrifugal pressure of 13.8-17.2 mPa (2000-2500 psi).

Fourthly, the Lacteal Batter is moved to chilled or frozen storage, until later used in Stage 3. The cream-colored, low-viscous mixture is then cooled to a preferred temperature range of 2-7° C. (35-45° F.). Alternatively, prior to moving the mixture to chilled storage, the present invention's Lacteal Batters may be pasteurized for use as an ultra high temperature (UHT) packaged product, or as an aseptically-packaged mix. Aseptic or UHT type packaging require the aforementioned additional post-processing pasteurizing in order to lethally terminate any potentially biologically active microbes for 30 minutes at 69° C. (156° F.); 25 seconds at 80° C. (176° F.); 16 seconds at 83° C. (181° F.) or similar time-temperature durations.

### Stage 2b—Fermented Milk Products Contained in the Lacteal Batters:

The following product preparation is for the fermented milk products that are added to the preferred embodiment's Lacteal Batter composition shown in Tables 8 & 11.

The present invention's Lacteal Batters shall preferably contain conventionally fermented milk products, prepared in the following customary manner. Specifically, defect-free fluid milk is conveyed to the mixer tank for standardization, clarification, and separation to the desired fat content. Defect-free fluid milk products have a low bacteria count, and are free of antibiotics, sanitizing chemicals, mastitis milk, colostrums, bacteriofage contamination, or rancid milk. To enhance viscosity, yield, nutritive value and protein content, nonfat solid milk fractions (e.g. casein protein concentrates, whey proteins) are optionally added in the form of prehydrated spray-dried powders, concentrates or liquids, within a preferred range of 10-30% by batter weight. The tank contents are then agitated under a vibratory load, rotated, and paddled until fully blended. The milk products are then pasteurized, preferably in a stainless steel continuous plate heat exchanger for 30 minutes @85° C., 10 minutes @95° C., or similar time-temperature duration.

Next, the mixture is inoculated, preferably with a symbiotic blend of lyophilized (freeze-dried), frozen, or spray-dried starter cultures in the preferred range of 3-5% by total volume, at a 1:1 culture ratio. Coagulation occurs under quiescent (no agitation) conditions, while attaining a peak colonization of 1×10⁹ CFU/g. The fermentation process is accompanied by a releasal of lactic acid, acetaldehyde, acetic acid & diacetyl, and an acidity drop to pH 4.0-4.6. The exact temperature profile is optimized for microbial culture growth. For example, streptococcus salivarius subsp.thermophilus (ST) has an optimized growth at 55-65° C., and lactobacillus delbrueckii subsp.bulgaricus (LB) which have an optimized growth at 30-40° C., when combined the microbial growth is optimized by holding the temperatures and acidity are attained until peak colonization are achieved. Furthermore, the addition of fermented milk products to the batter prepared in Stage 2a, warrant reducing the centrifugal pressures to a range of 3.5-4.3 mPa (500-625 psi), in order to minimize syneresis (liquid separation in gel), and/or constituent settling type defects.

The mix is now ready for use in the preferred embodiment's Lacteal Batters. The fermented-milk product is now complete, and rapidly chilled to a desirable temperature range of 2-7° C. (35-45° F.) for later use in Stage 2a, or pasteurized in for aseptic & UHT post-processing and packaging.

As shown in Table 8, Lacteal Batters consist of 33% of the total product weight the preferred embodiments. The present invention's Lacteal Batter shall be comprised of at least the milk with a thickener/stabilizer ingredient to attain a creamy, viscous, flowing batter for use in Stage 3.

TABLE 11
Preferred Embodiment's Lacteal Batter Composition

| Nutrition Facts | | | | Daily Values (DV) | |
|---|---|---|---|---|---|
| Lowfat Lacteal Batter | | | | based on daily | |
| One (1) precooked serving: | | | % DV | caloric intake of | |
| 77 g (2.2 oz) product weight | | | (2,000 Kcals/day) | 2,000 kcals/d | |
| Total calories | 80 | kcal | 4% | | |
| Calories from fats | 19 | kcal | — | | |
| Calories from saturated fats | 7 | kcal | — | | |
| Total fats | 2.1 | g | 3% | 65 | g |
| Saturated fatty acids | 0.7 | g | 4% | 20 | g |
| Polyunsaturated fats | 0.3 | g | — | — | |
| Monounsaturated fats | 3.5 | g | — | — | |
| Trans fatty acids | 0.01 | g | — | — | |
| Cholesterol | 3.5 | g | .01% | 300 | g |
| Sodium, Na | 142 | g | 6% | 2400 | g |
| Potassium, K | 384 | mg | 11% | 3500 | mg |
| Total carbohydrates | 11 | g | 4% | 300 | g |
| Dietary fiber | 1.8 | g | 7% | 25 | g |
| Soluble fiber | 0.5 | g | 86% | 0.6 | g |
| Insoluble fiber | 1.3 | g | — | — | |
| Sugars, totals | 4.8 | g | — | — | |
| Other sugars (no added sugars) | 0.1 | g | — | — | |
| Carbohydrates, by difference | 11.7 | g | — | — | |
| Protein | 4.2 | g | 8% | 50 | g |

Vitamins & Minerals

| | | | | | |
|---|---|---|---|---|---|
| Vitamin A | 293 | IU | 6% | 5000 | IU |
| Vitamin C (total ascorbic acid) | 6 | mg | 11% | 60 | mg |
| Calcium, Ca | 128 | mg | 13% | 1000 | mg |
| Iron, Fe | 2.7 | mg | 15% | 18 | mg |
| Vitamin D | 18 | mcg | 5% | 400 | IU |
| Vitamin E (tocopherols) | 0.4 | IU | 1% | 30 | IU |
| Vitamin K (phylloquinone) | 53 | mcg | 67% | 80 | mcg, μg |
| Vitamin B1 (thiamin) | 0.1 | mg | 6% | 1.5 | mg |
| Vitamin B2 (riboflavin) | 0.2 | mg | 10% | 1.7 | mg |
| Niacin | 0.5 | mg | 3% | 20 | mg |
| Vitamin B6 | 0.1 | mg | 7% | 2 | mg |
| Folate (Total) | 20 | mcg | 5% | 400 | mcg, μg |
| Vitamin B12 | 0.3 | mcg | 5% | 6 | mcg, μg |
| Pantothenic acid | 0.3 | mg | 3% | 10 | mg |
| Phosphorus, P | 88 | mg | 9% | 1000 | mg |
| Magnesium, Mg | 18 | mg | 4% | 400 | mg |
| Zinc, Zn | 0.4 | mg | 3% | 15 | mg |
| Selenium, Se | 4.5 | mcg | 6% | 70 | mcg, μg |
| Copper, Cu | 0.04 | mg | 2% | 2 | mg |
| Manganese, Mn | 0.4 | mg | 19% | 2 | mg |

TABLE 12
Preferred Embodiment's Lacteal Coated Pizzas -
Meal Product Assembly

| | | | Precooked | |
|---|---|---|---|---|
| Prototype | | | Meal Entrée: | |
| Product | Component | Stage | 191 g (6.75 oz) | % |
| Cheese | Pizza Dough | 1 | 62 g (2.2 oz) | 33% |
| Lacteal | Lacteal Batter | 2 | 77 g (2.7 oz) | 40% |
| Coated | Toppings | 3 | 52 g (1.8 oz) | 27% |
| Pizzas | Net Weight Loss - Oven | 4 | −21 g (−3/4 oz) | −11% |
| | Baking | | | |
| | Packaging | 5 | Varies | na |
| | Product Labeling | 6 | na | na |
| | Net Cooked Product | — | 170 g (6 oz) | 100% |
| | Weight | | | |

### Stage 3—Lacteal Coated Pizzas Product Assembly:

Table 12 identifies the meal entrée components contained in the preferred embodiment's 191 g (6.75 oz) Lacteal Coated Pizza. In accordance with Tables 8, 11, 12-16, the preferred embodiment's Lacteal Coated Pizzas are preferably prepared as follows. Scale the dough for an individual meal entrée, prepared in Stage 1. Followed by opening, kneading smoothing, flattening and perforating the dough to prevent air-pressure buildup during baking. Next, apply the present invention's Lacteal Batter, prepared in Stage 2. Followed by spreading the topping products. Followed by spreading the topping products shown in Table 8, which are comprised of shredded lowfat cheddar, lowfat Swiss, and part skim milk mozzarella, along with herbs & spices. The quantity of batter, dough & topping used are based on individual preferences, as are the added constituents. Alternatively, Tables 9 & 10 illustrates the present invention's compositional variations. Generally speaking, these added constituents are subject to individual preferences, that include the plurality of livestock products (i.e. poultry, fish, & meat), cheeses, plant foods (vegetables, fruits, & milled products), and flavorings/spices.

TABLE 13
Preferred embodiment

| Nutrition Analysis | | | | Daily Values | |
|---|---|---|---|---|---|
| Cheese Lacteal Coated Pizza | | | | (DV) Based | |
| Topped with a yogurt-containing | | | | on 2,000 | |
| Lacteal Batter, and shredded | | | | kcals/day | |
| lowfat cheddar, part skim milk mozarrella | | | % DV | Daily | |
| & lowfat Swiss cheeses. 2 slice serving: | | | on 2,000 | Caloric | |
| 191 g (6.75 oz) - precooked weight. | | | kcals/d | Intake | |
| Total Calories | 336 | kcal | 17% | | |
| Calories from fats | 48 | kcal | 8% | | |
| Calories from saturated fats | 29 | kcal | 16% | | |
| Total fats | 5.3 | g | 8% | 65 | g |
| Saturated fatty acids | 3.2 | g | 16% | 20 | g |
| Polyunsaturated fats | 1.3 | g | — | — | |
| Monounsaturated fats | 3.5 | g | — | — | |
| Trans fatty acids | 0.01 | g | — | — | |
| Cholesterol | 23 | g | 8% | 300 | g |
| Sodium, Na | 515 | g | 21% | 2400 | mg |
| Potassium, K | 858 | mg | 25% | 3500 | mg |
| Total carbohydrates | 52.5 | g | 17 | 300 | g |
| Dietary fiber | 6.9 | g | 28% | 25 | g |
| Soluble fiber | 2.1 | g | 345% | 0.6 | g |
| Insoluble fiber | 5.5 | g | — | — | |
| Sugars, totals | 5.9 | g | — | — | |
| Other sugars (no added sugars). | 0.3 | g | — | — | |
| Carbohydrates, by difference | 50 | g | — | — | |
| Protein | 19.5 | g | 39% | 50 | g |

Vitamins & Minerals

| | | | | | |
|---|---|---|---|---|---|
| Vitamin A | 819 | IU | 16% | 5000 | IU |
| Vitamin C, (total ascorbic acid) | 11 | mg | 19% | 60 | mg |
| Calcium, Ca | 543 | mg | 54% | 1000 | mg |
| Iron, Fe | 8.0 | mg | 44% | 18 | mg |
| Vitamin D | 18.5 | mcg | 4.5% | 400 | mcg |
| Vitamin E (tocopherols) | 11.3 | IU | 38% | 30 | IU |
| Vitamin K (phylloquinone) | 108 | mcg | 134% | 80 | mcg |
| Vitamin B1 (thiamin) | 0.3 | mg | 18% | 1.5 | mg |
| Vitamin B2 (riboflavin) | 0.4 | mg | 23% | 1.7 | mg |
| Niacin | 3.0 | mg | 15% | 20 | mg |
| Vitamin B6 | 0.3 | mg | 16% | 2 | mg |
| Folate | 66 | mcg | 17% | 400 | mcg |
| Vitamin B12 | 0.8 | mcg | 13% | 6 | mcg |
| Pantothenic acid | 0.8 | mg | 8% | 10 | mg |
| Phosphorus, P | 470 | mg | 47% | 1000 | mg |
| Magnesium, Mg | 77 | mg | 19% | 400 | mg |
| Zinc, Zn | 2.7 | mg | 18% | 15 | mg |
| Selenium, Se | 34 | mcg | 48% | 70 | mcg |
| Copper, Cu | 0.2 | mg | 10% | 2 | mg |
| Manganese, Mn | 1.9 | mg | 93% | 2 | mg |

TABLE 14
Preferred Embodiment's Cooking Times & Temperatures

| | Cheese Lacteal Coated Pizzas ™ | | | |
|---|---|---|---|---|
| Preferred | Thin/Medium Crust | | | |
| Embodiment: | Packaged | Precooked | Cooking | |
| Category | Product Type | Temperature | Temperature | Cooking Time |
| Food Retailers & | Frozen | ≦0° C. (32° F.) | 204–260° C. | 20–25 |
| Food Processors: | | | (400–500° F.) | minutes |
| Retailed Packaged | Chilled | 0–7° C. | 204–260° C. | 10–15 |
| Pizzas For At-Home | | (32–45° F.) | (400–500° F.) | minutes |
| Consumption | Aseptically | Ambient | 204–260° C. | 8–12 |
| (Residential). | packaged, | temperature | (400–500° F.) | minutes |
| | shelf-stable, | | | |
| | UHT processed | | | |
| | foods | | | |
| Foodservices: | Fresh-baked | Ambient | 371–427° C. | 6–8 |
| Fresh-Baked Pizzas | for | Temperature | (700–800° F.) | minutes |
| For Away From | Consumption | | | |
| Home Consumption. | On-Premises or | | | |
| (Commercial) | Take-Away | | | |

### Stage 4—Oven Baking:

Table 14 shows the preferred embodiment's cooking times and temperatures, which vary with oven types, precooked temperatures, and such forth. Other factors influencing baking quality and performance are residual moisture, flour oxidation, water hardness, along with environmental variables such as air vapor, ambient air temperature and altitude. Consequently, the present invention's methods & compositions require adjustments based on trial batching, conducted under similar conditions, using the exact ingredients, environmental conditions, and manufacturing processes.

### Stage 5—Packaging & Product Shelf Life:

By varying the processing and packaging methodologies, wide varieties of meal-solutions are now possible. The present inventions can be packaged as ready-to-eat, frozen, chilled, shelf stable, or pizza kits using a plurality of constituents, shapes, thickness, and configurations. Table 15 shows the product shelf life for the most common packaging and processing variations. The taste and odor (organoleptic) properties influence packaging selections, particularly the shelf life of aseptically processed foods.

The present inventions can be sold as ready-to-eat (fully-cooked), partially cooked (parbaked), and uncooked products can be packaged in a number of different manners. The present inventions can be hermitically sealed in airtight packaging can be accomplished in a number of ways. The present inventions can be air tight packaged in reduced oxygen packaging that is accomplished by replacing the reduced amount of oxygen with one or more gases, or by controlling the packaged oxygen content to a level below typical atmosphere (21% oxygen).

The use of aseptic type processing and packaging of the present inventions offers the creation of long-lasting, shelf-stable food products (e.g. aseptic packaging that contain fully-cooked, ready-to-eat convenience foods). The present inventions may be packaging following UHT commercially sterilization, filling and sealing in sealed sterilized, aseptic environments. More specifically the Lacteal Batter may be UHT processed and aseptically packaged to be stored at ambient temperature. Lacteal Coated Pizzas may be UHT/aseptically processed & packaged in a fully cooked state to microbially terminate any potential pathogens.

Aseptically processed food require UHT treatment, and post-processing in sterile environments in order to lethally terminate any microbially active cultures or pathogens, disable phosphatase enzymes, and lessen the potential for spoilage taste/textural defects. Commercial sterilization occurs when the product temperature is raised and held for specified time duration, typically as follows: 2-5 seconds @135° C. (275° F.) or 1-2 seconds @141° C. (285° F.). Furthermore, the shortening of elevated temperature holding durations is advantageous to continuous-flow processing plant operation. Common aseptic, pre-sterilized packing includes are shown below.

The present inventions may be processed and packaged in variety of contained that include airtight cans, paperboard/plastic/foil/plastic laminates, flexible pouches, thermoformed glass, plastic, or metal in preformed sterilized containers, blow mold, fill, & seal type containers, flow molded packaging, bag-in-box; bulk totes containers, erect, fill, and seal using knock-down blanks (e.g. gable-top cartons, cambri-bloc), and such forth.

### Stage 6: Nutritional Labeling

As shown in Tables 13 & 16, the preferred embodiment's Cheese Lacteal Coated Pizza™ is a perfectly calorically balanced, nutrient-dense, all-in-one meal, which satisfies the following healthy food criterias. Firstly, in accordance with US-FDA, federal regulatory standards 21 CFR 101.9 (k)(1), 101.14(c)-(d) & 101.70, the preferred embodiment contains over 500 IU vitamin A, 6 mg vitamin C, 100 mg calcium, 1.8 mg iron, 5 g protein, and 2.5 g dietary-fiber. Secondly, in accordance with the federal regulatory standard 21 CFR 101.13 (m), the preferred embodiment contain less than the established threshold for total fats, saturated-fats, sodium, and cholesterol. From a public health standpoint, the preferred embodiment, as shown in Tables 8, 11, 13, 14, & 16, comply with numerous federal regulatory standards authorizing the following health claims.

The preferred embodiment complies with federal regulatory Docket No. 99P-2209, authorizing a health claim on “Increasing Dietary Intake of Whole Grains, Lowers CHD & Certain Cancers Risks. “As shown in Tables 8, 13 & 16, the preferred embodiment is low in fat and contains over 51% whole-grain flour and 3.0 g of non-fortified, dietary-fiber.

The preferred embodiment complies with federal regulatory standard 21 CFR 101.72, authorizing a health claim on “Raising Calcium Intake, Lowers Osteoporosis Risks.” As shown in Table 16, the preferred embodiment contains 20% DV of non-fortified calcium, which exceeds the phosphorous content.

The preferred embodiment complies with federal regulatory Docket No. 00Q-1582, authorizing a health claim on “Raising Dietary Potassium Intakes, Reduces Hypertension & Stroke Risks. “As shown in Table 13, the preferred embodiment contains unfortified potassium levels that exceed 10% DV, and is low in total fats, saturated fats, sodium & cholesterol.

The preferred embodiment complies with federal regulatory standard 21 CFR 101.76, authorizing a health claim on “Dietary Fiber-Containing Grains, Vegetables & Fruits, &Lowers Cancer Risks. “As shown in Table 16, the preferred embodiment contains a minimum of 10% DV unfortified dietary-fiber, derived from approved sources.

The preferred embodiment complies with federal regulatory standard 21 CFR 101.73, authorizing a health claim on “Reducing Intake of Dietary Fat, Lowers Cancer Risks.” As shown in Table 16, the preferred embodiment is low in lipids and saturated fats.

The preferred embodiment complies with federal regulatory standard 21 CFR 101.74, authorizing a health claim on “Lowering Sodium Uptakes, Reduces Hypertension Risks.” As shown in Table 16, the preferred embodiment is low in sodium.

The preferred embodiment complies with federal regulatory standard 21 CFR 101.75, authorizing a health claim on “Reducing Saturated Fat & Cholesterol, Lowers CHD Risks.” As shown in Table 16, the preferred embodiment is low in lipids, saturated fats, and cholesterol.

TABLE 16
Nutritional Facts
Cheese Lacteal Coated Pizza
topped with a yogurt-containing Lacteal Batter, and
lowfat cheddar, mozzarella & Swiss cheeses.

| Meal Entrée - 2 slice serving | | | 2,000 kcals/day | | |
|---|---|---|---|---|---|
| Amount per serving: | | | | Daily Values | |
| 191 g (6.75 oz) - precooked product wt. | | | % DV | (DV) | |
| Total Calories | 336 | kcals | 17% | 2000 | kcals |
| Calories From Fats | 48 | kcals | 8% | 585 | kcals |
| Calories From Saturated Fats | 29 | kcals | 16% | 180 | kcals |
| Total Fat | 5.3 | g | 8% | 65 | g |
| Saturated Fats | 3.2 | g | 16% | 20 | g |
| Polyunsaturated Fats | 1.3 | g | — | | |
| Monounsaturated Fats | 3.5 | g | — | | |
| Trans Fats | 0.01 | g | — | — | |
| Cholesterol | 23 | mg | 8% | 300 | g |
| Sodium, Na | 515 | mg | 21% | 2400 | mg |
| Potassium, K | 858 | mg | 25% | 3500 | mg |
| Total Carbohydrate | 52.5 | g | 17% | 300 | g |
| Dietary Fiber | 6.9 | g | 28% | 25 | g |
| Soluble Fiber | 2.1 | g | 345% | 0.6 | g |
| Insoluble Fiber | 5.5 | g | — | — | |
| Sugars, Totals | 5.9 | g | — | — | |
| Other Sugars | 0.3 | g | — | — | |
| Protein | 19.5 | g | 39% | 50 | g |

Essential Vitamins & Minerals

| | | | | | |
|---|---|---|---|---|---|
| Vitamin A | 819 | IU | 16% | 5000 | IU |
| Vitamin C | 11 | mg | 19% | 60 | mg |
| Calcium, Ca | 543 | mg | 54% | 1000 | mg |
| Iron, Fe | 8.0 | mg | 44% | 18 | mg |

Calorie Breakdown

| | | | | | |
|---|---|---|---|---|---|
| Calories from Fats | 48 | kcals | 8% | 585 | kcals |
| Calories from Carbohydrates | 210 | kcals | 18% | 1,200 | kcals |
| Calories from Proteins | 78 | kcals | 39% | 200 | kcals |

Ingredients: Crust - enriched, unbleached whole-wheat flours (consisting 51% whole grain flour & 49% whole-wheat flour); filtered water; safflower oil; salt substitute; active baker's yeast. Lacteal Batter - enriched, unbleached whole wheat flours - 15% protein; nonfat yogurt; milk, nonfat fluid milk with added vitamin A; nonfat dry milk, without added vitamin A; comminuted green, raw cabbage; unsalted butter; garlic powder; mixed canola, safflower & other vegetable oils (consisting of equal parts of USDA commodity food, low saturated fat vegetable oil; high-stability, non-trans, (70% high-oleic), natreon canola oil; primary safflower oil of commerce); dried parsley; black pepper; dehydrated onions flakes; salt substitute. Toppings - a combination of shredded lowfat cheddar, lowfat Swiss & mozzarella (part skim milk); dried parsley, herbs & spices.
Authorized Health Claims: Increasing dietary potassium intake lowers risk of hypertension & stroke risks - Docket No. 00Q-1582; Increasing dietary whole-grain intake lowers risk of CHD & certain cancers risks - Docket No. 99P-2209; Increasing calcium intake lowers osteoporosis risks - Title 21 CFR 101.72; Reducing dietary fat intake lowers cancer risks - Title 21 CFR 101.73; Lowering sodium uptakes, reduces hypertension risks - 21 CFR 101.74; Reducing saturated fat & cholesterol, lowers CHD risks - Title 21 CFR 101.75; Increasing dietary fiber containing intake of grains & vegetables, lowers cancer risks - Title 21 CFR 101.76; Increasing dietary & soluble-fiber containing grains & vegetables, lowers CHD risks - Title 21 CFR 101.77; Increasing folate intake lowers neural-tube defects - Title 21 CFR 101.79; Increasing soluble-fiber intake lowers CHD & LDL cholesterol risks - Title 21 CFR 101.81.

The preferred embodiment complies with federal regulatory standard 21 CFR 101.77, authorizing a health claim on “Dietary & Soluble-fiber containing Grains, Vegetables, Lowers CHD Risks.” As shown in Table 16, the preferred embodiment contains over 0.6 g, non-fortified, soluble-fiber derived from eligible sources, and is low in fats, saturated fats & cholesterol.

The preferred embodiment complies with federal regulatory standard 21 CFR 101.78, authorizing a health claim on “Increased Dietary Vegetables & Fruits, Lowers Cancer Risks.” As shown in Tables 8 & 16, the preferred embodiment contains over 0.6 g non-fortified, soluble dietary fiber derived from eligible sources, and over 10% DV of non-fortified vitamins A & C.

The preferred embodiment complies with federal regulatory standard 21 CFR 101.79, authorizing a health claim on “Increasing Folate Uptakes, Lowers Neural Tube Defects.” As shown in Table 13, the preferred embodiment contains over 40 mcg of nonfortified folate.

The preferred embodiment complies with federal regulatory standard 21 CFR 101.81, authorizing a health claim on “Increasing Soluble Fiber from Certain Foods, Lowers CHD Risks & LDL Cholesterol.” As shown in Table 16, the preferred embodiment is low in lipids, saturated fats & cholesterol, and contains dietary soluble-fibers from approved sources, such as pectins, beta-glucans, guar gums, inulin oligofructose, mucilages-psyllium, oats, barley, fruits, & vegetables. As result of slow gastric emptying, these types of dietary soluble fibers lower serum cholesterol by delaying small intestinal absorption of some nutrients.

### EMBODIMENTS

The following product applications are adaptations of the preferred embodiments, which present yet more objects and advantages that are in keeping with the spirit & scope of the present invention's Lacteal Coated Pizzas and Lacteal Batters. All recombined milk products used herein, shall meet the same safety protocols as homogenized milk products. To increase shelf life and inhibit mold, particularly in frozen & parbaked products, calcium propionate, sodium propionate acidic, and/or other acidic solutions may optionally be added.

### EXAMPLE 1

### Calcium Caseinates, Thickeners/Stabilizers & Flavor Enhancers/Coloring

In this example, the present invention's Lacteal Coated Pizzas contain added calcium caseinates, alternative types of thickeners/stabilizers, flavor enhancers, cheddar cheese toppings on a thin, high-protein crust. The bulk dough (in baker's percents) comprises 100% high-gluten whole wheat flour, 59% water, 5% calcium caseinates, 3% flavoring enhancers/colorings agents, 2% salt, and 1% active dry yeast. The Lacteal Batter (in prorated percents of the batter weight) is comprised of 48% nonfat, fluid milk, 15% nonfat yogurt, 10% raw spinach, 5% thickener/stabilizers, 5% canola oil, 5% calcium caseinates, 5% flavoring enhancers/coloring agents, 5% spices, and 2% salt. The toppings (in prorated percents of the total product weight) comprise 20% shredded lowfat cheddar with annatto coloring, and 4% herbs & spices.

The calcium caseinates are added to increase the nutritive value, function as emulsifiers to keep fats suspended, impart a tintable white-opaque coloring, and neutralize capsaicin. Furthermore, caseins are slow digesting, long-lasting proteins that supply sustained amino acids and nitrogen nutrients over a long duration. This ingredient is typically added in the form of a spray-dried milk protein that is a pale-colored, bland-flavored NFS with a neutral pH. Caseins are naturally high in protein and low in sodium. The calcium caseinates are thoroughly blended into the batter or dough mixture during product preparation.

The thickening/stabilizing agents are selected from the group comprising modified starch, alginates, lecithins (emulsifiers), locust bean guars, mono/diglycerides (emulsifiers), carboxymethyls, methyl-celluloses (insoluble fibers), carrageenans, glycerides, pectins (insoluble fiber), guar-gums (insoluble fibers), sodium aluminosilicates, or other similar substances that are used singly or in combinations of mixtures. Compared with the preferred embodiment's flour-based starch product, considerably less quantity of thickening/stabilizing agents are required to be added to the Lacteal Batter as suspending, setting, bodying, and bulking agents. The main disadvantages in using these alternative thickening/stabilizing agents over the preferred embodiment's lipid-in-starch paste, is the escalation in manufacturing processes and costs, as well the potential for imparting some undesirable taste/textural defects.

The flavoring/coloring additives are selected from the group comprising of cloves, ginger, fructose, annatto, turmeric (Indian curry spice), among the many other spices & herbs, used singly or in combinations of mixtures thereof, to enhance flavor, and/or imparts a desired coloring. Flavorings are added directly to the hot batter, or infused in hot oil to attain a desired color (discarding the seed after desired coloration is achieved). Spices such as ginger and turmeric, among many others, have known health benefits.

### EXAMPLE 2

### Whey Protein Concentrates, Soy Products, & Soluble/insoluble Fibers

In this example, the present invention's Lacteal Coated Pizzas contain added whey protein concentrates, soy products, soluble/insoluble fibers, spinach & cheddar cheese toppings over a medium-thick, high-protein crust. The bulk dough (in baker's percents) comprises 100% flour (90% high-gluten flour & 10% soy flour), 59% water, 5% whey protein concentrate, 5% fructose, 2% salt, 1.5% active compressed yeast, 1% soluble fibers, and 1% insoluble fibers. The Lacteal Batter (in prorated percents of the batter weight) is comprised of 48% nonfat, fluid milk, 15% nonfat yogurt, 10% raw cabbage, 4% thickener/stabilizers (selected from the group shown in example 1), 6% soybean oil, 7.5% whey protein concentrate, 7.5% flavor enhancers/coloring agents, and 2% salt. The toppings (in prorated percents of the total product weight) comprise 15% shredded lowfat cheddar with annatto coloring, 5% spinach, and 4% spices & flavorings.

Soy & whey concentrates are added to produce softer, protein enriched foods that brown more easily, and have a creamier mouthfeel. Optionally added whey protein concentrates (WPC) are preferably comprised of 80% (dwb) protein, 3% ash, less than 5% lactose, and have less than 8% fat. WPC are bland tasting, water-soluble fractions that are derived from filtered “whey.” Both, soy & whey concentrates are commonly available in instantized-forms, that are easily blended and dispersed to the batter and dough products.

Insoluble fibers (also known as reduced carbohydrates) are selected from the group comprising of celluloses (cereal fibers such as wheat bran), lignins, and certain types of hemicelluloses, and pectins, used singly or in combinations of mixtures thereof. Insoluble fibers are nonviscous, nonabsorbent dietetic constituents that quickly pass through the stomach, and are relatively nonfermentable.

Soluble fibers enhance satiety by slow-gastric emptying, and are added to the dough/batter, selected from the group comprising of 0.75 g whole-oats, 1.7 g psyllium-seed husks, 4.0% beta-glucans (rolled-oats), whole-oat flours containing 4% beta-glucan soluble fiber or psyllium husks (mucilages), 5.5% beta-glucan derived from oat-brans, 10% beta-glucans (dwb) derived from alpha-amylase hydrolyzed oat-brans or whole-oat flours, 5.5% beta-glucans derived from barley grains, oatrim soluble fibers extracted from amylase-hydrolyzed, whole oat-flours or oat-bran sources, pectins, legumes (e.g. dry beans, peas & lentils), guar gums, inulin oligofructoses, fruits, and vegetables, used singly or in combinations of mixtures thereof.

### EXAMPLE 3

### Deep-dish, Flaky Crust, Nonfat Solids & Emulsifiers

In this example, the present invention of a Lacteal Coated Pizza contains added nonfat solids (NFMS), emulsifiers, shredded garlic-spiced chicken toppings over a deep-dish, flaky pastry-like crust. The bulk dough (in baker's percents) comprises 100% flour (soft-white flours, white-club flours, and/or western-white whole-wheat flours), 44% water, 8% butter-oil blend low in saturated fats, 7% fructose, 4% nonfat solid fractions, 2% emulsifiers, 1% active dry yeast, and 1% salt composition. The Lacteal Batter (in prorated percents of the batter weight) is comprised of 48% nonfat fluid milk, 15% nonfat yogurt, 10% raw cabbage, 8% NFMS, 7% flavor enhancers & colorings (as shown in example 1), 4% oil-butter blend, 4% thickener/stabilizing agent (as shown in example 1), 2% salt, and 2% emulsifiers. The toppings (in prorated percents of the total product weight) comprise 15% shredded lowfat chicken, 5% comminuted spinach, and 2% dried garlic.

Nonfat milk solids are optionally added in the form of dried powders, in the range of 10% to 30% by milk weight, to increase density and viscosity. NFMS produce softer, protein enriched foods that brown more easily (milliard effect) and have a creamier mouthfeel.

Emulsifiers are anti-staling, immiscible blending agents that modify the surface tension in the component phase, and produce a uniform dispersion. These additives impart crust softness by improving stack & chain butterfat formation. At the biochemical level, this inhibits the diary proteins from completely coating fat droplets, which does improve freeze/thaw performance. Emulsifiers are also important in lowering the fat content of the present invention's flaky pasty-like crust (i.e. comprised of laminated dough layers with a low-fat lipid mixture placed between thin layers), which is used in this example.

The optionally added emulsifiers are chosen from the group comprising of: acetic & fatty acid esters of glycerol, ammonium salts of phosphatidic acid, calcium stearoyl (or oleyl) lactylate, citric & fatty acid esters of glycerol, diacetyltartaric, dimethylpolysiloxane (emulsifier, antifoaming agent, anti-caking agent), dioctyl sodium sulphosuccinate, lactic acid & fatty acid esters of glycerol, magnesium stearate (emulsifier, stabilizer), mono/di-glycerides, pectin (vegetable gum & emulsifier), polyglycerol esters, polyglycerol esters of interesterified ricinoleic acid, polysorbate 80/60/65, propylene glycol mono/di-esters, sodium stearoyl (or oleyl) lactylate, sorbitan monostearate, sorbitan tristearate, sucrose acetate isobutyrate, sucrose esters, and tartaric & fatty acid esters of glycerol, used singly or in combinations of mixtures thereof.

### EXAMPLE 4

### Omega-3 & 6 Enriched, Salt Substitutes, & Antioxidants

In this example, the present invention of a Lacteal Coated Pizza comprises omega-3 & 6 rich oils, soluble-fiber rich grains, salt substitutes, and antioxidants (safe preservatives) on a chopped-walnuts containing, medium-thick, whole-wheat crust, topped with chopped, garlic-spiced salmon, tuna, herring, mackerel, or combinations thereof.

For this example, the bulk dough (in baker's percents) comprises 100% hard-red winter wheat flours, 56% water, 5% whey protein concentrate powders, 1½% salt composition(see explanation below), 2% safflower seed oils, 1% chopped walnuts, and antioxidants <1% (see explanation below). The Lacteal Batter (in prorated percents of the batter weight) is comprised of 48% nonfat fluid milk, 15% nonfat yogurt, 10% raw cabbage, 7% flavor enhancers & colorings, 7% blend of canola oil & walnut oils, 5% nonfat solid fractions (see example 3), 4% thickener/stabilizer(per example 1), 2% emulsifiers (as per example 3), 1% salt composition (per example 4), and antioxidants <1% (per example 4). The toppings (in prorated percents of the total product weight) comprise 20% chopped, garlic-spiced, omega-rich fishes like salmon, tuna, herring, or mackerel, used singly or in combinations or mixture thereof, 5% flavoring, and 2% dried garlic.

As shown in Table 7, the AHA (TLC) {American HeartAssociation's—Therapeutic Lifestyle Changes} dietary guidelines achieve reducing the risks of LDL, cholesterimia, and coronary artery disease by lowering DV's for disease-related key nutrients limits. The AHA (TLC) recommend the following reduced DV's: 10% poly-unsaturated fatty acid (PUFA), 20% mono-unsaturated fatty acids (MUFA), 50-60% carbohydrate, 15% protein, 7% saturated fats acids, 25-30% total fats, and dietary cholesterol <200 mg/d, increasing consumption of whole grains, vegetables & other soluble-rich foods, and eliminating trans-fats. This example, along with the preferred embodiment and most of the other examples, meet the AHA-TLC dietary guidelines.

The antioxidants are selected from the group comprising of propionic acids, ascorbic acids, citric acids, BHA, BHT, heptylparabens, stannous chlorides, tertiary butylhydroquinones or other similar substances, which are used alone or in other combinations of mixtures thereof. These apparently-safe substances inhibit microbial spoilage, extend product shelf-life, and maintain/improve wholesomeness. In accordance with USFDA's federal regulatory standards—21 CFR§172, these antioxidants are typically added in an upper limit of about 0.02% by fat content.

The aforementioned salt composition is a reduced sodium product that is preferably derived from magnesium, phosphorus, and potassium salts, or similar substances that are used singly or in combinations of mixtures thereof. Salt substitutes are exceptionally important in reducing consumers' intake of sodium, and corresponding lower their risk of hypertension and other coronary diseases.

The omega-6 oils, contained herein are selected from the group consisting of corn, safflower, soybean, cottonseed, sunflower oils, or similar substances that are used singly, or in combinations of mixtures thereof. Likewise, the omega-3 oils contained herein are selected from the group consisting of walnut oils, flaxseed oils, canola oils, or fatty fish marine oils, or similar substances that are also used singly, or in combinations of mixtures thereof.

### EXAMPLE 5

### Plant Sterols/Stanols Oils

In this example, a heart-healthy Lacteal Coated Pizza contains plant sterols/stanols oils that are derived from canola, corn and/or wheat germ oils. The bulk dough (in baker's percents) comprises 100% flour (70% high-gluten whole wheat flour, and 30% three-grain mix from any kind of combination of grain/flour type such as ⅓ whole-grain flour, ⅓ soy flour, ⅓ corn flour or ⅓ ground oats), 49% water, 4% phytosterols-containing oils (e.g. corn oil), 2% fructose, 1½% salt composition (see example 4), 1% active dry yeast, and 1% wheat germ. The Lacteal Batter (in prorated percents of the batter weight) is comprised of 48% nonfat fluid milk, 15% nonfat yogurt, 10% raw cabbage, 7% flavor enhancers & colorings, 7% phytosterols-containing oils (e.g. canola oil), 5% nonfat solid fractions (as per example 1), 4% thickener/stabilizer (as per example 1), 2% emulsifiers (as per example 3), 1% salt composition, and antioxidants <1% (as per example 4). The toppings (in prorated percents of the total product weight) comprise 20% shredded, garlic-spiced chicken, 5% comminuted frozen spinach, and 2% garlic.

The present invention complies with the federal regulatory standard 21 CFR101.83, authorizing the health claim on lowering CHD risks by increasing dietary intake of plant-derived compounds known as phytosterols, which are either a plant stanol esters (lacking a double bonded sterol ring), or a plant sterol esters (having a double bonded sterol rings). In this example, the Lacteal Coated Pizzas comprise phytosterol-containing oils (chosen from the many oilproducts now marketed), which lower dietary cholesterol uptake by inhibiting its intestinal absorption.

### EXAMPLE 6

### Soya Milk Derived Lacteal Coated Pizzas

This type of product benefits those consumers whom for medical, religious, personal and/or other reasons, refrain from consuming diary products. In this example, the pizza is comprised of a soya-milk derived Lacteal Batter, topped with lowfat barbequed chicken, green peppers, and mushrooms over a three-grain crust. The bulk dough (in baker's percents) comprises 100% flour {70% high-gluten whole wheat flour, 20% defattened soybean flours & 10% rolled-oats (4.0% beta-glucan soluble fibers), fortified with riboflavin, thiamine, niacin, pyridoxine, zinc oxide & iron}, 49% water, 4% soybean oil, 2% cane juice, 2% vital wheat gluten, 1½% salt composition (as per example 4), and 1% active dry yeast. The Lacteal Batter (in prorated percents of the batter weight) is comprised of 53% soya-milk, 15% fermented soya-milk (i.e. bean curd), 8% raw cabbage, 7% canola oil, 5% soy protein isolates, 4% flavorings, 2% cane juice, 1% sea-salt, and less than 1% of lecithin, ginger, turmeric, carrageenan, guar-gum, vitamin A palpitate (coloring), calcium carbonate, vitamin D, folic acid & ascorbic acid (preservative). The toppings (in prorated percents of the total product weight) comprise 20% barbequed lowfat chicken, 3% sliced mushrooms, and 2% diced green peppers.

Soybeans are loaded with heart-healthy proteins, essential fatty acids (e.g. linoleic & linolenic), antioxidants (e.g. zinc, iron, & B vitamins), and isoflavones (phytoestrogens). Added herein are soy products that are selected from the group comprising of soya-milk, soy flours, soy protein concentrates, soy protein isolates, hydrolyzed soy proteins, powder and such forth, which are used singly and in combination of mixtures thereof. For enhanced fortification, digestibility, blendability, viscosity, and taste, these substances are commonly instantized with other constituents such as emulsifiers, corn solids, lecithin, and other similar substances. To avoid processing defects (e.g. fish-eyes), these substances should be prehydrated prior to the blending.

Soy flours are typically derived from roasted soybeans that are ground into a fine powder, which are available in full fat, lowfat, and defatted forms. These substances have a pleasant nutty flavor and texture.

Soy tofu or bean curds are smooth, pale-colored foods that are typically prepared by using calcium/magnesium sulfating agents to fermenting and precipitated soy products.

Lacteal Coated Pizzas are naturally high in organic chemical compounds comprising the fat-soluble vitamins A, C, E, D & K, as well as the water-soluble, kidney excreted vitamins B, C & P. From farm to table essential nutrients are lost, and restored in this and other examples by the use of supplementation. Some types of vitamin/mineral supplementation are particularly benefit the elderly, diseased, physically impaired, immuniocompromised, post-surgical, and allergenic consumers, whom are at higher risk of developing dietary-related deficiencies.

### EXAMPLE 7

### Nondairy, Nonwheat, Lacteal Coated Pizzas

This product version is similar to example 6, with the following exceptions: 1) the doughs and batters are derived from nonwheat containing flour products, and 2) the milk products are derived from non-animal sources, most notably coconut or soy-bean milk. This type of product benefits those consumers whom for medical, religious or personal reasons, refrain from consuming both diary and wheat products.

A nonwheat, nondairy version of example 6 may alternatively be created by replacing wheat with rye, soy, rice or other nonwheat flours. To assimilate the characteristic rise and structure of raised wheat dough, non-wheat flours require the addition a chemical leaving agent, as well as a hydrocolloidal gum or similar substance. Using these and other additives to replace the microstructure in nonwheat doughs are now well known compositions and processes in the culinary arts. Furthermore, many nonwheat flours may similarly be used alone or in combinations of mixtures to replace wheat-type dough products, such as rye, rice, potato, or smelt-derived flours. For added variety, nutritive value, and longer shelf life, these nonwheat doughs may be further fermented using a nondairy culture media, to produce a sourdough type crust.

### EXAMPLE 8

### Nondairy, Nongluten, Lacteal Coated Pizzas on a Sourdough Crust

This product version is similar to example 6, with the following exceptions: 1) the doughs and batters are derived from nongluten containing flour products, and 2) the milk products are derived from non-animal sources, most notably coconut or soy-bean milk. This type of product benefits those consumers whom for medical, religious or personal reasons, refrain from consuming both diary and gluten products.

A nongluten, nondairy version of example 6 may alternatively be created by replacing wheat with soy, rice or other nongluten containing flours. To assimilate the characteristic rise and structure of raised wheat dough, non-gluten containing flours require the addition a chemical leaving agent, as well as a hydrocolloidal gum or similar substance. Using these and other additives to replace the glutinous microstructure are now well known compositions and processes in the culinary arts. Furthermore, many nongluten flours may similarly be used alone or in combinations of mixtures to replace wheat & rye dough products, such as soy, rice or potato-derived flours. For added variety, nutritive value, and longer shelf life, these nonwheat doughs may be further fermented using a nondairy culture media, to produce a sourdough type crust.

### EXAMPLE 9

### Lactose Free, Fast-Acting Whey Protein Isolates & Maltodextrins

In this example, the Lacteal Coated Pizza is a lactose-free product that contains optionally added whey protein isolates and maltodextrins.

The bulk dough formula (in baker's percents) for a medium-thick sourdough crust comprises 100% flour (50% hard-red winter wheat flour & 50% rye flour), 56% water, 10% cottage cheese whey powder, 7% white vinegar (5%—fifty grain), 4% whey protein isolates, 4% maltodextrins, 4% vegetable oil blend (canola, safflower & corn oils), 2% sea salt, 1% sourdough starter, and less than 1% propionic acid (preservative).

The Lacteal Batter (in prorated percents of the batter weight) is comprised of 48% nonfat fluid milk, 15% lactose-free, nonfat yogurt, 9% raw cabbage, 6% flavorings, 5% flaxseed oil, 5% whey protein isolates, 4% maltodextrins, and 1% or less of sea-salt, locust bean guar, alginate acid, citric acid, & beta-carotene (coloring) vitamin A, beta-carotene, vitamin B₁ (thiamine), vitamin B₂ (riboflavin), vitamin B₃ (niacin), vitamin B₅ (pantothenic acid), vitamin B₆ (pyridoxine hydrochloride), vitamin B₁₂ (cyanocobalamin), vitamin Bₕ (inositol), vitamin Bₓ (para-aminobenzoic acid), vitamin Bₜ (L-carnitine), vitamin C (ascorbic acid), vitamin D (calciferol), vitamin E (tocopherol), vitamin B₇ (biotin), vitamin K, & vitamin M (folic acid/folate). The toppings comprise (in prorated percents of the total product weight) 20% lowfat mozzarella (part-skim milk, low moisture), 5% red peppers, 2% black olives, 2% spices, and less than 1% citric acid (preservative).

This application particularly benefits those consumers who for medical, religious or personal reasons, abstain from consuming lactose-containing diary products. The added whey protein isolates & maltodextrins are easily digested and quickly absorbed, along with rapidly raising glucose & amino acid blood concentrations. Generally speaking, aseptically processing and packaging the Lacteal Coated Pizzas and Lacteal Batters as fully-cooked, UHT treated foods particularly benefits diseased, immunocompromised, and interncare consumers. This type of processing, as previously discussed in Stage 5, in necessary to lethally terminate any microbial cultures.

Maltodextrins are a sweet high-glycemic polysaccharides that are as quickly absorbed as glucose. These water soluble substances are typically white to slightly yellow colored solids that have a shorter chain length and a low-molecular-weight. These are carbohydrates are typically derived from acidic-hydrolyzed potato starches.

In its native form, raw whey consists predominantly of water and lactose. Due to ultrafiltration processes, whey protein isolates capture 90% of the protein fractions, while reducing the lactose content to less than 0.5%. Whey protein isolates are generally added in the form of dried powder. To avoid solubility defects, these substances should preferably be presoaked and rehydrated prior to blending.

Whey proteins isolates are neither practical nor useful to the diverse population for several important reasons. Due to its soaring sodium content and elevated phosphorous to calcium ratio, whey protein isolates amplify concerns over hypertension and bone loss. Despite these disadvantages, certain populations would benefit from this product formulation, notably lactose intolerant malabsorbers and exercise enthusiasts.

Small quantities of locust bean guar and alginate acid are optionally added to thicken/stabilize the Lacteal Batter, as well as to impart a desirable chewy texture. Most noteworthy, is that these water-soluble vegetable gums are heat stable hydrocolloids that help to form high-strength, semi-solid milk microstructures. To insure proper solubility and avoid mix defects (e.g. fish eyes), prior to blending into the Lacteal Batters, the dried gum powders are preferably pre-dissolved and rehydrated in high-temperature aqueous solutions.

The sourdough crust is prepared in a conventional manor using at least 50% rye flours. Compared to regular dough, sourdough acidification extends the product shelf life by increasing its mold resistance. The citric acid (preservative) is optionally added in this product example to retard mold and produce a lighter dough texture.

### EXAMPLE 10

### Hydrolyzed Whey Proteins & Hydrolyzed Caseinate

In this example, a fortified Lacteal Coated Pizzas of the present invention is topped with shredded lowfat chicken on a medium-thick crust, and has optionally added hydrolyzed whey protein & hydrolyzed caseinates. This product formulation benefits the elderly, the very young, immunocompromised, individuals with digestive disorders (e.g. acid reflux or ulcerated conditions), malabsorbers, and post-operative patients. More specifically, this lowfat, fast-acting, digestible diary protein contains all of the essential & nonessential amino acids. This soft, lactose-free product version is preferably aseptically processed and packaged.

The sourdough formula (in baker's percents) comprises 100% flour (hard-red winter wheat flours, 30% rye flour & sourdough starter), 56% water, 4% hydrolyzed whey protein isolates, 4% hydrolyzed caseinates, 4% maltodextrins, 4% canola, safflower & corn oils blend, 2% sea salt, and 1% dry active yeast. The Lacteal Batters (in prorated percents of the batter weight) are comprised of 48% nonfat lactose free milk, 15% nonfat yogurt, 9% raw cabbage, 6% flavorings, 4% hydrolyzed whey protein isolates, 4% hydrolyzed caseinates, 4% blend of canola & corn oil, 2% stearoyl-2-lactylate (emulsifier), 2% sea-salt, and 1% or less of carrageenan, alginate acid, vitamin A, beta-carotene, vitamin B₁ (thiamine), vitamin B₂ (riboflavin), vitamin B₃ (niacin), vitamin B₅ (pantothenic acid), vitamin B₆ (pyridoxine hydrochloride), vitamin B₁₂ (cyanocobalamin), vitamin Bₕ (inositol), vitamin Bₓ (para-aminobenzoic acid), vitamin Bₜ (L-carnitine), vitamin C (ascorbic acid), vitamin D (calciferol), vitamin E (tocopherol), vitamin B₇ (biotin), vitamin K, & vitamin M (folic acid/folate). The toppings (in prorated percents of the total product weight) comprise 20% lowfat chicken and 5% nonspicy flavorings.

Due to its soaring sodium content, hydrolyzed whey proteins and hydrolyzed caseinates are neither practical nor useful to the diverse population. These substances have elevated phosphorous to calcium ratios that amplify concerns over bone loss and escalate manufacturing costs. Despite these disadvantages, certain populations benefit from this product formulation. Due to its increased digestibility, absorption rate, and assimilation, the following consumer groups would benefit from this product formulation: individuals with dietary tract impairments, post surgical patients, the elderly, the immunocompromised, and lactose malabsorbers.

At the biochemical level, hydrolysis is the process of splitting long amino acids chains linked by peptide bonds into small protein bits (i.e. polypeptides 50-100 amino acids & peptides <50 amino acids). Typically, digestion and absorption of consumed intact proteins are slowed by enzymatic breakdown. Conversely, consuming hydrolyzed proteins are more easily digested and rapidly absorbed, due to the polypeptides are already broken into smaller protein peptide configurations.

A high temperature, short-duration pasteurizing step, or other similar post-processing pasteurizing processes is highly recommended to lethally terminate in the Lacteal Batters any microbially active microorganisms prior to packaging. As previously enumerated, the manor and duration of high temperature processing is dependent on the type of packaging, intended shelf-life, and the method of storage (e.g. ascetic, stored at ambient temperature, chilled, frozen). The use of high-temperature post-processing treatments (e.g. UHT, UHST, HTST) may be accomplished by high temperature treatment of both batter, as well as packaging the food product as a fully-cooked food, among other factors known to those experienced in the culinary arts.

Emulsifiers (surfactants) are lipid substances that mesh with wheat & milk proteins to form finer, firmer networks. Emulsifiers produce with softer, finer crumb structures that impart a creamy texture & mouthfeel, while also slowing crumb firming (i.e. Anti-staling agents). The present invention's soft foods properties are important features to individuals with chewing & swallowing disorders (dysfagia), the elderly, and the very young. Some of the more common preferred emulsifiers that may be used herein, as previously enumerated in example 3, are monoglycerides, diglycerides, lecithin, and polysorbate 60/80.

This example is comprised of carrageenans (thickening/stabilizing agent), which are seaweed-type gums most commonly derived from spiny, red-algae, and typically available as iota, kappa, and lambda powders. At the biochemical level, carageenans are long chain polysaccharides that have a sugar galactose backbone. When these substances are mixed with milk proteins (i.e. caseins), they form complex mesh-like networks. Consequently, when carageenans are added to the present invention's Lacteal Batters these substances function to thickener/stabilizers the mixture, protect the batter during cycles of thawing and refreezing, and to increase its air-entrainment capacity.

By reacting with unwanted oxygen, the ascorbic acid, or alternatively erythorbic acid, which has no vitamin value, is added herein to help prevent color and flavor losses. To insure solubility and minimize processing defects, the aforementioned powder additives are preferably prehydrated in a high-temperature aqueous solution prior to blending.

The present invention is naturally high in organic chemical compounds comprising the fat-soluble vitamins A, C, E, D & K, as well as the water-soluble, kidney excreted vitamins B, C & P. Despite the present invention's high mineral and vitamin content, from farm to table essential nutrients are lost, and are thus restored herein by supplementation. Some types of vitamin/mineral supplementation are particularly beneficial to the elderly, diseased, physically impaired, immuniocompromised, post-surgical, and allergenic consumers, whom are at higher risk of developing deficiencies.

### EXAMPLE 11

### Whey Protein Concentrates & Calcium Caseinates

Example 11 is alternatively composed of the following ingredients. The bulk dough (in baker's percents) comprises 100% deep-dish crust (preferably comprised of soft-white wheats with subclasses white-club or western-white, hard white, soft-red winter wheat, and/or hard-red winter wheat flour, averaging about 10% protein), 54% water, 8% butter-oil blend, 4% whey protein isolate, 2% salt composition, 1% active dry yeast, 1% chopped walnuts, and 1% asbsorbic acid (preservative).

The Lacteal Batters (in prorated percents of the batter weight) are comprised of 48% nonfat fluid milk, 15% nonfat yogurt, 10% raw cabbage, 5% flavor enhancers & colorings, 4% whey protein concentrate powder that is manufactured with instantised distilled monoglycerides, 4% calcium caseinate powders, 4% blend of canola oil & walnut oils, 1% salt composition, and less than 1% of guar-guar, alginates, vitamin A, beta-carotene, vitamin B₁ (thiamine), vitamin B₂ (riboflavin), vitamin B₃ (niacin), vitamin B₅ (pantothenic acid), vitamin B₆ (pyridoxine hydrochloride), vitamin B₁₂ (cyanocobalamin), vitamin Bₕ (inositol), vitamin Bₓ (para-aminobenzoic acid), vitamin Bₜ (L-carnitine), vitamin C (ascorbic acid), vitamin D (calciferol), vitamin E (tocopherol), vitamin B₇(biotin), vitamin K, & vitamin M (folic acid/folate). The toppings (in prorated percents of the total product weight) comprise 20% chopped, garlic-spiced barbequed beef, and 2% dried garlic, and less than 1% of jalapeño peppers.

Whey proteins are fast-acting proteins that contain highly digestible amino acids, which are anabolically synthesized. In terms of digestion and absorption, whey proteins are fast-acting substances that rapidly impart satiety (feeling of fullness) and rapid impart metabolic/hormonal responses. More specifically, after consuming whey proteins, amino acid and nitrogen blood plasma levels are rapidly raised and returned to baseline within two (2) hours. Compared to caseins, whey proteins illicit a much higher concentrations of a satiety-signaling chemical called cholecystokinin, as well as fat-burning glucagon-like peptides hormones.

Calcium caseinates are bland flavored, creamy-colored, highly-stable substances, which are high in calcium and low in sodium. Caseinates have distinctly different bioactive peptides (alpha, beta, & kappa-caseins) profiles than do whey proteins. Calcium caseinates are slow-acting proteins that are anti-catabolically synthesized. Caseinates form coagulated curds in the stomach, and is digested over about a duration of about seven (7) hours. Consequently, caseinates are slow acting proteins that gradually raise amino acid and nitrogen blood levels.

Both whey and casein proteins are typically available in the form of dried milk powders. To insure their solubility and minimize processing defects, these substances are preferably presoaked and rehydrated in a high-temperature aqueous solution prior to blending.

Furthermore, the thickened doughs in this and other product examples, shall be parbaked prior to product assembly to insure it fully cooks.

### EXAMPLE 12

### Fondue Style Lacteal Batter

In this example, the Lacteal Batters are prepared in a fondue style batter/toppings with the melt and elasticity characteristics of raclette-type cheeses. This example contains (in prorated percents of the batter): 49% nonfat fluid milk, 20% raclette-type cheese, 8% raw cabbage, 5% flavor enhancers, 4% whey protein concentrate powder manufactured with instantised distilled monoglycerides, 4% calcium caseinate powders, 4% butter-oil blend, 1% salt composition (as per example 4), and 1% or less of locust bean, carrageenans, alginates, beta-carotene, thiamine, riboflavin, niacin, pantothenic acid, pyridoxine hydrochloride, cyanocobalamin, inositol, para-aminobenzoic acid, L-carnitine, ascorbic acid (preservative), calciferol, tocopherol, biotin, vitamin K, & folic acid.

The small quantities of vegetable gums added to the Lacteal Batter herein, form a mesh-like network that thickens/stabilizes the mixture, and improves its organoleptical properties (i.e. texture, body& mouthfeel). Locust bean gums (extracted from locust bean seed) are heat shock resistant, water-absorbers that impart a desirable chewy texture, and have smooth meltdown. Carrageenans have excellent milk reactivity and exhibit high viscosity after cooking. These constituents are typically available in powderized forms extracted from the red seaweed class rhodophyceae, and selected from the group comprising of chondrus crispus (kappa/lambda carrageenan), eucheuma cottonii (kappa carrageenan), eucheuma spinosum (iota carrageenan), gigartina, and lambda/kappa carrageenans, used singly or combinations of mixtures thereof. To insure solubility and minimize processing defects, powderized vegetable gums shall preferably be prehydrated in a high-temperature aqueous solution prior to blending.

### EXAMPLE 13

### Lacteal Batters with Varying Fermented Cultured Milk Products

In this example, altered product taste, acidity, nutrients, processing requirements, and shelf-life are achieved by varying the type of fermented-milk product contained the present invention's Lacteal Batters. Optionally included herein are Lacteal Batters that have varying types of lactic-acid bacteria and the addition of yeast cultures, catalytic enzymes (e.g. inulin), and acidifiers (e.g. acetic acid). These substances are used to alter the product tastes, nutrients, and mold/bacterial inhibition. Moreover, cultured milk products extend the Lacteal Batter product can be used to extend the shelf life from 4-7 days (without the use of preservatives or cultured milk products, the present invention's chilled) to about 10 days. The present invention's Lacteal Batters that are processed and packaged in sterile environments, and without the use of preservatives has a shelf life of about three weeks.

The use of these varying types of fermented milk products are known to experienced in the culinary arts. What is patentable herein are the fermented milk containing Lacteal Batters, which are a wholly new food product that has not been commercially marketed to date, more particularly on pizza doughs. Furthermore, the batters may also be applied to many other food products, as later enumerated.

The Lacteal Batter (in prorated percents of batter weight) is comprised herein of 48% nonfat fluid milk, 15% fermented cultured milks, 4% whey protein concentrate powder manufactured with instantised distilled monoglycerides, 4% calcium caseinate powders, 4% butter-oil blend, 1% salt composition, and less than 1% of locust bean, carrageenans, and alginates.

All cultured diary products have some naturally-occurring whey separation, (known as syneresis) that is easily resolvable by stirring. Although, the use of thickeners/stabilizers, solid milk fractions and such forth, minimizes but does not eliminate syneresis defects.

### EXAMPLE 14

### Lacteal Batter Variations

The term “lacteal” used throughout this patent text implies milk or milk-like substances that are derived from either animal sources or vegetable sources (e.g. coconuts or soybeans). Likewise, fermented-milk may similarly be derived from animal or vegetable sources. All lacteal with/without fermented milk, shall meet the same safety protocols as homogenized cow milk, among other regulatory statures.

The present invention's Lacteal Batters can be swathed over vegetables, pasta, meat, poultry or fish dishes, enveloped, encrusted, and/or rolled in dough-type products (e.g. lasagnas), used as a nutritious dipping sauce, or appetizer topping. Furthermore, the present invention's Lacteal Batters may be aseptically processed & packaged for use on un-refrigerated snack-foods. To date, there have been no other similar substances marketed on pizza doughs, whatsoever.

### EXAMPLE 15

### Carbohydrate Type Fat Replacers

In this example, the present invention of a Lacteal Coated Pizza comprises optionally added carbohydrate-type fat replacers on a medium thick crust, topped with lowfat Swiss, mozzarella, and cheddar cheeses. The modified starches, dietary fibers, gums, & saccharides carbohydrate-type fat replacers are reduced calorie, texture modifiers that mimic the slippery mouthfeel, body, and viscosity of full-fat products.

Example 15 is composed of the following ingredients. The bulk dough formula (in baker's percents) comprises 100% flour (consisting of 85% high-gluten whole-wheat flour & 15% semolina flour), 55% water, 2% egg whites, 2% salt composition, 2% vital wheat gluten (dietary fiber), 2% beta-glucan dietary fiber, 2% soybean oil, 2% maltodextrin, 1% active dry yeast, and 1% or less of oatrims (dietary fiber), carboxy-methylcelluloses (dietary fiber), stearoyl-2-lactylate (emulsifier), amylase (modified starches), and inulin. The Lacteal Batter (in prorated percents of the batter weight) is comprised of 48% nonfat milk, 15% nonfat yogurt, 9% raw cabbage, 6% flavorings, 4% calcium caseinates powder, 4% whey protein concentrate, 3% vegetable gum blend (carragenan, alginate acid & locust bean gums), 2% canola oil, 2% beta-glucan (dietary fiber), 2% sea-salt, and 1% or less of inulin (fructo-oligosaccharides), The toppings (in prorated percents of the total product weight) comprise 20% lowfat Swiss, mozzarella, & cheddar cheeses, and 5% flavorings.

The following carbohydrate-type ingredients are optionally added to mimic the physical and sensory properties of full-fat products selected from the group comprising of starches & modified starches (e.g. amylase, polydextrose), dietary fibers (e.g. beta-glucan, oatrims, celluloses), gums (e.g. vegetable gums), and saccharides (e.g. inulin or dextrose). These constituents are used singly, or in combination of mixtures thereof, to imitate the smooth, lubricated (slippery) mouthfeel of full-fat products, to physically fill voids where fat is removed, and to nutritionally replace lipids with significantly lower calorie components. The caloric content corresponds with the amount of digestible and absorbable carbohydrates.

Optionally added starches and modified starch constituents shall preferably include waxy resistant-type starches (e.g. amaleani, fairnexva15, and va20, instant stellar, n-lite, optagrade, perfectamylac, ax-1&2, pure-gel, sta-slim). These products are typically derived from potato, corn, oat, rice, wheat or tapioca starches, and have the added advantage of mixing well with emulsifiers, proteins, gums, & other modified food starches.

Dietary fibers are multifunctional constituents that increase viscosity, structural integrity, volume, fiber content, moisture holding capacity, adhesiveness, shelf-stability, and impart a fat-like slippery mouthfeel. Preferably, added fibers are selected from the group comprising of beta-glucans, hydrolyzed oat or barley flour, amylopectins, microcrystalline microcellulose particles or carboxy-methylcelluloses, which are derived from powderized oat, soybean, pea, corn, wheat-bran, and rice hulls. Solubilized dietary fibers have the added advantage of reducing CAD risks, blood cholesterol, and glucose insulin levels. Many insoluble dietary fibers that are used as “fat replacers” are more aptly described as “fat substitutes” that are comprised of indigestible, nonabsorbable matter, which have little energy value.

Optionally added hydrocolloids (hydrophilic colloids) shall preferably include water-soluble, plant-derived gums such as carrageenans, alginates, locust bean gums, and pectins (derived from bananas, plums, pears & apples purees), and less preferably from chemically modified or microbial fermented polysaccharides (e.g. kelcogel, keltrol, splendid) which may pose concerns over nutrient malabsorbtion. These constituents vary widely in thermal solubility, opacity, gelling, firmness, and elasticity characteristics.

Saccharides may optionally be added as plasticizing humectant-type fat replacers that impart sweetened tastes and slippery mouthfeels. These added constituents are preferably comprised of amylum-containing dextrins and inulin-containing fructo-oligosaccharides, which have the added advantage of increasing vitamin absorption. For example, any of the following substances may alternatively be added to the present inventions: a) maltodextrins are bulk sweeteners that are derived from corn, potato, wheat and tapioca sources (e.g. crystalean, lorelite, lycadex, maltrin, paselli d-lite, paselliexcel, pasellisa2, star-drie); b) polydextroses are water-soluble polymers of dextrose (e.g. litesse, sta-Lite) that contain 1 kcal/g amounts, or c) polyols are reduced calorie bulk sweeteners that contains 1.6-3 kcals/g. These added constituents are typically available in gels, and/or powderized forms that are preferably prehydrated, and predissolved in a high-temperature aqueous solution prior to dispersion into a mixer tank.

### EXAMPLE 16

### Protein Type Fat Replacers

In this example, the present invention of a Lacteal Coated Pizza comprises optionally added protein-type fat replacers on a medium-thick crust, topped with garlic-spiced lowfat chicken, and red peppers. Optionally added protein-type fat replacers are reduced calorie, texture modifiers that mimic the slippery mouthfeel, body, and viscosity of full-fat products.

The bulk dough (in baker's percents) comprises 100% flour (70% high-gluten whole-wheat flour & 30% defatted soybean flour), 50% water, 2% salt composition, 2% vital wheat gluten, 2% oatrim (dietary fiber), 2% soybean oil, 2% inulin (fructo-oligosaccharides), 1.5% active dry yeast, and 1% or less of carboxy-methylcelluloses (dietary fiber), stearoyl-2-lactylate (emulsifier), & amylase.

The Lacteal Batter (in prorated percents of the batter weight) is comprised of 48% nonfat fluid milk, 15% nonfat yogurt, 10% raw cabbage, 8% flavor enhancers, 4% calcium caseinates, 4% whey protein isolates, 2% soybean oil, 1% salt composition, and less than 1% of locust bean gum, alginate acid, beta-carotene, thiamine, riboflavin, niacin, pantothenic acid, pyridoxine hydrochloride, cyanocobalamin, inositol, para-aminobenzoic acid, L-carnitine, ascorbic acid (preservative), calciferol, tocopherol, biotin, vitamin K, & folic acid. Precook flavorings in preheated oil to intensify taste, prior to dispersing the herbs & spices into the mixer tank.

The toppings (in prorated percents of the total product weight) comprise 20% garlic-spiced lowfat chicken and 5% red peppers. In general, to avoid bubbling, perforate the dough prior to baking.

Fat is a multi-functional ingredient that nutritionally supplies fat-soluble vitamins and essential fatty acids (e.g. linolenic, linoleic). Functionally speaking, fats influence the product viscosity, crystallinity, along with its freezing, boiling, and melting temperatures. The fatty acid chemical configuration and its carbon chain length greatly influence its degree of fat saturation (i.e. cis or trans).

Small quantities protein-based fat replacers (e.g. whey protein isolates) in combination with other ingredients (e.g. thickeners/stabilizers), can provide lipid-like sensory characteristics (e.g. fat-like mouthfeel, flavor & textural consistency).

Protein-based fat replacers are selected from the group comprising of: microparticulated egg whites, soybean proteins, vital wheat gluten, microparticulated milk proteins (e.g., whey protein isolates, calcium caseinates). These substances achieve a smooth-creamy texture by use of heat and enzyme controlled denaturation in combination with high shear. In contrast, traditional products like gelatin may impart structure, viscosity, and a smooth mouthfeel, but offer little nutritional value.

The protein-type fat replacers are typically added in small quantities to form gels or powders, at a third of the calories of fat. To avoid mix defects these optionally added constituents are preferably prehydrated and predissolved in high-temperature aqueous solutions under conditions of controlled denaturation.

### EXAMPLE 17

### Lipid Fat Extenders & Fat Analogs

In this example, the present invention of a Lacteal Coated Pizza is a low-glycemic food that comprises optionally added fat extenders & fat analogs, on a medium-thick crust, topped with barbequed lowfat chicken & onions. The fat-extenders and fat-analogs mimic the slippery mouthfeel, and texture of full-fat products. This example is also comprised of coarsely ground white whole-wheat flour (less-bitter than the traditional red wheat). The larger ground flour particles are useful in delaying glucose digestion. The mixture also contains extra light virgin/extra virgin olive oil, which is low in saturated fat & high in PUFA's, and canola oil, which is rich in MUFA & PUFA's.

Example 17 is composed of the following ingredients. The bulk dough (in baker's percents) comprises 100% flour (70% high-gluten whole-wheat flour, 20% defatted soybean flour & 10% semolina flour), 50% water, 2% inulin, 2% canola oil (rapeseed), 2% salt composition, monoglyceride (emulsifier), 2% carboxy methyl cellulose (soluble fiber), 2% microparticulated egg whites, and 1% or less of active dry yeast. The Lacteal Batter (in prorated percents of the batter weight) is comprised of 48% nonfat fluid milk, 15% nonfat yogurt, 10% raw cabbage, 5% flavor enhancers & colorings, 4% nonfat dry milk powder, 2% defatted soybean protein, 2% olive oil, 2% salt composition, and 1% or less of locust bean gum, alginate acid, enova oil, neobene oil (fat analog), beta-carotene, pectin (apple puree), thiamine, riboflavin, niacin, pantothenic acid, pyridoxine hydrochloride, cyanocobalamin, inositol, para-aminobenzoic acid, L-carnitine, ascorbic acid (preservative), calciferol, tocopherol, biotin, vitamin K, & folic acid. The toppings (in prorated percents of the total product weight) comprise 20% barbequed lowfat chicken, 3% onions, and 2% flavorings.

Small quantities of fat extenders are optionally added to optimize the functionality of decreased quantities of lipids. Fat extenders are compound substances that are commonly comprised of emulsifiers (e.g. mono/diglycerides) that are mixed with dietary fibers, thickeners/stabilizers or vegetable gums (e.g. carboxy methyl celluloses, locust bean gums, methyl celluloses, pectins, or calcium/sodium alginates) or similar substances.

Small quantities of fat analogs are optionally added as reduced calorie fat substitutes. Fat analogs compounds have substantially reduced calories due to containing inabsorbable, nondigestible food matter. These compounds are selected from the group comprising of benefit, salatrim, enova oil, neobee, caprenin, olestra, capryllic, capric or similar substances, which are used singly or in combinations of mixtures thereof.

Fat analogs have some undesirable features. Chemically speaking, fat analogs are comprised of short medium and long-chain triglyceride compounds that frequently are heat unstable. More disconcerting, is that these substances may pose public health concerns over increased serum cholesterol or cause nutrient malabsorption of fat soluble vitamins A, D, E, & K (e.g. behenic, a cocoa butter replacers or olestra, a sucrose polyester).

### EXAMPLE 18

### Frozen Lacteal Coated Pizzas & Frozen Lacteal Batters

In this example, Lacteal Coated Pizzas & Lacteal Batters are prepared as parbaked or fully-cooked frozen foods. Unlike fresh-baked food products, frozen bakery goods can have a diminished product quality from delayed leavening, freezing dehydration, freezer-burn, and under/over-risen pizza dough. Freezer-burn results occur from ice crystals forming on the surface prior to freezing, and moisture released during cycles of thawing & refreezing. The released moisture dehydrates dough/topping products, after becoming soggy, crumbly and tasteless. The present invention's Lacteal Batters resolves/improves these prior art defects by functioning as a protein-film moisture barriers.

The release of ethanol and carbon dioxide metabolites gives yeast- leavened doughs its beguiling aroma. However, frozen pizzas loose significant dough rise and this very desirable aroma of fresh baked doughs.

Product taste, flavor, and shelf-life are improved herein by using the following now techniques. Firstly, “rapid blast/flash freezing” minimizes ice crystal formation. Secondly, partially (par-baking) or fully cooking the crust prior to adding the toppings, and than freezing the combination alone, and/or as an assembled food product, helps to reduce these defects. Thirdly, optionally adding vegetable gums, and (surfactants) in order to improve structural retention during freeze/thaw cycling, as well as to achieve a sturdy, moist, and puffy rising-crust. Fourthly, improving delayed dough rise by optionally adding chemical leavening agents (e.g. sodium bicarbonate tartrates), and fermentation delaying agents (e.g. propionic acid). Fifthly, the following packaging options, among others are further included herein as important ways to preserve product quality, flavor, and shelf life: reduced oxygen packaging by removal & replacement of oxygen with other gases (e.g. nitrogen), hermitically sealed, vacuum-packed, and such forth. Sixthly, by separating the dough, batter and the toppings components into individual compartments, the product life and quality may be further improved. Seventhly, product quality and shelf life is further enhanced by the use of UHT processing to lethally terminate any microbial active cultures, with/without aseptically packaging. Eighthly, flash frozen pizzas are preferably mounted on cardboard, and wrapped in airtight packaging.

To increase shelf life and inhibit mold, particularly in frozen & parbaked products, calcium propionate, sodium propionate acidic, and/or other preservatives substances are optionally added to the dough, batter and toppings.

### EXAMPLE 19

### Present Inventions Incorporate Functional Food Properties

This example illustrates how optionally added constituents may transform the present invention's Lacteal Coated Pizzas and Lacteal Batters into functional foods.

Flavonoid-containing constituents are optionally added to the present invention's Lacteal Coated Pizzas and Lacteal Batters, selected from the following plurality of ingredients. Anthocyanidin-containing constituents, such as berries, cherries or red grapes are optionally added to potentially bolster cellular antioxidant defenses, and to maintain cognitive (brain) function. Flavanol-containing constituents, such as catechins, epicatechins, procyanidins (e.g. tea, cocoa, chocolate, apples or grapes) are optionally added for maintenance of heart-health. Flavanone-containing citrus constituents are optionally added to neutralize cell-damaging free radicals, and to bolster cellular antioxidant defenses. Flavonol-containing constituents, such as onions, apples, tea, or broccoli, are optionally added to neutralize cell-damaging free radicals, and to bolster cellular antioxidant defenses. Proanthocyanidin-containing constituents, such as cranberries, cocoa, apples, strawberries, grapes, wine, peanuts, or cinnamon, are optionally added to potentially maintain urinary tract health and retain heart health.

Sulfides/thiols-containing constituents are optionally added to the present invention's Lacteal Coated Pizzas and Lacteal Batters, selected from the following plurality of ingredients. Diallyl sulfide or allyl methyl trisulfide-containing constituents, such as garlic, onions, leeks or scallions, are added to potentially enhance detoxification of undesirable compounds, maintain heart health, and preserve healthy immune function. Dithiolthiones-containing constituents, such as cruciferous vegetables, are optionally added to preserve healthy immune function.

Carotenoid-containing constituents are optionally added to the present invention's Lacteal Coated Pizzas and Lacteal Batters, selected from the following plurality of ingredients. Beta-carotene containing constituents, such as carrots or various fruits, are optionally added to neutralize free radicals, and potentially bolster cellular antioxidant defenses. Lutein or zeaxanthin-containing constituents, such as kale, collards, spinach, corn, eggs, or citrus, are optionally added for maintenance of healthy vision. Isothiocyanates-containing constituents, such as cauliflower, broccoli, broccoli sprouts, cabbage, kale, or horseradish, are optionally added to enhance the detoxification of undesirable compounds, and to bolster cellular antioxidant defenses.

Dietary fiber-containing constituents are optionally added to the present invention's Lacteal Coated Pizzas and Lacteal Batters, selected from the following plurality of ingredients. Insoluble fiber-containing constituents such as wheat bran are optionally added for maintenance of a healthy digestive tract. Dietary fiber containing constituents such as beta glucan, oat brans, rolled oats, psyllium seed husk, or oat flours are optionally added to reduce the risk coronary heart disease (CHD). Whole grain or cereal grain-containing constituents are added to reduce CHD, lessen cancer risk, and to maintain healthy blood glucose levels. Soy proteins, soybeans, and/or soy-based ingredients are optionally added to reduce CHD risks.

Phytoestrogen-containing constituents are optionally added to the present invention's Lacteal Coated Pizzas and Lacteal Batters, selected from the following plurality of ingredients. Isoflavones-containing daidzein or genistein soybeans, and other soy-based foods, are optionally added to potentially contribute to maintenance of bone health, healthy brain & immune function, as well as for women's potential maintenance of menopausal health. Lignans such as flax, rye or some types of vegetables are optionally added to maintain heart health and preserve healthy immune function.

Prebiotic/Probiotic-containing constituents are optionally added to the present invention's Lacteal Coated Pizzas and Lacteal Batters, selected from the following plurality of ingredients. Inulin, fructo-oligosaccharides, or polydextrose-containing ingredients such as whole grains, onions, some fruits, garlic, honey, leeks or fortified foods are optionally added to potentially improve gastrointestinal health, and calcium absorption. Fermenting micro-organisms such as lactobacilli or bifidobacterias-containing cultures may improve gastrointestinal health and systemic immunity. These ingredients are heat-sensitive priobotic/probotic constituents that can be usefully added to fully cooked food products. These prebiotic/probiotic constituents are added to the present inventions following cooking, as in the form of dried herbs sprinkled on top of the pizza products.

Polyol-containing constituents are optionally added to the present invention's Lacteal Coated Pizzas and Lacteal Batters, selected from the following plurality of ingredients. Sugar-alcohol containing ingredients comprising of xylitol, sorbitol, mannitol, lactitol are optionally added to reduce the risk of dental caries over other sugar additives.

Fatty acid-containing constituents are optionally added to the present invention's Lacteal Coated Pizzas and Lacteal Batters, selected from the following plurality of ingredients. Monounsaturated fatty acids (MUFAs) derived from various types of tree-nuts are optionally added to potentially reduce CHD risks. Polyunsaturated fatty acids (PUFAs) such as omega-3 fatty acids, ALA derived from walnut or flaxseed oil, are optionally added to potentially contribute to maintaining healthy cognitive (brain) and visual function. PUFAs omega-3 fatty acids, DHA/EPA containing oils such as comprised in salmon, tuna, marine, and other fish oils, are added to potentially reduce CHD risks. PUFA's containing conjugated linoleic acid such as those comprised in beef/lamb, and certain cheeses, are optionally added to potentially contribute to maintaining healthy body composition, and immune function. Similarly the following PUFA's are alternatively added to potentially reduce CHD risks, and improve cognitive function, selected from the group comprising of hexadecenoic or palmitoleic acid derived from some fish oils or beef fat, and 9-octadecenoic acid or oleic acids derived form olive or canola oils; 9, 12 octadecadienoic acid, linoleic acid derived from soybean or corn oils; 9,12,15 octadecatrienoic acid, alpha-linolenic acid derived from soybean or canola oils; 5, 8, 11, 14, 17 eicosapentaenoic acid (EPA) derived from some fish oils, and docosohexaenoic acid (DHA) derived from certain types of fish oils, used singly or in combinations of mixtures thereof.

Phenol-containing constituents are optionally added to the present invention's Lacteal Coated Pizzas and Lacteal Batters, selected from the following plurality of ingredients. Caffeic acid or ferulic acid-containing ingredients, such as apples, pears, citrus fruits, or some vegetables are optionally added to potentially bolster cellular antioxidant defenses, contribute to maintenance of healthy vision, and heart health. Plant stanols/sterols, and free stanols /sterol ester-containing constituents such as corn, soy, wheat, wood oils, fortified table spreads, and/or fortified ingredients are optionally added to potential reduce the risk of CHD.

Photochemical-containing constituents such as green cabbages, broccoli, and spinach, are optionally added to the present invention's Lacteal Coated Pizzas and Lacteal Batters to facilitate intestinal absorption.

### EXAMPLE 20

### Desert Type Lacteal Coated Pizza with Functional Food Properties

This example illustrates a desert-style Lacteal Coated Pizza comprised of a high-fiber wheat and soy-protein crust coated with a Lacteal Batter, and covered with a fruit-containing topping product.

The bulk dough (in baker's percents) comprises 100% flour (comprised of 70% high-gluten whole-wheat flour, 10% soybean flour, 10% whole-grain, 10% semolina flour), 54% water, 4% canola oil (rapeseed), 4% soybean oil, 2% inulin, 2% salt, 2% microparticulated egg whites, and 1% active dry yeast. The Lacteal Batter (in prorated percents of the batter weight) is comprised of 48% nonfat fluid milk, 15% nonfat yogurt, 10% raw cabbage, 5% flavor enhancers & colorings, 4% nonfat dry milk powder, 2% soybean protein isolate, 2% olive oil, 2% salt composition, and 1% or less of locust bean gum, alginate acid, enova oil, pectin (apple puree), thiamine, riboflavin, niacin, pantothenic acid, pyridoxine hydrochloride, cyanocobalamin, inositol, para-aminobenzoic acid, L-carnitine, ascorbic acid (preservative), calciferol, tocopherol, biotin, vitamin K, & folic acid. The toppings (in prorated percents of the total product weight) comprise 20% natural fruit products (e.g. berries, cherries, red grapes, apples, cranberries, strawberries, or citrus fruits), 2% sugar alcohols, 2% flavorings, and 1% or less of locust bean gum, alginate acid, enova oil, neobene oil (fat analog) , beta-carotene, pectin (apple puree).

Furthermore, preservatives, preparation modifications, and varying packaging methods extend the useful shelf life, as shown in other embodiments herein.

### Conclusion

The present invention's Lacteal Coated Pizzas and Lacteal Batters are heart-healthy proteineous-polysaccharide composite foods that contain significantly less sodium than tomato-paste coated pizzas.

What is claimed is:

1. The composition of a pizza comprised of a breadlike dough that is coated with a Lacteal Batter (milk-like mixture), and covered with topping products like shredded cheeses, whereby said pizza is a heart-healthy food containing significantly less sodium than tomato-paste coated pizzas.

2. The pizza according to claim 1, whereby said dough in baker's percents (one-hundred percent of flour) comprises 100% enriched flour mix (51% whole grain flour, 49% whole wheat& maltedbarley), 55% water, 3% safflower oil, 2% salt composition, 2% leavening agents, active bakers yeast; said Lacteal Batter, in prorated percents of the batter weight, comprises 7% unbleached whole wheat enriched flours, 15% protein, 48% nonfat fluid milk, 17% nonfat yogurt, 1.8% butter, 2% oil blend (canola oil, safflower oil & mixed vegetable oils), 3% spices, 1% salt composition, 3% onions, 3% spices, 9% raw cabbage, 3% nonfat dry milk, 3% spices, and said toppings, in prorated percents of the total product weight, comprises 93% combination cheeses {shredded lowfat cheddar, lowfat Swiss & mozzarella (part skim milk)}, 7% spices & herbs.

3. The pizza according to claim 1, whereby said dough in baker's percents (one-hundred percent of flour) comprises 100% high-gluten whole wheat flour, 59% water, 5% calcium caseinates, 3% flavoring enhancers/colorings agents, 2% salt & 1% active dry yeast; said Lacteal Batter, in prorated percents of the batter weight, comprises 48% nonfat fluid milk, 15% nonfat yogurt, 10% raw spinach, 5% thickener/stabilizers, 5% canola oil, 5% calcium caseinates, 5% flavoring enhancers/coloring agents, 5% spices & 2% salt, and said toppings, in prorated percents of the total product weight, comprises 20% shredded lowfat cheddar with annatto coloring, and 4% herbs & spices.

4. The pizza according to claim 1, whereby said dough in baker's percents (one-hundred percent of flour) comprises 100% flour (90% high-gluten flour & 10% soy flour), 59% water, 5% whey protein concentrate, 5% fructose, 2% salt, 1.5% active compressed yeast, 1% soluble fibers & 1% insoluble fibers; said Lacteal Batter, in prorated percents of the batter weight; said Lacteal Batter, in prorated percents of the batter weight, comprises 48% nonfat, fluid milk, 15% nonfat yogurt, 10% raw cabbage, 4% thickener/stabilizers, 6% soybean oil, 7.5% whey protein concentrate, 7.5% flavor enhancers/coloring agents, and 2% salt, and said toppings, in prorated percents of the total product weight, comprises 15% shredded lowfat cheddar with annatto coloring, 5% spinach, and 4% spices & flavorings, whereby soy & whey concentrates are added to produce softer, protein enriched foods that brown more easily, and have a creamier mouthfeel.

5. The pizza according to claim 1, whereby said dough in baker's percents (one-hundred percent of flour) comprises 100% flour (soft-white flours, white-club flours, and/or western-white whole-wheat flours), 44% water, 8% butter-oil blend low in saturated fats, 7% fructose, 4% nonfat solid fractions, 2% emulsifiers, 1% active dry yeast, and 1% salt composition; said Lacteal Batter, in prorated percents of the batter weight, comprises 48% nonfat fluid milk, 15% nonfat yogurt, 10% raw cabbage, 8% nonfat milk solids (NFMS), 7% flavor enhancers & colorings, 4% oil-butter blend, 4% thickener/stabilizing agent, 2% salt, and 2% emulsifiers, and said toppings, in prorated percents of the total product weight, comprises 15% shredded lowfat chicken, 5% comminuted spinach, and 2% dried garlic, whereby said NFMS increase batter density and viscosity, produce softer, protein enriched foods that brown more easily (milliard effect), and have a creamier mouthfeel.

6. The pizza according to claim 1, whereby said dough in baker's percents (one-hundred percent of flour) comprises 100% hard-red winter wheat flours, 56% water, 5% whey protein concentrate powders, 1½% salt composition, 2% safflower seed oils, 1% chopped walnuts, and antioxidants <1%; said Lacteal Batter, in prorated percents of the batter weight, comprises 48% nonfat fluid milk, 15% nonfat yogurt, 10% raw cabbage, 7% flavor enhancers & colorings, 7% blend of canola oil & walnut oils, 5% nonfat solid fractions, 4% thickener/stabilizer, 2% emulsifiers, 1% salt composition, and antioxidants <1%, and said toppings, in prorated percents of the total product weight, comprises 20% chopped, garlic-spiced, omega-rich fishes like salmon, tuna, herring, or mackerel, 5% flavoring, and 2% dried garlic, used singly or in combinations or mixture thereof.

7. The pizza according to claim 1, whereby said dough in baker's percents (one-hundred percent of flour) comprises 100% flour (70% high-gluten whole wheat flour, and 30% three-grain mix from any kind of combination of grain/flour type such as ⅓ whole-grain flour, ⅓ soy flour, ⅓ corn flour or ⅓ ground oats), 49% water, 4% phytosterols-containing oils (e.g. corn oil), 2% fructose, 1½% salt composition, 1% active dry yeast, and 1% wheat germ; said Lacteal Batter, in prorated percents of the batter weight, comprises 48% nonfat fluid milk, 15% nonfat yogurt, 10% raw cabbage, 7% flavor enhancers & colorings, 7% phytosterols-containing oils, 5% nonfat solid fractions, 4% thickener/stabilizer, 2%emulsifiers, 1% salt composition, and antioxidants <1%, and said toppings, in prorated percents of the total product weight, comprises 20% shredded, garlic-spiced chicken, 5% comminuted frozen spinach, and 2% garlic, whereby the increasing dietary intake of plant-derived compounds known as phytosterols lowers dietary cholesterol uptake by inhibiting its intestinal absorption.

8. The pizza according to claim 1, whereby said dough in baker's percents (one-hundred percent of flour) comprises 100% flour {70% high-gluten whole wheat flour, 20% defattened soybean flours & 10% rolled-oats (4.0% beta-glucan soluble fibers), fortified with riboflavin, thiamine, niacin, pyridoxine, zinc oxide & iron}, 49% water, 4% soybean oil, 2% cane juice, 2% vital wheat gluten, 1½% salt composition, and 1% active dry yeast; said Lacteal Batter, in prorated percents of the batter weight, comprises 53% soya-milk, 15% fermented soya-milk (i.e. bean curd), 8% raw cabbage, 7% canola oil, 5% soy protein isolates, 4% flavorings, 2% cane juice, 1% sea-salt, and less than 1% of lecithin, ginger, turmeric, carrageenan, guar-gum, vitamin A palpitate (coloring), calcium carbonate, vitamin D, folic acid & ascorbic acid (preservative), and said toppings, in prorated percents of the total product weight, comprises 20% barbequed lowfat chicken, 3% sliced mushrooms, and 2% diced green peppers.

9. The pizza according to claim 1, whereby said dough in baker's percents (one-hundred percent of flour) comprises 100% flour (50% hard-red winter wheat flour & 50% rye flour), 56% water, 10% cottage cheese whey powder, 7% white vinegar (5%—fifty grain), 4% whey protein isolates, 4% maltodextrins, 4% vegetable oil blend (canola, safflower & corn oils), 2% sea salt, 1% sourdough starter, and less than 1% propionic acid (preservative); said Lacteal Batter, in prorated percents of the batter weight, comprises 48% nonfat fluid milk, 15% nonfat yogurt (lactose-free), 9% raw cabbage, 6% flavorings, 5% flaxseed oil, 5% whey protein isolates, 4% maltodextrins, and 1% or less of sea-salt, locust bean guar, alginate acid, citric acid, & beta-carotene (coloring) vitamin A, beta-carotene, vitamin B₁ (thiamine), vitamin B₂ (riboflavin), vitamin B₃ (niacin), vitamin B₅ (pantothenic acid), vitamin B₆ (pyridoxine hydrochloride), vitamin B₁₂ (cyanocobalamin), vitamin Bₕ (inositol), vitamin Bₓ (para-aminobenzoic acid), vitamin Bₜ (L-carnitine), vitamin C (ascorbic acid), vitamin D (calciferol), vitamin E (tocopherol), vitamin B₇ (biotin), vitamin K, & vitamin M (folic acid/folate), and said toppings, in prorated percents of the total product weight, comprises 20% lowfat mozzarella (part-skim milk, low moisture), 5% red peppers, 2% black olives, 2% spices, and less than 1% citric acid (preservative), whereby this application particularly benefits those consumers who for medical, religious or personal reasons, abstain from consuming lactose-containing diary products.

10. The pizza according to claim 1, whereby said sourdough formula in baker's percents (one-hundred percent of flour) comprises 100% flour (hard-red winter wheat flours, 30% rye flour & sourdough starter), 56% water, 4% hydrolyzed whey protein isolates, 4% hydrolyzed caseinates, 4% maltodextrins, 4% oil blend (canola, safflower& corn oils), 2% sea salt, and 1% dry active yeast; said Lacteal Batter, in prorated percents of the batter weight, comprises 48% nonfat lactose free milk, 15% nonfat yogurt, 9% raw cabbage, 6% flavorings, 4% hydrolyzed whey protein isolates, 4% hydrolyzed caseinates, 4% blend of canola & corn oil, 2% stearoyl-2-lactylate (emulsifier), 2% sea-salt, and 1% or less of carrageenan, alginate acid, vitamin A, beta-carotene, vitamin B₁ (thiamine), vitamin B₂ (riboflavin), vitamin B₃ (niacin), vitamin B₅ (pantothenic acid), vitamin B₆ (pyridoxine hydrochloride), vitamin B₁₂ (cyanocobalamin), vitamin Bₕ (inositol), vitamin Bₓ (para-aminobenzoic acid), vitamin Bₜ (L-carnitine), ascorbic acid (preservative), vitamin D (calciferol), vitamin E (tocopherol), vitamin B₇ (biotin), vitamin K, & vitamin M (folic acid/folate), and said toppings, in prorated percents of the total product weight, comprises 20% lowfat chicken and 5% nonspicy flavorings.

11. The pizza according to claim 1, whereby said dough is a deep-dish crust that in baker's percents (one-hundred percent of flour) comprises 100% flour (preferably consisting of soft-white wheats with subclasses white-club or western-white, hard white, soft-red winter wheat, and/or hard-red winter wheat flour, averaging about 10% protein), 54% water, 8% butter-oil blend, 4% whey protein isolate, 2% salt composition, 1% active dry yeast, 1% chopped walnuts, and 1% ascorbic acid (preservative); said Lacteal Batter, in prorated percents of the batter weight, comprises 48% nonfat fluid milk, 15% nonfat yogurt, 10% raw cabbage, 5% flavor enhancers & colorings, 4% whey protein concentrate powder that is manufactured with instantised distilled monoglycerides, 4% calcium caseinate powders, 4% blend of canola oil & walnut oils, 1% salt composition, and less than 1% of guar-guar, alginates, vitamin A, beta-carotene, vitamin B₁ (thiamine), vitamin B₂ (riboflavin), vitamin B₃ (niacin), vitamin B₅ (pantothenic acid), vitamin B₆ (pyridoxine hydrochloride), vitamin B₁₂ (cyanocobalamin), vitamin Bₕ (inositol), vitamin Bₓ (para-aminobenzoic acid), vitamin Bₜ (L-carnitine), ascorbic acid (preservative), vitamin D (calciferol), vitamin E (tocopherol), vitamin B₇(biotin), vitamin K, & vitamin M (folic acid/folate), and said toppings, in prorated percents of the total product weight, comprises 20% chopped, garlic-spiced barbequed beef, and 2% dried garlic, and less than 1% of jalapeno peppers.

12. The pizza according to claim 1, whereby said dough in baker's percents (one-hundred percent of flour) comprises 100% flour (consisting of 85% high-gluten whole-wheat flour & 15% semolina flour), 55% water, 2% egg whites, 2% salt composition, 2% vital wheat gluten (dietary fiber), 2% beta-glucan dietary fiber, 2% soybean oil, 2% maltodextrin, 1% active dry yeast, and 1% or less of oatrims (dietary fiber), carboxy-methylcelluloses (dietary fiber), stearoyl-2-lactylate (emulsifier), amylase (modified starches) & inulin; said Lacteal Batter, in prorated percents of the batter weight, comprises 48% nonfat milk, 15% nonfat yogurt, 9% raw cabbage, 6% flavorings, 4% calcium caseinates powder, 4% whey protein concentrate, 3% vegetable gum blend (carragenan, alginate acid & locust bean gums), 2% canola oil, 2% beta-glucan (dietary fiber), 2% sea-salt, and 1% or less of inulin (fructo-oligosaccharides), and said toppings, in prorated percents of the total product weight, and said toppings, in prorated percents of the total product weight, comprises 20% lowfat Swiss, mozzarella, & cheddar cheeses, and 5% flavorings, whereby modified starches, dietary fibers, gums, & saccharides carbohydrate-type fat replacers are reduced calorie, texture modifiers that mimic the slippery mouthfeel, body, and viscosity of full-fat products.

13. The pizza according to claim 1, whereby said dough in baker's percents (one-hundred percent of flour) comprises 100% flour (70% high-gluten whole-wheat flour & 30% defatted soybean flour), 50% water, 2% salt composition, 2% vital wheat gluten, 2% oatrim (dietary fiber), 2% soybean oil, 2% inulin (fructo-oligosaccharides), 1.5% active dry yeast, and 1% or less of carboxy-methylcelluloses (dietary fiber), stearoyl-2-lactylate (emulsifier), & amylase; said Lacteal Batter, in prorated percents of the batter weight, comprises 48% nonfat fluid milk, 15% nonfat yogurt, 10% raw cabbage, 8% flavor enhancers, 4% calcium caseinates, 4% whey protein isolates, 2% soybean oil, 1% salt composition, and less than 1% of locust bean gum, alginate acid, beta-carotene, thiamine, riboflavin, niacin, pantothenic acid, pyridoxine hydrochloride, cyanocobalamin, inositol, para-aminobenzoic acid, L-carnitine, ascorbic acid (preservative), calciferol, tocopherol, biotin, vitamin K, & folic acid, and said toppings, in prorated percents of the total product weight, comprises 20% garlic-spiced lowfat chicken and 5% red peppers, where by the optionally added protein-type fat replacers are reduced calorie, texture modifiers that mimic the slippery mouthfeel, body, and viscosity of full-fat products.

14. The pizza according to claim 1, whereby said dough in baker's percents (one-hundred percent of flour) comprises 100% flour (comprised of 70% high-gluten whole-wheat flour, 10% soybean flour, 10% whole-grain, 10% semolina flour), 54% water, 4% canola oil (rapeseed), 4% soybean oil, 2% inulin, 2% salt, 2% microparticulated egg whites, and 1% active dry yeast; said Lacteal Batter, in prorated percents of the batter weight, comprises 48% nonfat fluid milk, 15% nonfat yogurt, 10% raw cabbage, 5% flavor enhancers & colorings, 4% nonfat dry milk powder, 2% soybean protein isolate, 2% olive oil, 2% salt composition, and 1% or less of locust bean gum, alginate acid, enova oil, pectin (apple puree), thiamine, riboflavin, niacin, pantothenic acid, pyridoxine hydrochloride, cyanocobalamin, inositol, para-aminobenzoic acid, L-carnitine, ascorbic acid (preservative), calciferol, tocopherol, biotin, vitamin K, & folic acid, and said toppings, in prorated percents of the total product weight, and said toppings, in prorated percents of the total product weight, comprises 20% natural fruit products (e.g. berries, cherries, red grapes, apples, cranberries, strawberries, or citrus fruits), 2% sugar alcohols, 2% flavorings, and 1% or less of locust bean gum, alginate acid, enova oil, neobene oil (fat analog) , beta-carotene, pectin (apple puree).

15. The pizza according to claim 1, wherein said dough is derived from the plurality of flour products, selected from the group comprising of wheat, rye, corn, potato, rice, soybean, smelt flours, among grain products commonly known and used in the baking arts, present in the range of 10% to 75% of the precooked product weight.

16. The pizza according to claim 1, wherein said batter is present in the range of 10% to 75% of the precooked product weight.

17. The pizza according to claim 1, wherein said topping products are present in the range of 0% to 35% of the precooked product weight, and are selected from the plurality of cheeses, livestock (fish, fowl, pork, beef), vegetables, fruits, flavorings, herbs & spices, oils, and such forth, used singly or in any combination of mixtures thereof.

18. The pizza according to claim 1, further including said dough is a sourdough product selected from the group comprising of wheat sourdough product derived from a nondairy starter culture media; nonwheat sourdough product derived from a fermented nondairy starter culture media; whereby said sourdough crust adds variety, nutritive value, and longer shelf life.

19. A pizza comprised of a breadlike dough containing, in prorated bakers' percents (one-hundred percent of flour weight), 100% flour, 40% to 65% water, 0.5% to 9% lipid mixture, 0.5% to 4% salt composition, 0% to 15% optional additives, 0% to 15% optional flavorings/spices, 0% to 10% optional milk composition, 0% to 10% optional sweeteners, 0% to 10% optional vegetable matter, 0% to 10% optional nondairy ingredients, 0% to 5% optional eggs, 0.5% to 5% leavening agents; followedbya milk-like layer comprised of, in prorated percents of the batter weight, 51% to 80% fluid milk, 0% to 24% fermented-milk products, 0.2% to 10% thickening/stabilizing agents, 0.5% to 10% lipid mixture, 2% to 20% vegetable matter, 0% to 10% nondairy ingredients, 2% to 15% flavorings/spices, 0.5% to 5% salt composition, 0% to 10% optional additives, and covered with toppings products such as shredded cheeses, whereby said pizzas is a nutritious, delicious all-in-one meal.

20. The composition of a batter comprised of about 51% to 80% fluid milk consisting of 70-100% fluid milk, preferably 0-30% fermented milk products, 0-10% nonfat diary solid; 0.2% to 10% thickening/stabilizing agents; 0.5% to 10% lipid mixture; 2% to 20% vegetable matter; 0% to 10% nondairy ingredients, such as vital wheat gluten, soy proteins, protein hydrolsates; 2% to 15% flavorings/spices; 0.5% to 5% salt composition, and 0% to 10% additives, whereby said batter mixture is a nutritious, delicious food product accompaniment, whereby said batter has a mix viscosity that ranges from a spoonable mixture to a more pourable consistency.

21. The composition according to claim 20, wherein said batter is served as a nutritious accompaniment to complement other food products, selected from the group comprising of most notably spread on top of pizza dough; encrusted in pasta; placed between dough layers, such as lasagna; coating or accompanying livestock products (i.e. fish, fowl, pork, beet) swathed over vegetables or fruits; mixed with cheeses and served as a fondue; used as a dipping sauce condiment, and adapted to snack foods by coating a thin cracker like crust with said Lacteal Batter.

22. The compositions according to claims 19 & 20, further including air-entraining admixtures that are optionally added in the range of 0% to 0.50% by batter weight, wherein said air entraining compounds are used to reduce the ice crystal formation during thawing and refreezing cycles.

23. The compositions according to claims 19 & 20, further including carotenoid-containing constituents selected from the group consisting of beta-carotene containing constituents, such as carrots or various fruits; lutein or zeaxanthin-containing constituents, such as kale, collards, spinach, corn, eggs or citrus, and ilsothiocyanates-containing constituents, such as cauliflower, broccoli, broccoli sprouts, cabbage, kale, or horseradish, used singly or in combinations of mixtures thereof.

24. The compositions according to claims 19 & 20, further including various types of cheeses added to said batter, used singly or in any combination of mixtures, to attain a variation in physical & chemical properties ranging from elastic to inelastic consistency, and from meltable to meltless, whereby varying said cheese type is useful for different product applications.

25. The compositions according to claims 19 & 20, wherein said batter contains fermented milk products selected from the group comprising of yogurt, kefir, tofu, and other such similar substances, used singly or in combinations of mixtures, thereof.

26. The compositions according to claims 19 & 20, wherein said fermented milk is inoculated with at least one acid-producing bacteria selected from the group consisting of bacteriumlinesn, lactobacillus acidophilus, lactobacillus brevis, lactobacillus bugaricus, lactobacillus casei, lactobacillus delbruekii, lactobacillus fermenti, lactobacillus heleveticus, lactobacillus helveticus, lactobacillus lactis, lactobacillus plantarum, lactobacillus streptococcus, lactobacillus thermophillus, leuconostoc citrovorum, leuconostoc dextranicum, leuconostoc eitrovorum, leuconostoc mesenteroides, micrococcus caseolyticus, pediococcus cerevisiae, propionibacterium species, pseudomonas fraga, saccharomyces cerevisiae (kefir grain yeast culture), saccharomyces delbruecki (kefir grain yeast culture), streptococcus citrovorous, streptococcus cremoris, streptococcus diacetilactis, streptococcus durans, streptococcus faecalis, streptococcus lactis, streptococcus paracitrovorus, streptococcus thermophilus, used singly or in combinations of mixtures, thereof.

27. The compositions according to claims 19 & 20, further including dairy products are selected from the group comprising of concentrated milk powders; non-fat dry milk; calcium caseinates that are optionally added to said dough, batter and topping components, whereby said caseinate increase the nutritive value, function as emulsifiers to keep fats suspended, impart a tintable white-opaque coloring, and neutralize capsaicin; whey protein concentrates preferably comprised of 80% (dwb) protein, 3% ash, less than 5% lactose containing less than 8% fat whey powders; casein protein isolates; concentrated whey or casein protein; nonfat dry milk powders, and other similar substances, used singly or in combinations of mixtures thereof.

28. The compositions according to claims 19 & 20, further including dietary fiber-containing selected from the group consisting of beta glucan, oat brans, rolled oats, psyllium seed husk, oat flours, whole grain, cereal grain, soy proteins, soybeans, pectins, soy-based ingredients and other similar substances, used singly or in combinations of mixtures thereof.

29. The compositions according to claims 19 & 20, further including emulsifiers selected from the group comprising of acetic & fatty acid esters of glycerol, ammonium salts of phosphatidic acid, calcium stearoyl (or oleyl) lactylate, acetic & citric fatty acid esters of glycerol, diacetyltartaric & fatty acid esters of glycerol, dimethylpolysiloxane (emulsifier, antifoaming agent, anti-caking agent), dioctyl sodium sulphosuccinate, lactic acid & fatty acid esters of glycerol, magnesium stearate (emulsifier, stabilizer), mono/di-glycerides, pectin (vegetable gum & emulsifier), polyglycerol esters of fatty acids, polyglycerol esters of interesterified ricinoleic acid, polysorbate 80/60/65, propylene glycol mono/di-esters, sodium stearoyl (or oleyl) lactylate, sorbitan monostearate, sorbitan tristearate, sucrose acetate isobutyrate, sucrose esters, and tartaric & fatty acid esters of glycerol, ranging from 0% to 2% of the subtotal product weight, used singly or in combinations of mixtures thereof, wherebysurfactants improve blendabiltyof immiscibles, shape holding during freeze/thaw cycling, and impart a creamy texture and smooth mouthfeel

30. The compositions according to claims 19 & 20, further including flavonoid-containing constituents selected from the group consisting of anthocyanidin-containing constituents, such as berries, cherries orred grapes; flavanol-containing constituents, such as catechins, epicatechins, procyanidins; flavanone-containing citrus constituents; flavonol-containing constituents, such as onions, apples, tea, orbroccoli, and proanthocyanidin-containing constituents, such as cranberries, cocoa, apples, strawberries, grapes, wine, peanuts, or cinnamon, used singly or in combinations of mixtures thereof.

31. The compositions according to claims 19 & 20, wherein said flavoring/coloring are selected from the group comprising of cloves, ginger, fructose, annatto, turmeric (Indian curry spice), among the many other spices & herbs, used singly or in combinations of mixtures thereof, to enhance flavor, and/or imparts a desired coloring.

32. The compositions according to claims 19 & 20, wherein said flour is selected from the following group comprising of wheat, rye, potato, soy, smelt, corn, and other nonwheat sources, used singly or in combinations of mixtures, whereby nonwheat grain product require a chemical leavening agent, as well as a hydrocolloidal gum or similar substance to assimilate the characteristic rise and structure of raised wheat crust.

33. The compositions according to claims 19 & 20, further including insoluble fibers (also known as reduced carbohydrates) optionally added to said dough, batter and topping products, selected from the group comprising of celluloses (cereal fibers such as wheat bran), lignins, and certain types of hemicelluloses; pectins, used singly or in combinations of mixtures thereof, whereby said insoluble fibers are nonviscous, nonabsorbent dietetic constituents that quickly pass through the stomach, and are relatively nonfermentable.

34. The compositions according to claims 19 & 20, wherein said lipids are selected from the group consisting of monounsaturated fatty acids, such as in various types of tree-nuts; polyunsaturated fatty acids (PUFA), such as omega-3 fatty acids or ALA derived from walnut & flaxseed oils; omega-3 fatty acids that contain DHA & EPA oils, such as in salmon, tuna & other marine fish oils; omega-3 oils, such as walnut, flaxseed, canola, & fatty fish marine oils; conjugated linoleic acid containing PUFA's, such as in beef/lamb & certain cheeses; hexadecenoic or palmitoleic acid containing PUFA, such as marine fish oils or beef fat, 9-octadecenoic acid or oleic acids derived from olive or canola oils; 9, 12 octadecadienoic acid, linoleic acid derived from soybean & corn oils; omega-6 oils, such as corn, safflower, soybean, cottonseed & sunflower oils; 9,12,15 octadecatrienoic acid, alpha-linolenic acid derived from soybean & canola oils; 5, 8, 11, 14, 17 eicosapentaenoic acid (EPA) derived from some fish oils, and docosohexaenoic acid (DHA) derived from certain types of fish oils; cream; butter; butter-oil; dried sweet cream; anhydrous milk fat, and concentrated milk fat, used singly or in combinations of mixtures thereof.

35. The compositions according to claims 19 & 20, wherein said lipids are fat analogs and fat extenders, selected from the group comprising of benefit, salatrim, enova oil, neobee, caprenin, olestra, capryllic, capric or similar substances, used singly or in combinations of mixtures thereof, whereby these fat substitutes substantially reduce calories by containing inabsorbable, nondigestible food matter.

36. The compositions according to claims 19 & 20, wherein said lipids are protein-based fat replacers selected from the group comprising of microparticulated egg whites; soybeans proteins; vital wheat gluten; microparticulated milk proteins, such as whey proteins isolates, calcium caseinates, and other similar substances, used singly or in combinations of mixtures thereof, whereby these fat substitutes are texture modifiers that mimic the slippery mouthfeel, body, and viscosity of full-fat products.

37. The compositions according to claims 19 & 20, wherein said lipids are carbohydrate-type fat replacers, selected from the group comprising of starches, such as from potato, corn, oat, rice, wheat or tapioca starches); modified starches (e.g. amylase, polydextrose); waxy resistant-type starches, such as amaleani, fairnexva15, and va20, instant stellar, n-lite, optagrade, perfectamylac, ax-7&2, pure-gel, sta-slim) dietary fibers, such as beta-glucan, oatrims, celluloses, hydrolyzed oat or barley flour, amylopectins, microcrystalline microcellulose particles or carboxy-methylcelluloses, derived from powderized oat, soybean, pea, corn, wheat-bran & rice hulls; preferably vegetable gums, such as carrageenans, alginates, locust bean gums & pectins derived from bananas, plums, pears & apples purees; less preferably gums derived from chemically modified or microbial fermented polysaccharides, such as kelcogel, keltrol, splendid; saccharides, such as inulin or dextrose, whereby these fat substitutes mimic the slippery mouthfeel, body, and viscosity of full-fat products, with caloric levels that correspond with the amount of digestible and absorbable carbohydrates.

38. The compositions according to claims 19 & 20, wherein said milk composition is comprising of about 70% to 100% fluid milk preferably comprising of 0% to about 30% (by milk composition weight) fermented milk products; 0% to about 10% (by milk composition weight) nonfat milk solid such as whey, caseinattes, hydrolsates; 0% to about 10% (by milk composition weight) nondairy fractions, such as vital wheat gluten and soy protein isolates, used singly or in combinations of mixtures thereof.

39. The compositions according to claims 19 & 20, wherein said milk composition from the group comprising of either non-animal sources, such as rice milk, coconut, and soybean milk, or animal sources, such as cow&goatmilk, whereby some consumers for medical, religious, or personal reasons, refrain from consuming animal diary products.

40. The compositions according to claims 19 & 20, further including nondairy products are selected from the group comprising of concentrated milk powders are non-fat dry milk, whey powders, casein, or milk protein powders or any combination of mixtures thereof, whereby said batter is an edible proteineous-polysaccharide composite for oral human consumption comprised of a fully cooked product of complex carbohydrate, coated with a layer of semisolid, viscous-flowing, lacteal-like mixture preferably containing fermented-milk products, preferably covered with a topping layer.

41. The compositions according to claims 19 & 20, further including phenol-containing constituents, selected from the group consisting of caffeic acid; ferulic acid-containing ingredients, such as apples, pears, citrus fruits, or some vegetables; plant stanols/sterols, and free stanols/sterol ester-containing constituents, such as corn, soy, wheat, wood oils, fortified table spreads & similar products, used singly or in combinations of mixtures thereof, whereby such substances reduce the risk of CHD.

42. The compositions according to claims 19 & 20, further including preservatives, selected from the group comprising of antioxidants, such as (propionic acids, ascorbic acids, citric acids, BHA, BHT, heptylparabens, stannous chlorides, tertiary butylhydroquinones or other similar substances, which are used alone or in other combinations of mixtures thereof, which are typically added in an upper limit of about 0.02% by fat content, whereby these apparently-safe substances inhibit microbial spoilage, extend product shelf-life, and maintain/improve wholesomeness.

43. The compositions according to claims 19 & 20, further including phytoestrogen-containing constituents selected from the group consisting of isoflavones-containing daidzein; genistein soybeans; other soy-based foods, and lignans, such as flax, rye orsome types of vegetables, used singly or in combinations of mixtures thereof.

44. The compositions according to claims 19 & 20, further including polyol-containing constituents selected from the group consisting of sugar-alcohols, such as xylitol, sorbitol, mannitol, and lactitol, used singly or in combinations of mixtures thereof, whereby said sugar alcohols reduce the risk of dental caries over other sugar additives.

45. The compositions according to claims 19 & 20, further including prebiotic/probiotic-containing constituents selected from the group consisting of inulin; fructo-oligosaccharides; polydextrose-containing ingredients, such as whole grains, onions, some fruits, garlic, honey, leeks or fortified foods, and fermenting micro-organisms, such as lactobacilli or bifidobacterias-containing cultures, used singly or in combinations of mixtures thereof.

46. The compositions according to claims 19 & 20, wherein said salt composition is preferably a reduced sodium product derived from magnesium, phosphorus, and potassium salts, or similar substances that are used singly or in combinations of mixtures, whereby lower sodium content reduces consumers risk of hypertension and other coronary diseases.

47. The compositions according to claims 19 & 20, further including soluble fibers, selected from the group comprising of 0.75 g whole-oats; 1.7 g psyllium-seed husks; 4.0% beta-glucans (rolled-oats); whole-oat flours containing 4% beta-glucan soluble fiber or psyllium husks (mucilages); 5.5% beta-glucan derived from oat-brans; 10% (dwb) beta-glucans derived from alpha-amylase hydrolyzed oat-brans or whole-oat flours; 5.5% beta-glucans derived from barleygrains; oatrim soluble fibers extracted from amylase-hydrolyzed; whole oat-flours; oat-bran sources; pectins; legumes, such as dry beans, peas & lentils; guar gums; inulin oligofructoses; fruits, and vegetables, used singly or in combinations of mixtures thereof, whereby said soluble fibers enhance satiety by slow-gastric emptying.

48. The compositions according to claims 19 & 20, where said flours and milk products are soy-derived products selected from the group comprising of soya-milk, soy flours, soy protein concentrates, soy protein isolates, hydrolyzed soy proteins, powder and such forth, which are used singly and in combination of mixtures thereof, whereby said soybeans are loaded with heart-healthy proteins, essential fatty acids (e.g. linoleic & linolenic), antioxidants (e.g. zinc, iron, & B vitamins), and isoflavones (phytoestrogens).

49. The compositions according to claims 19 & 20, further including sulfides/thiols-containing constituents selected from the group consisting of diallyl sulfides; allyl methyl trisulfide-containing constituents, such as garlic, onions, leeks & scallions, and dithiolthiones-containing constituents, such as cruciferous vegetables, used singly or in combinations of mixtures thereof.

50. The compositions according to claims 19 & 20, wherein said sweeteners are selected from the group comprising of maltodextrins, dextrins, glucose, lactose, acidic-hydrolyzed potato starches, whereby said some types of dextrins, such as maltodextrins, are sweet high-glycemic polysaccharides that are as quickly absorbed as glucose.

51. The compositions according to claims 19 & 20, wherein said thickening & stabilizing agents are selected from the group comprising of acacias, agarose (agar) gums, alginates carboxymethyls, alginic acids, ammonium alginates, arabinogalactan, calcium alginates, carrageenans, glycerides, gellans, guar-gums (insoluble fibers), isinglass, karaya hydroxypropyls, lecithins (emulsifiers), locust bean gum, methyl ethyl celluloses, methyl-celluloses (insoluble fibers), modified starch, mono/diglycerides (emulsifiers), pectins (insoluble fiber), potassium alginates, processed eucheuma seaweeds, propylene glycol alginates, sodium alginates, sodium aluminosilicates, sodium carboxymethylcelluloses, tragacanths, xanthan methylcelluloses, and similar substances, used singly or in combinations of mixtures thereof, whereby these substances increase viscosity by partially absorbing moisture; stabilize emulsions by inhibiting state changes in complex mixtures of oils, water, acids, & solids; increase air-entrainment holding; improve shape holding, reduce syneresis (weeping), inhibit ice crystallation during freeze/thaw cycling, minimize diary lactose graininess, and improve mouthfeel.

52. The compositions according to claims 19 & 20, further includes whey protein isolates & maltodextrins that are, whereby these substances are easily digested and quickly absorbed, along with rapidly raising glucose & amino acid blood concentrations benefiting lactose intolerant malabsorbers and exercise enthusiasts.

53. The compositions according to claims 19 & 20, wherein said vegetables are selected from the group consisting of broccoli, spinaches, Brussels sprouts, cabbages, cauliflowers, collard greens, kale, kohlrabi, rutabaga, turnips, bok choy and Chinese cabbages, arugula, or watercress and other similar ingredients, used singly or in combinations of mixtures thereof, whereby said vegetables require wet/dry volume adjustments by those skilled in the culinary arts.

54. The compositions according to claims 19 & 20, further including vitamins and mineral supplementation selected from the group comprising of vitamin A, beta-carotene, vitamin B₁ (thiamine), vitamin B₂ (riboflavin), vitamin B₃ (niacin), vitamin B₅ (pantothenic acid), vitamin B₆ (pyridoxine hydrochloride), vitamin B₁₂ (cyanocobalamin), vitamin Bₕ (inositol), vitamin Bₓ (para-aminobenzoic acid), vitamin Bₜ (L-carnitine), vitamin C (ascorbic acid), vitamin D (calciferol), vitamin E (tocopherol), vitamin B₇ (biotin), vitamin K, & vitamin M (folic acid/folate), as well as other vitamins & minerals, used singly or in combinations of mixtures thereof, whereby supplementation particularly benefits the elderly, diseased, physically impaired, immuniocompromised, post-surgical, and allergenic consumers, whom are at higher risk of developing dietary-related deficiencies.

55. The compositions according to claims 19 & 20, wherein said batter comprises 48% nonfat fluid milk, 15% fermented cultured milks, 4% whey protein concentrate powder manufactured with instantised distilled monoglycerides, 4% calcium caseinate powders, 4% butter-oil blend, 1% salt composition, and less than 1% of locust bean, carrageenans, and alginates, whereby said batter contains varying fermented milk products using singly or in combinations of mixture thereof, such as yogurt, kefir, tofu, and other such similar substances.

56. The composition according to claim 20, wherein said batter is a fondue mixture comprised of 49% nonfat fluid milk, 20% raclette-type cheese, 8% raw cabbage, 5% flavor enhancers, 4% whey protein concentrate powder manufactured with instantised distilled monoglycerides, 4% calcium caseinate powders, 4% butter-oil blend, 1% salt composition (as per example 4), and 1% or less of locust bean, carrageenans, alginates, beta-carotene, thiamine, riboflavin, niacin, pantothenic acid, pyridoxine hydrochloride, cyanocobalamin, inositol, para-aminobenzoic acid, L-carnitine, ascorbic acid (preservative), calciferol, tocopherol, biotin, vitamin K, & folic acid, whereby said batter is a delicious, nutritious fondue.

57. The processes of preparing a pizza comprised of a breadlike crust coated with a Lacteal Batter (milk-like mixture) that is composed of a thickening/stabilizing agent, lipids, flavorings & preferably fermented milk, which is covered with a topping product like shredded cheeses, whereby said pizza is an edible proteineous-polysaccharide composite for oral human consumption comprised of a fully cooked product of complex carbohydrate, coated with a layer of semisolid, viscous-flowing, lacteal-like mixture preferably containing fermented-milk products, preferably covered with a topping layer.

58. The processes of preparing a batter by means of screening a milk compositions for low bacteria and deleterious ingredients, separating, clarifying, and standardizing the milk composition to desired fat content, pasteurizing the milk composition, adding and blending a quantity of a thickening agent, a vegetable product, a lipid mixture, a salt composition, a flavoring/spice composition, preferably a fermented milk product such as yogurt to form a semi-solid, viscous-flowing milk-like mixture.

59. The methods according to claims 57 & 58,further including packaging environments selected from the group comprising of hermitically sealed, airtight packaging in reduced oxygen packaging; packaging with reduced amount of oxygen; packaging with replacing the with one or more gases; packaging with oxygen below typical atmosphere (21% oxygen), and such forth used singly of in any combination to wrap and seal the present inventions.

60. The methods according to claims 57 & 58, further including added to said dough, batter and topping components in the form of spray-dried milk proteins, whereby said caseinates are slow digesting, long-lasting proteins that supply sustained amino acids and nitrogen nutrients over a long duration.

61. The methods according to claims 57 & 58, further including prehydrated & presoaking powders in high temperature aqueous solutions prior to blending.

62. The methods according to claims 57 & 58, further including packaging selected from the group comprising of airtight cans; flexible pouches; cardboard; paperboard; plastic; foil; plastic laminates; thermoformed glass; plastic; metal; preformed sterilized containers; blow mold, fill, & seal type containers; flow molded packaging; bag-in-box; bulk totes containers; erect, fill, and seal using knock-down blanks such as gable-top cartons; cambri-bloc; and such forth, used singly of in any combination to wrap and seal the present inventions.

63. The methods according to claims 57 & 58, further including post-processing pasteurizing heat treatment to lethally terminate any microbial pathogens, whereby UHT treated foods particularly benefits diseased, immunocompromised, and interncare consumers by lethally terminate any microbial cultures.

64. The methods according to claims 57 & 58, further including said dough, batter and toppings individually sealed as a pizza kits, such as in any combination of individual components for end user assemblage, selected from the processing group comprising of ready-to-eat (fully-cooked); parbaked (partially cooked); frozen; chilled; shelf stable; using a multitude of constituents, shapes, thickness, and configurations to wrap and seal the present inventions, whereby organoleptic properties influence packaging selections, most particularly in aseptically processed foods.
